(19) United States
(12) Patent Application Publication
(10) Pub. No.: US 2015/0344782 A1
(43) Pub. Date: Dec. 3, 2015

(54) POLYMERIZABLE LIQUID CRYSTAL COMPOUND, LIQUID CRYSTAL COMPOSITION, POLYMER MATERIAL AND METHOD FOR MANUFACTURING THE SAME, AND FILM

(71) Applicant: FUJIFILM CORPORATION, Tokyo (JP)

(72) Inventors: Hiroshi MATSUYAMA, Kanagawa (JP); Shunya KATOH, Kanagawa (JP); Masaru YOSHIKAWA, Kanagawa (JP)

(73) Assignee: FUJIFILM CORPORATION, Tokyo (JP)

(21) Appl. No.: 14/822,213

(22) Filed: Aug. 10, 2015

Related U.S. Application Data
(63) Continuation of application No. PCT/JP2014/055964, filed on Mar. 7, 2014.

(30) Foreign Application Priority Data
Mar. 13, 2013 (JP) 2013-050615
Aug. 22, 2013 (JP) 2013-172609

(51) Int. Cl. C09K 19/38

(52) U.S. Cl. CPC C09K 19/3838

(57) ABSTRACT

Provided is a liquid crystal composition which is easily synthesized and highly suppress crystallization thereof. The liquid crystal composition includes at least one compound represented by formula (1), wherein Z¹ represents —CO—, —O—CO— or single bond, and Z² represents —CO— or —CO—CH═CH—, at least one compound represented by formula (2) not having (meth)acrylate group, wherein Z³ represents —CO— or —CH═CH—CO—, and Z⁴ represents —CO— or —CO—CH═CH—, and at least one compound represented by formula (3), wherein Z⁵ represents —CO—, —O—CO— or single bond, and Z⁶ represents —CO—, —CO—O— or single bond.

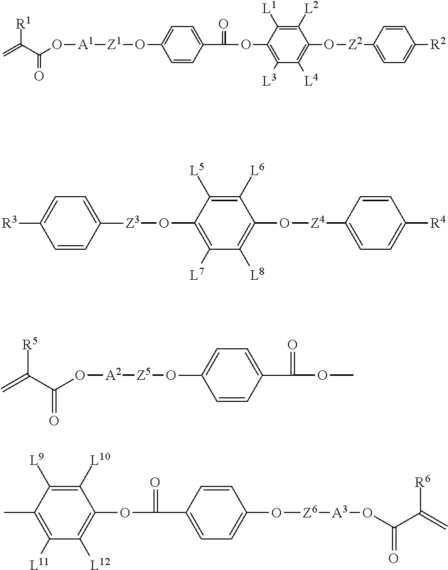

### CROSS-REFERENCE TO RELATED APPLICATIONS

This application is a Continuation of PCT International Application No. PCT/JP2014/055964 filed on Mar. 7, 2014, which claims priority under 35 U.S.C §119(a) to Japanese Patent Application No. 2013-050615 filed on Mar. 13, 2013 and Japanese Patent Application No. 2013-172609 filed on Aug. 22, 2013. Each of the above application(s) is hereby expressly incorporated by reference, in its entirety, into the present application.

### TECHNICAL FIELD

This invention relates to a polymerizable liquid crystal compound versatile for various applications, represented by various optical components including optically anisotropic film, heat barrier film and so forth; a liquid crystal composition using such polymerizable liquid crystal compound; a method for manufacturing a polymer material using such liquid crystal composition; a polymer material, and a film.

### BACKGROUND ART

Liquid crystal material has been used in various industrial fields including phase difference film, polarizing element, selective reflection film, color filter, antireflection film, viewing angle compensatory film, holography, alignment film and so forth. In particular, bifunctional liquid crystalline (meth)acrylate compound is highly versatile, and has been used for various applications.

The bifunctional liquid crystalline (meth)acrylate compound is, however, highly crystallizable, and, therefore, bifunctional liquid crystalline (meth)acrylate compound only, or a composition of bifunctional liquid crystalline (meth)acrylate compounds is unfortunately very likely to crystallize in a process of coating. It has therefore been desired to develop an additive which is effective to suppress crystal deposition of the polymerizable liquid crystal compound.

As a countermeasure, it has been known that mixing of a main polymerizable liquid crystal compound with other polymerizable liquid crystal compound successfully lowers the melting point. Patent Literature 1 also discloses that even crystallization may be suppressed by further mixing a polymerizable liquid crystal compound having a specific molecular structure. Patent Literature 1 describes that a bifunctional (meth)acrylate compound in which the hydroquinone core having thereon a C₄ or longer substituent further has a C₅ or longer substituent is added into a liquid crystal material. Patent Literature 1 discloses that the compound successfully suppresses from crystallizing even if super-cooled from the liquid crystal state down to room temperature, without degrading the characteristics including alignability and curability. Patent Literature 1, however, describes only bifunctional polymerizable liquid crystal compounds, and is unsatisfactory because the bifunctional polymerizable liquid crystal compound has a molecular structure having a poor-synthetic suitability which is needed to separately synthesize core moiety.

On the other hand, although not mentioned on suppression of the crystallization, Non-Patent Literature 1 describes a monofunctional polymerizable liquid crystal compound which is a benzoate ester of a substituted hydroquinone core. The monofunctional polymerizable liquid crystal compound described in Non-Patent Literature 1 was a compound configured by two different benzoate esters of methylhydroquinone, having a benzoate ester with a (meth)acrylate group on one side, and having a benzoate ester with a C₅ alkoxy group on the other side. According to Non-Patent Literature 1, a cholesteric liquid crystal composition is manufactured by using a liquid crystal composition which contains 95% by mass of the above-described monofunctional polymerizable liquid crystal compound, 5% by mass of a chiral agent, and a polymerization initiator, so that there was no suggestion in Non-Patent Literature 1 about the use of the monofunctional polymerizable liquid crystal compound as an additive for suppressing crystallization.

Although not mentioned on suppression of the crystallization, also Patent Literature 2 describes a method for manufacturing a monofunctional polymerizable liquid crystal compound having a substituted hydroquinone core, as a random mixture with a bifunctional polymerizable liquid crystal compound. The monofunctional polymerizable liquid crystal compound contained in the random mixture described in Patent Literature 2 was a compound configured by two different benzoate esters of methylhydroquinone, having on one side a benzoate ester with a (meth)acrylate group, and having on the other side a benzoate ester with a C₆ alkoxy group as a side chain. Furthermore in Patent Literature 2, neither disclosure nor suggestion was made on whether the compound described in the literature demonstrates a suppressive effect on crystallization.

Patent Literature 3 describes a liquid crystal composition successfully prevented from crystallizing during storage at low temperatures, by containing three or more species of phenylenebis(4-alkylbenzene carboxylate) compound. It is described that a particularly large suppressive effect on crystallization is obtained, when at least one species out of such three or more species of phenylenebis(4-alkylbenzene carboxylate) compound is an asymmetric compound having different alkyl groups.

### CITATION LIST

### Patent Literature

[PATENT LITERATURE 1] JP-A-2009-184974
[PATENT LITERATURE 2] JP-T2-2002-536529
[PATENT LITERATURE 3] JP-A-H09-279144

### Non-Patent Literature

[NON-PATENT LITERATURE 1] Molecular Crystals and Liquid Crystals (2010), 530 169-174

### SUMMARY OF THE INVENTION

### Technical Problem

It has been known that the melting point of a main polymerizable liquid crystal generally depresses when mixed with other polymerizable liquid crystal compound as described above. There are, however, only a few knowledge about addition of what kind of molecular structure of liquid crystal compound into the main polymerizable liquid crystal will demonstrate the suppressive effect on crystallization, so that the effect has been difficult to predict.

Non-Patent Literature 1 describes a method to manufacture of a cholesteric liquid crystal film, using a liquid crystal composition which contains 95% by mass of the above-described monofunctional polymerizable liquid crystal compound and 5% by mass of a chiral agent.

Non-Patent Literature 1, however, does not suggest that the monofunctional polymerizable liquid crystal compound is used as an additive for suppressing crystallization.

Patent Literature 1 only describes the bifunctional polymerizable liquid crystal compound, which still remains unsatisfactory in that the compound bothers from low suitability for synthesis, since the molecular structure thereof needs a separate synthesis of the core.

Also Patent Literature 2 neither discloses nor suggests whether or not the compound disclosed therein has the suppressive effect on crystallization.

Under such situation, the present inventors actually used the monofunctional polymerizable liquid crystal compound described in Non-Patent Literature 1 as an additive, and tested the suppressive effect on crystallization, only to find the crystallization suppressive effect was poor.

The present inventors also conducted a similar test on the crystallization suppressive effect using, as an additive, the monofunctional polymerizable liquid crystal compound described in Patent Literature 2, only to find that the crystallization suppressive effect was poor.

The present inventors still also conducted a similar test on the crystallization suppressive effect using the liquid crystal composition described in Patent Literature 3, only to find a poor crystallization suppressive effect. An improved suppressive effect on crystallization has therefore been required.

It is therefore an object of this invention to solve these problems, and to provide a liquid crystal composition having a high suppressive effect on crystallization.

### Solution to Problem

After extensive investigations to solve the above-described problems, the present inventors found that the problem of this invention may be successfully solved by using a later-described liquid crystal composition which contains a compound represented by Formula (1), a compound represented by Formula (2), and a compound represented by Formula (3).

Preferably used is a polymerizable liquid crystal compound having one (meth)acrylate group, a liquid crystal compound not having (meth)acrylate group, and a polymerizable liquid crystal compound having two (meth)acrylate groups. Herein, the polymerizable liquid crystal compound having one (meth)acrylate group has a unsymmetrical structure, and a length of the substituent which substitutes on the phenyl group at the side not having (meth)acrylate group contained therein is controlled to be shorter than the length in the compounds specifically disclosed in Patent Literature 2 and Non-Patent Literature 1. And, additionally used is a liquid crystal compound having a skeleton similar to the skeleton of the polymerizable liquid crystal compound having one (meth)acrylate group, and not having (meth)acrylate group. The present inventors also found that, by using such a liquid crystal compound, the crystallization suppressive effect may further be improved.

Specifically, the above problem was solved by the following [1], preferably [2] to [24].

[1] A liquid crystal composition comprising: at least one species of compound represented by the following formula (1); at least one species of compound represented by the following formula (2); and at least one species of compound represented by the following formula (3);

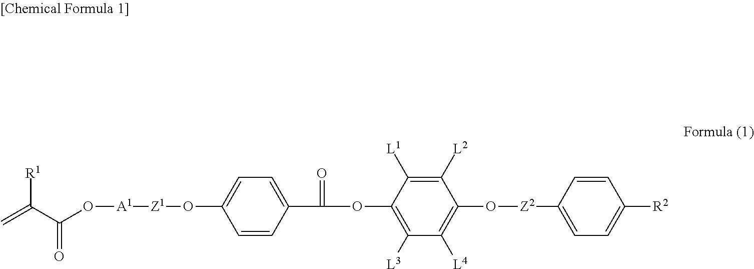

wherein

A¹ represents an alkylene group having 2 to 18 carbon atoms, one CH₂ group or two or more non-adjacent CH₂ groups in the methylene group may be replaced by —O—;

Z¹ represents —CO—, —O—CO— or single bond;

Z² represents —CO— or —CO—CH═CH—;

R¹ represents a hydrogen atom or methyl group;

R² represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, N-acetylamide group, acryloylamino group, N,N-dimethylamino group, maleimide group, methacryloylamino group, allyloxy group, allyloxycarbamoyl group, N-alkyloxycarbamoyl group with an alkyl group thereof having 1 to 4 carbon atoms, N-(2-methacryloyloxyethyl)carbamoyloxy group, N-(2-acryloyloxyethyl)carbamoyloxy group, or a structure represented by Formula (1-2) below;

each of L¹, L², L³ and L⁴ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, at least one L¹, L², L³ and L⁴ represents a group other than hydrogen atom;

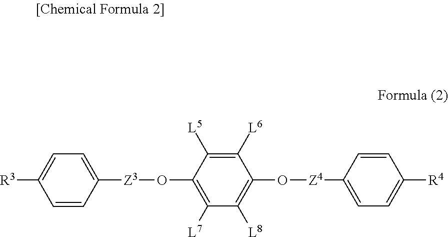

wherein

Z³ represents —CO or —CH═CH—CO—;

Z⁴ represents —CO— or —CO—CH═CH—;

each of R³ and R⁴ independently represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, acryloylamino group, N,N-dimethylamino group, maleimide group, methacryloylamino group, allyloxy group, allyloxycarbamoyl group, N-alkyloxycarbamoyl group with an alkyl group thereof having 1 to 4 carbon atoms, N-(2-methacryloyloxyethyl)carbamoyloxy group, N-(2-acryloyloxyethyl)carbamoyloxy group, or a structure represented by Formula (1-2);

each of L⁵, L⁶, L⁷ and L⁸ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, at least one of L⁵, L⁶, L⁷ and L⁸ represents a group other than hydrogen atom;

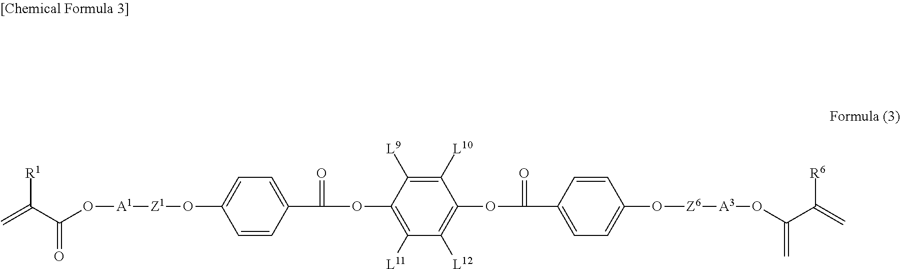

wherein

each of A² and A³ independently represents a methylene group having 2 to 18 carbon atoms, one CH₂ group or two or more non-adjacent CH₂ groups in the methylene group may be replaced by —O—;

Z⁵ represents —CO—, —O—CO— or single bond;

Z⁶ represents —CO—, —CO—O— or single bond;

each of R⁵ and R⁶ independently represents a hydrogen atom or methyl group;

each of L⁹, L¹⁰, L¹¹ and L¹² independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, and at least one of L⁹, L¹⁰, L¹¹ and L¹² represents a group other than hydrogen atom;

—Z⁵-T-Sp-P Formula (1-2)

wherein

P represents an acryl group, methacryl group or hydrogen atom;

Z⁵ represents a single bond, —COO—, —CONR¹—, wherein R¹ represents a hydrogen atom or methyl group, or —COS—;

T represents a 1,4-phenylene group; and

Sp represents an optionally substituted divalent aliphatic group having 1 to 12 carbon atoms, one CH₂ group or two or more non-adjacent CH₂ groups in the aliphatic group may be replaced by —O—, —S—, —OCO—, —COO— or —OCOO—.

[2] A liquid crystal composition of [1], wherein,

in Formula (1), R² represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, N-acetylamide group, acryloylamino group, N,N-dimethylamino group or maleimide group; and

in Formula (2), each of R³ and R⁴ independently represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, acryloylamino group, N, N-dimethylamino group or maleimide group.

[3] The liquid crystal composition of [1] or [2], wherein the compounds represented by Formulae (1), (2) and (3) are compounds represented by Formulae (4), (5) and (6) below:

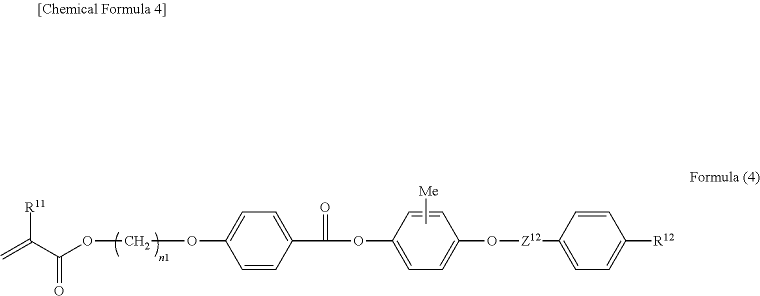

wherein, n1 represents an integer of 3 to 6;

R¹¹ represents a hydrogen atom or methyl group;

Z¹² represents —CO— or —CO—CH═CH—;

R¹² represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3) below;

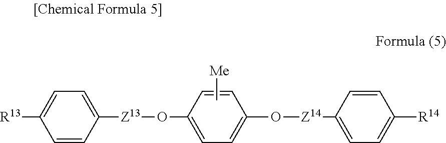

wherein

Z¹³ represents —CO— or —CO—CH═CH—;

Z¹⁴ represents —CO— or —CH═CH—CO—;

each of R¹³ and R¹⁴ independently represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3) below;

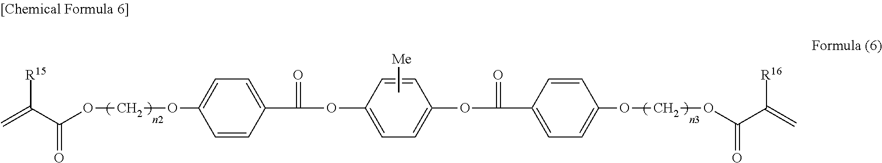

wherein

each of n2 and n3 independently represents an integer of 3 to 6; and

each of R¹⁵ and R¹⁶ independently represents a hydrogen atom or methyl group;

—Z⁵¹-T-Sp-P Formula (1-3)

wherein

P represents an acryl group or methacryl group;

Z⁵¹ represents —COO—;

T represents a 1,4-phenylene group; and

Sp represents an optionally substituted divalent aliphatic group having 2 to 6 carbon atoms, one CH₂ group or two or more non-adjacent CH₂ groups in the aliphatic group may be replaced by —O—, —OCO—, —COO— or —OCOO—.

[4] The liquid crystal composition of [3], wherein at least two of R¹², R¹³ and R¹⁴ represent the same substituent.
[5] The liquid crystal composition of [3] or [4], wherein n1 is 4.
[6] The liquid crystal composition of any one of [3] to [5], wherein each of R¹¹, R¹⁵ and R¹⁶ represents a hydrogen atom.
[7] The liquid crystal composition of any one of [3] to [6], wherein each of Z¹², Z¹³ and Z¹⁴ represents —CO—.
[8] The liquid crystal composition of any one of [3] to [7], wherein each of R¹², R¹³ and R¹⁴ independently represents a methyl group, ethyl group, methoxy group, ethoxy group, phenyl group, acryloylamino group, methacryloylamino group, allyloxy group, or a structure represented by Formula (1-3) below.
[9] The liquid crystal composition of any one of [3] to [8], wherein each of R¹², R¹³ and R¹⁴ represents a phenyl group.
[10] The liquid crystal composition of any one of [1] to [9], containing 3 to 50% by mass of the compound represented by Formula (1), and 0.01 to 10% by mass of the compound represented by Formula (2), relative to the compound represented by Formula (3).
[11] The liquid crystal composition of any one of [1] to [10], containing at least one species of polymerization initiator.
[12] The liquid crystal composition of any one of [1] to [11], containing at least one species of chiral compound.
[13] A method for manufacturing a polymer material, comprising polymerizing a liquid crystal composition described in any one of [1] to [12].
[14] The method for manufacturing a polymer material of [13], wherein the polymerization is attained through irradiation ultraviolet radiation.
[15] A polymer material, obtainable by polymerizing the liquid crystal composition described in any one of [1] to [12].
[16] A film containing at least one species of polymer material described in [15].
[17] A film comprising an optically anisotropic layer configured by fixing an alignment of a liquid crystal compound contained in a liquid crystal composition described in any one of [1] to [12].
[18] The film of [17], wherein the optically anisotropic layer is configured by fixing cholesteric alignment of the liquid crystal compound.
[19] The film of [18], having a selective reflection characteristic.
[20] The film of [18] or [19], having a selective reflection characteristic in the infrared wavelength region.
[21] The film of [17], wherein the optically anisotropic layer is configured by fixing homogeneous alignment of the liquid crystal compound.
[22] The film of [17], wherein the optically anisotropic layer is configured by fixing homeotropic alignment of the liquid crystal compound.
[23] A polarizing plate comprising a film described in [21] or [22], and a polarizing film.
[24] A liquid crystal display device comprising a polarizing plate described in [23].

### Advantageous Effects of Invention

According to this invention, it is now possible to provide a polymerizable liquid crystal compound which is easily synthesized, and can demonstrate a high performance of suppressing the crystallization.

### DESCRIPTION OF EMBODIMENTS

This invention will be detailed below. Explanation of constituent features will occasionally be made on representative embodiments or specific examples of this invention, to which this invention by no means limited. In this specification, all numerical ranges expressed using “to” with preceding and succeeding numerals are defined to contain these numerals as the lower and upper limit values.

In this specification, (meth)acrylate means a group consisting of both of acrylate and methacrylate.

### First Embodiment of this Invention

### Liquid Crystal Composition

The liquid crystal composition of this invention contains at least one species of compound represented by the following formula (1), at least one species of compound represented by the following formula (2), and at least one species of compound represented by the following formula (3).

The liquid crystal composition of this invention demonstrates a high suppressive effect on crystallization. The liquid crystal composition of this invention may be synthesized easily.

The individual compounds contained in the liquid crystal composition of this invention will be explained.

### [Compound Represented by Formula (1)]

The compound used for the liquid crystal composition of this invention is a compound represented by the following formula (1), and preferably a polymerizable liquid crystal compound having one (meth)acrylate group represented by the following formula (1).

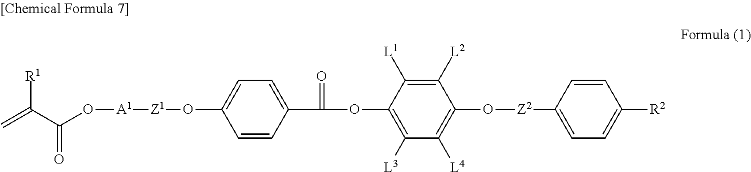

(in Formula (1), A¹ represents an alkylene group having 2 to 18 carbon atoms, wherein one CH₂ group or two or more non-adjacent CH₂ groups in the methylene group may be replaced by —O—;

Z¹ represents —CO—, —O—CO— or single bond;

Z² represents —CO— or —CO—CH═CH—;

R¹ represents a hydrogen atom or methyl group;

R² represents a hydrogen atom, halogen atom, straight-chain alkyl group having 1 to 4 carbon atoms, methoxy group, ethoxy group, optionally substituted phenyl group, vinyl group, formyl group, nitro group, cyano group, acetyl group, acetoxy group, N-acetylamide group, acryloylamino group, N,N-dimethylamino group or maleimide group, methacryloylamino group, allyloxy group, allyloxycarbamoyl group, N-alkyloxycarbamoyl group with the alkyl group thereof having 1 to 4 carbon atoms, N-(2-methacryloyloxyethyl)carbamoyloxy group, N-(2-acryloyloxyethyl) carbamoyloxy group or a structure represented by Formula (1-2) below;

each of L¹, L², L³ and L⁴ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, and at least one of L¹, L², L³ and L⁴ represents a group other than hydrogen atom.)

—Z⁵-T-Sp-P Formula (1-2)

(in Formula (1-2), P represents an acryl group, methacryl group or hydrogen atom, Z⁵ represents a single bond, —COO—, —CONR¹— (R¹ represents a hydrogen atom or methyl group) or —COS—, T represents a 1,4-phenylene group, Sp represents optionally substituted divalent aliphatic group having 1 to 12 carbon atoms, and one of CH₂ group or two or more non-adjacent CH₂ groups may be replaced by —O—, —S—, —OCO—, —COO— or —OCOO—.).

A¹ represents an alkylene group having 2 to 18 carbon atoms, wherein one CH₂ group or two or more non-adjacent CH₂ groups in the methylene group may be replaced by —O—.

A¹ preferably represents a methylene group having 2 to 7 carbon atoms, A¹ more preferably represents a methylene group having 3 to 6 carbon atoms, and A¹ particularly represents a methylene group having 3 or 4 carbon atoms. While one CH₂ group or two or more non-adjacent CH₂ groups in the methylene group may be replaced by —O—, the number of CH₂ groups in the methylene group replaced by —O— is preferably 0 to 2, more preferably 0 or 1, and particularly 0.

Z¹ represents —CO—, —O—CO— or single bond, and preferably represents —O—CO— or single bond.

Z² represents —CO— or —CO—CH═CH—, and preferably represents —CO—.

R¹ represents a hydrogen atom or methyl group, and preferably represents a hydrogen atom.

R² represents a hydrogen atom, halogen atom, straight-chain alkyl group having 1 to 4 carbon atoms, methoxy group, ethoxy group, optionally substituted phenyl group, vinyl group, formyl group, nitro group, cyano group, acetyl group, acetoxy group, N-acetylamide group, acryloylamino group, N,N-dimethylamino group, maleimide group, methacryloylamino group, allyloxy group, allyloxycarbamoyl group, N-alkyloxycarbamoyl group with the alkyl group thereof having 1 to 4 carbon atoms, N-(2-methacryloyloxyethyl)carbamoyloxy group, N-(2-acryloyloxyethyl)carbamoyloxy group, or a structure represented by Formula (1-2); preferably represents a straight-chain alkyl group having 1 to 4 carbon atoms, methoxy group, ethoxy group, phenyl group, acryloylamino group, methacryloylamino group, allyloxy group, or a structure represented by Formula (1-2); more preferably represents a methyl group, ethyl group, propyl group, methoxy group, ethoxy group, phenyl group, acryloylamino group, methacryloylamino group, or a structure represented by Formula (1-3); and even more preferably represents a methyl group, ethyl group, methoxy group, ethoxy group or phenyl group, acryloylamino group, methacryloylamino group, or a structure represented by Formula (1-3).

—Z⁵¹-T-Sp-P Formula (1-3)

(in Formula (1-3), P represents an acryl group or methacryl group, Z⁵¹ represents —COO—, T represents 1,4-phenylene, Sp represents an optionally substituted divalent aliphatic group having 2 to 6 carbon atoms, wherein one CH₂ group or two or more non-adjacent CH₂ groups in the aliphatic group may be replaced by —O—, —OCO—, —COO— or —OCOO—.)

In the compound represented by Formula (1), each of L¹, L², L³ and L⁴ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, wherein at least one of L¹, L², L³ and L⁴ represents a group other than hydrogen atom.

The alkyl group having 1 to 4 carbon atoms is preferably a straight-chain alkyl group having 1 to 4 carbon atoms, more preferably a methyl group or ethyl group, and even more preferably a methyl group.

The number of carbon atoms of the alkoxy group having 1 to 4 carbon atoms is preferably 1 or 2, and more preferably 1.

The number of carbon atoms of the alkoxycarbonyl group having 2 to 5 carbon atoms is preferably 2 to 4, and more preferably 2.

The halogen atom is preferably a chlorine atom.

It is preferable that each of L¹, L², L³ and L⁴ independently represents an alkyl group having 1 to 4 carbon atoms or hydrogen atom.

At least one of L¹, L², L³ and L⁴ preferably represents an alkyl group having 1 to 4 carbon atoms, at least one of them more preferably represents a methyl group or ethyl group, and at least one of them even more preferably represents a methyl group. In particular, it is preferable that one of L¹, L², L³ and L⁴ represents a methyl group, and each of three of them represents a hydrogen atom.

The compound represented by Formula (1) is preferably a compound represented by Formula (4).

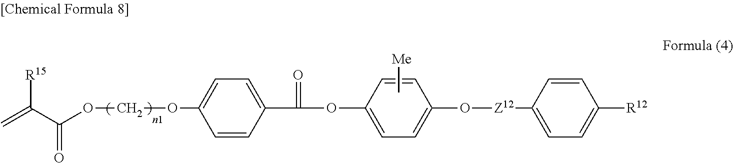

(in Formula (4), n1 represents an integer of 3 to 6;

R¹¹ represents a hydrogen atom or methyl group;

Z¹² represents —CO— or —CO—CH═CH—;

R¹² represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3) below:

—Z⁵¹-T-Sp-P Formula (1-3)

(in Formula (1-3), P represents an acryl group or methacryl group;

Z⁵¹ represents —COO—;

T represents 1,4-phenylene;

Sp represents an optionally substituted divalent aliphatic group having 2 to 6 carbon atoms, wherein one CH₂ group or two or more non-adjacent CH₂ groups in the aliphatic group may be replaced by —O—, —OCO—, —COO— or —OCOO—.))

n1 represents an integer of 3 to 6, and more preferably represents 3 or 4.

Z¹² represents —CO— or —CO—CH═CH—, and more preferably represents —CO—.

R¹² represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3), more preferably represents a methyl group, ethyl group, propyl group, methoxy group, ethoxy group, phenyl group, acryloylamino group, methacryloylamino group, or a structure represented by Formula (1-3), and even more preferably represents a methyl group, ethyl group, methoxy group, ethoxy group, phenyl group, acryloylamino group, methacryloylamino group, or a structure represented by Formula (1-3).

Specific examples of the compound represented by Formula (1) will be shown below, without limiting this invention.

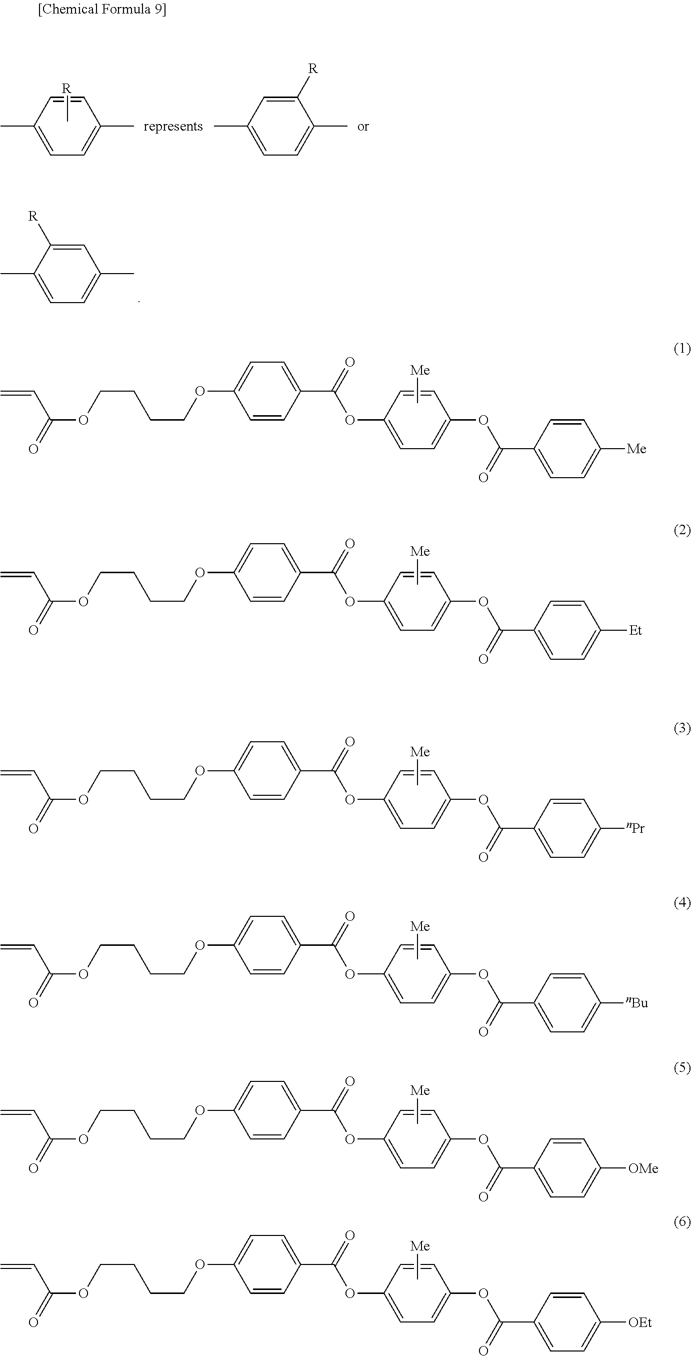

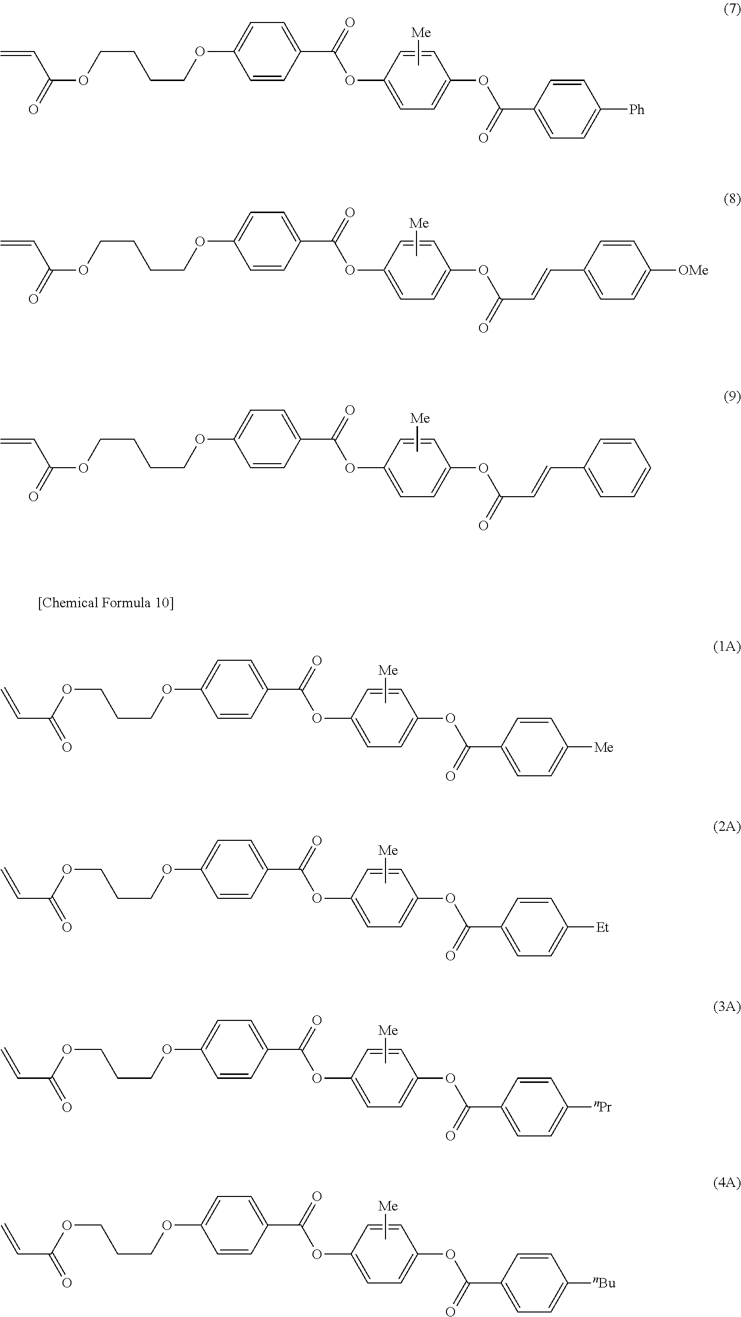

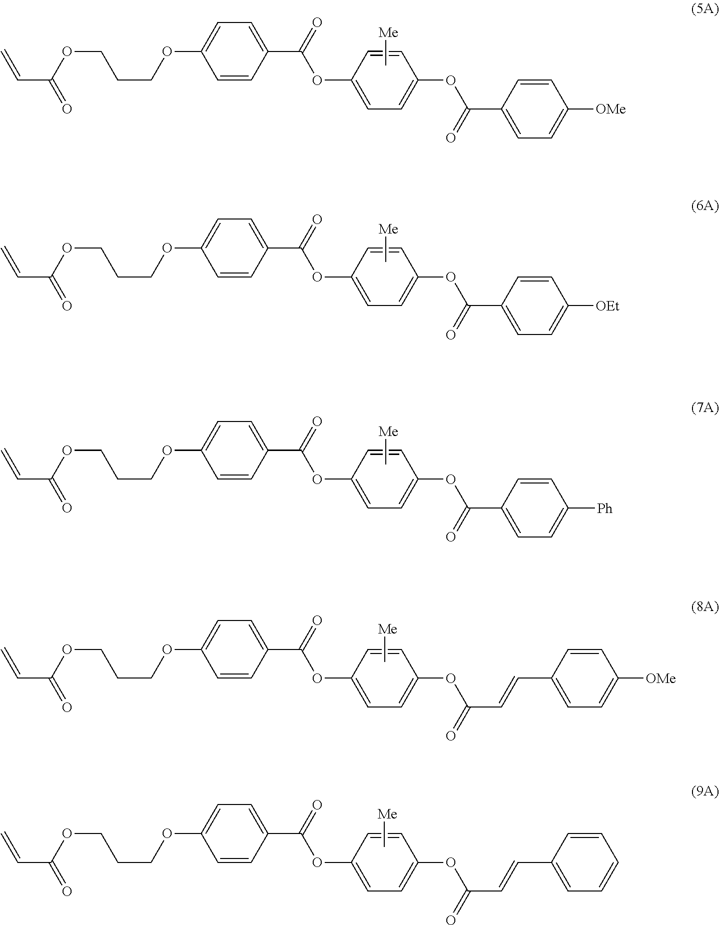

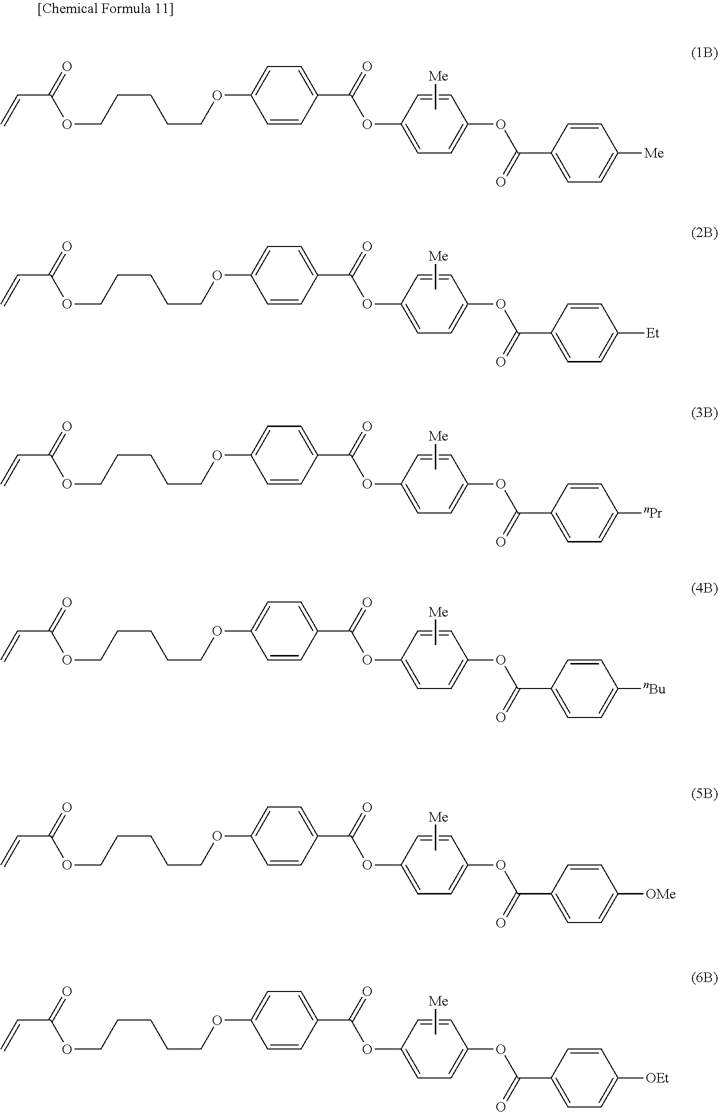

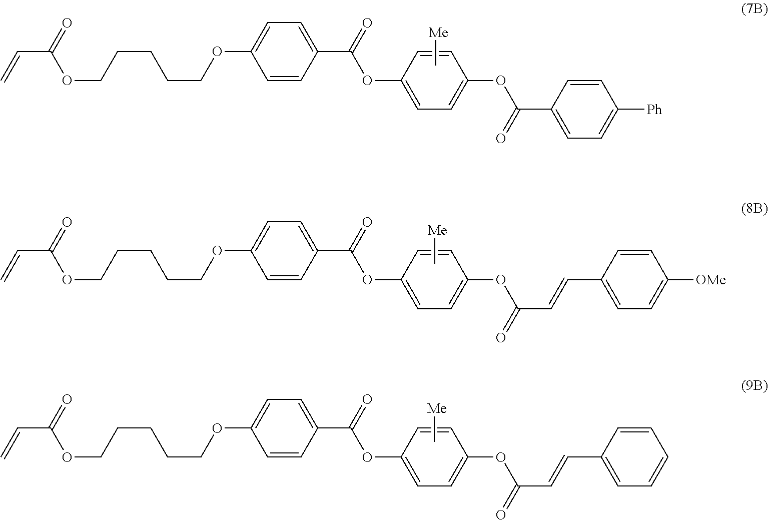

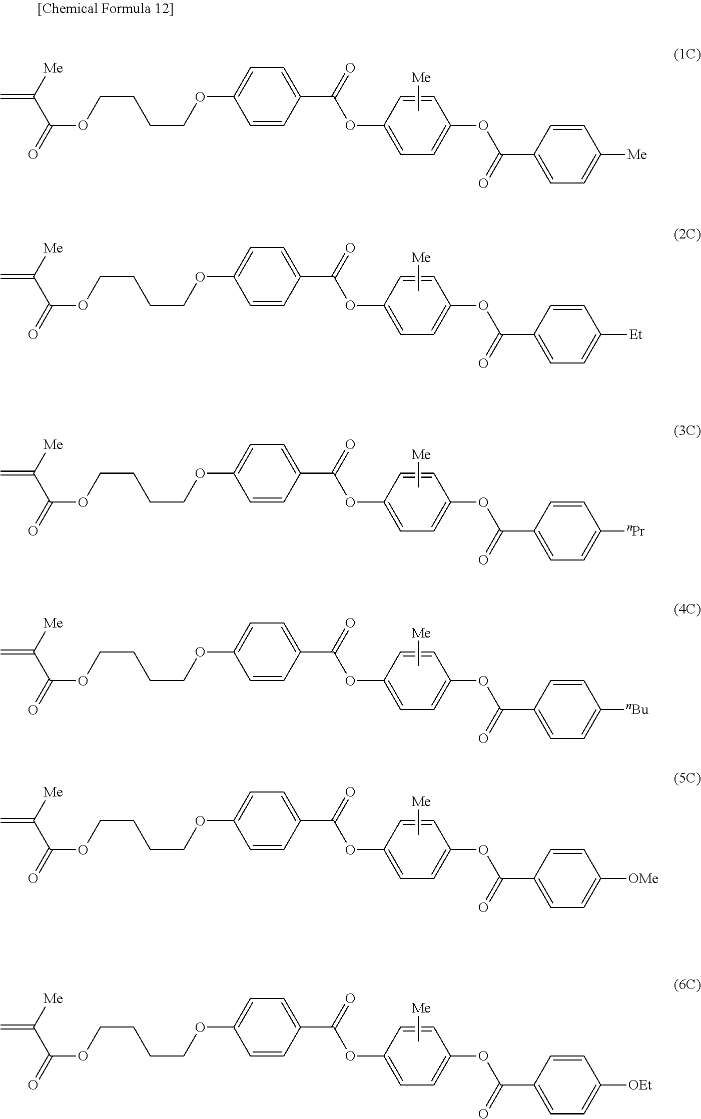

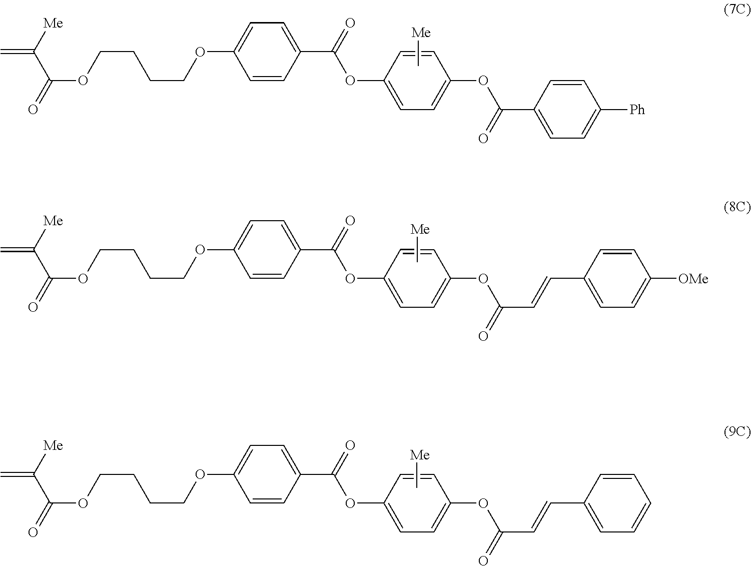

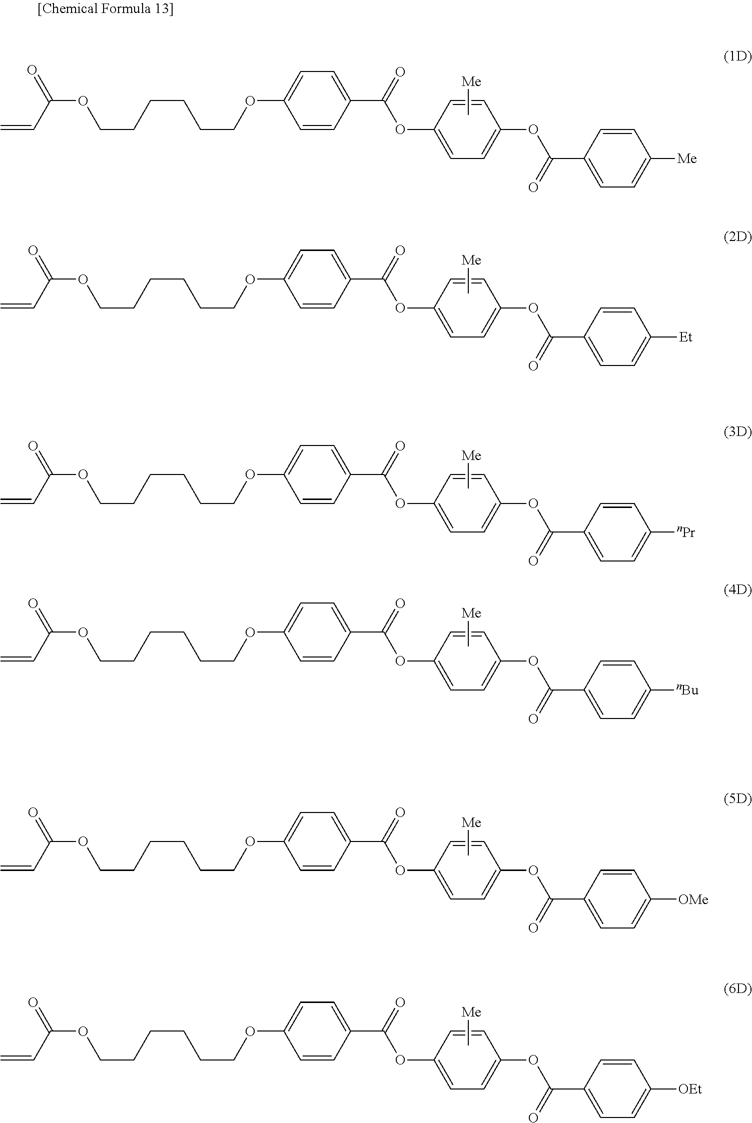

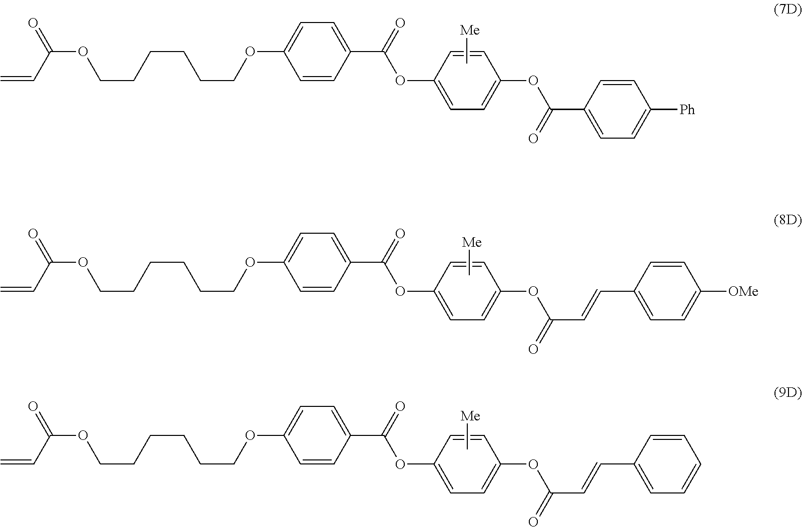

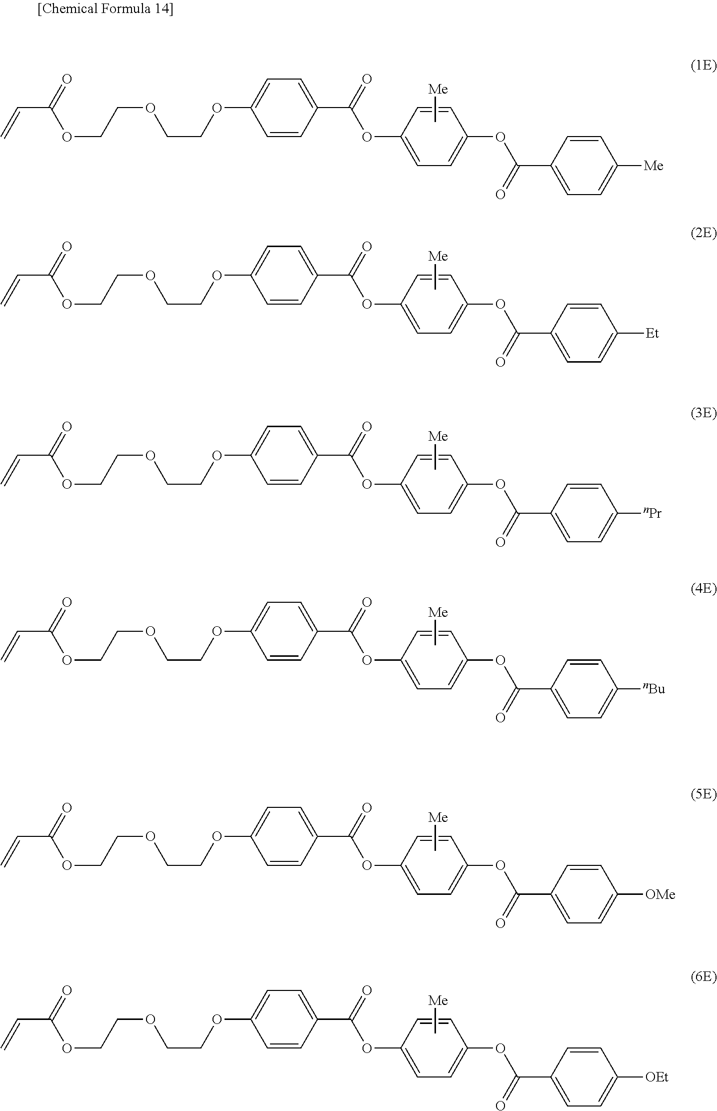

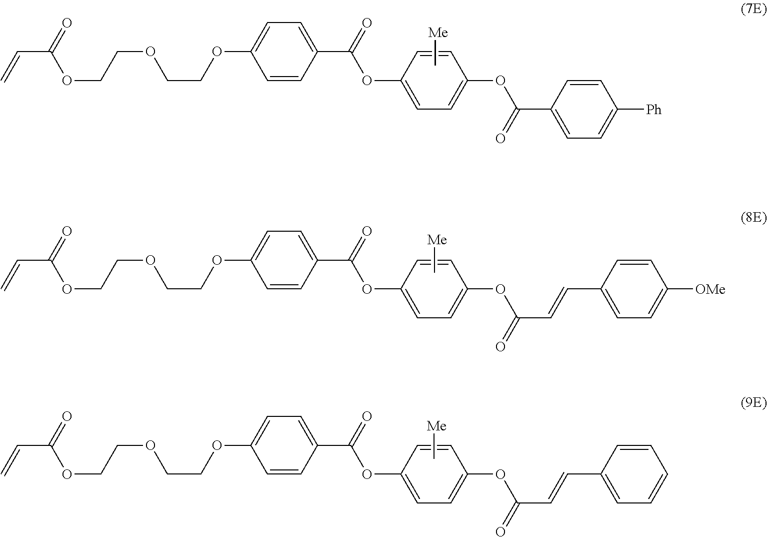

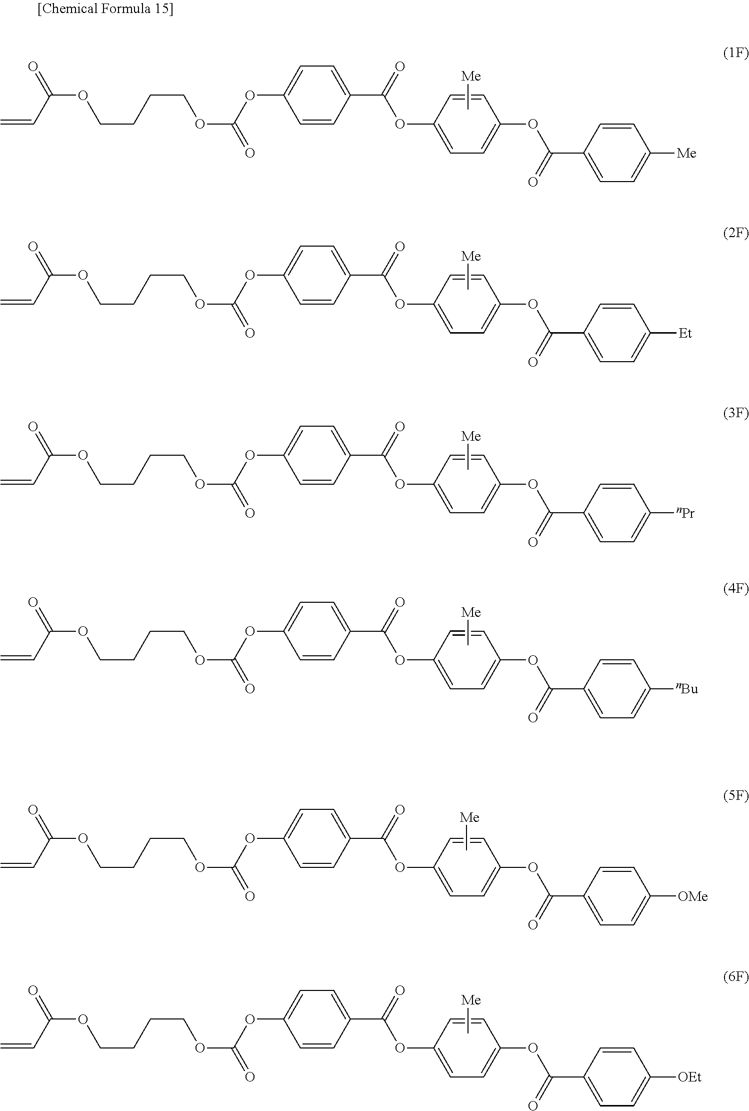

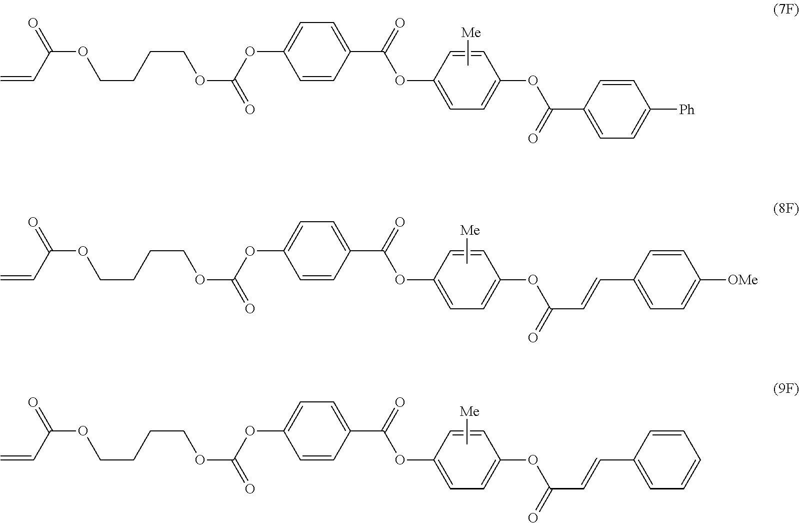

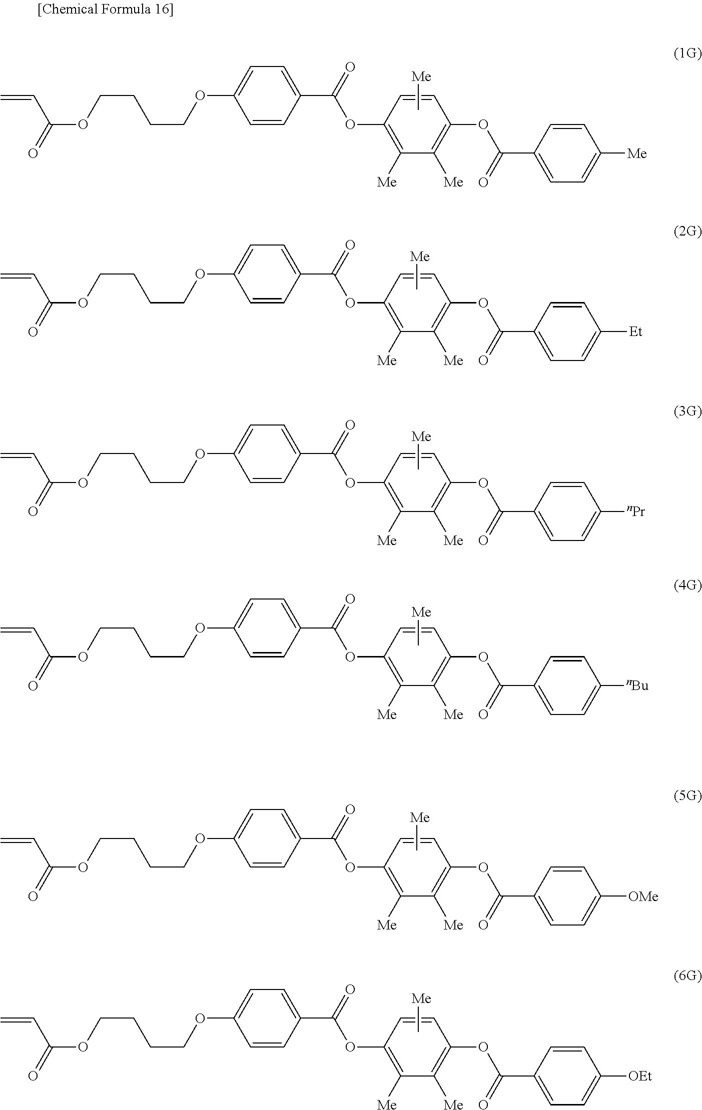

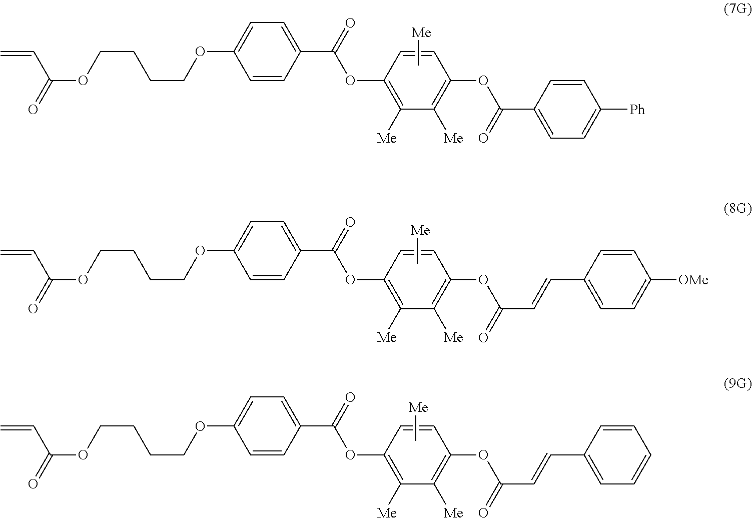

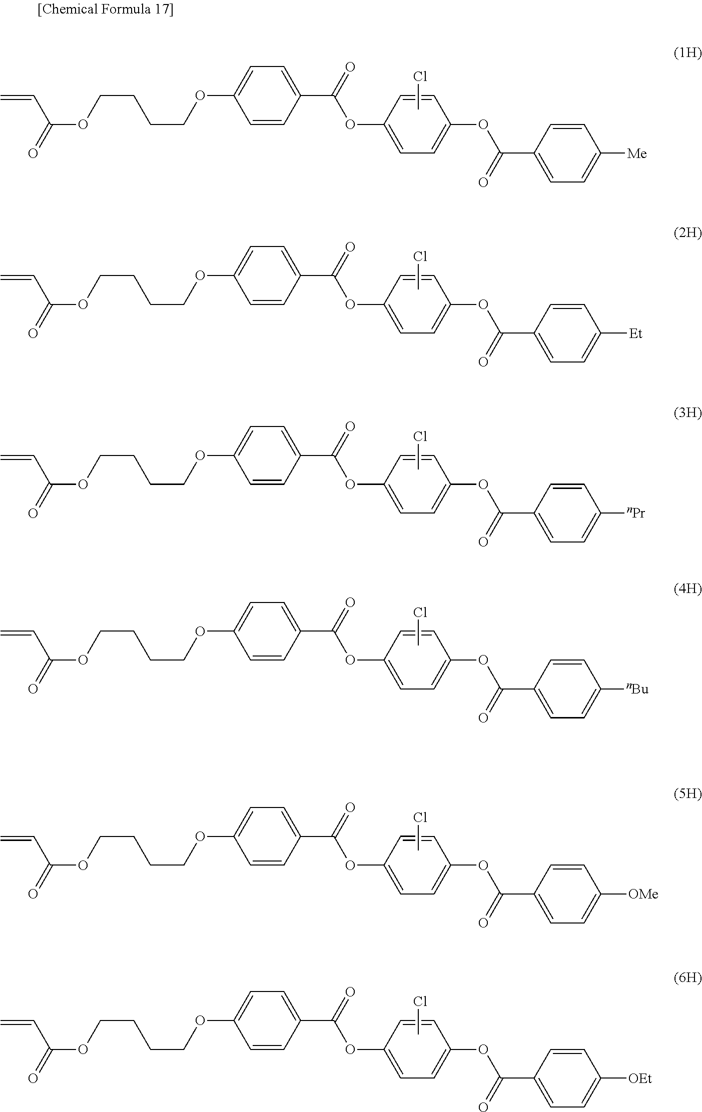

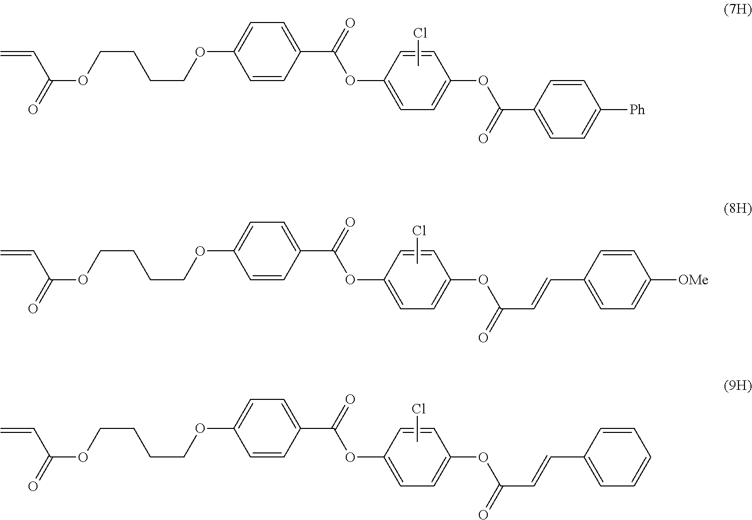

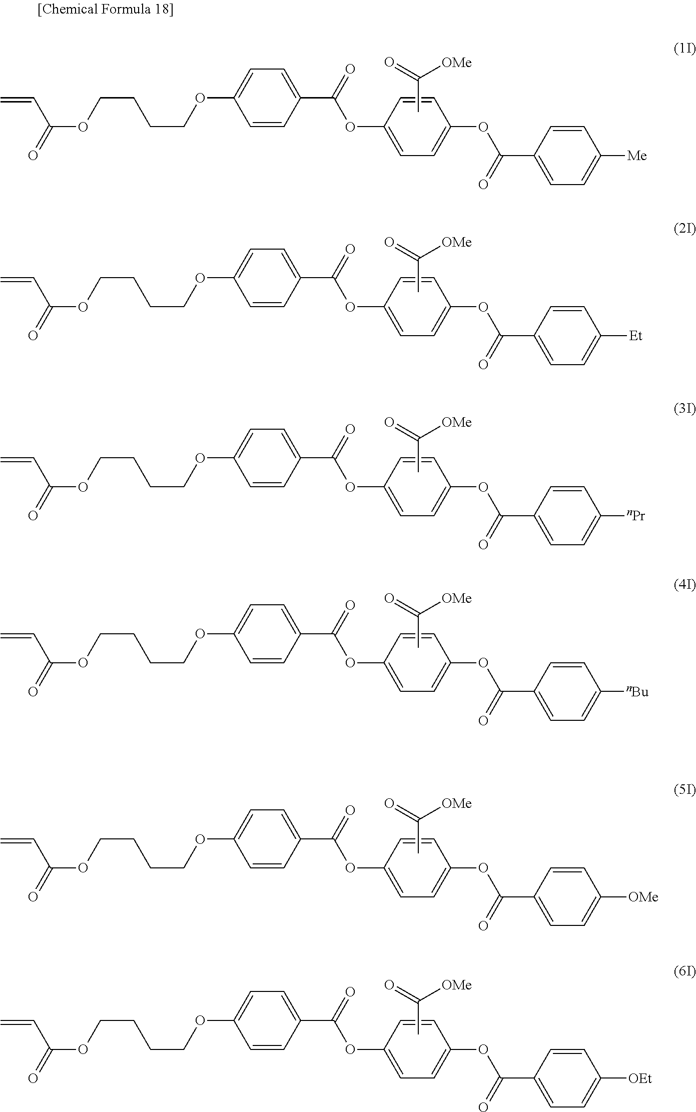

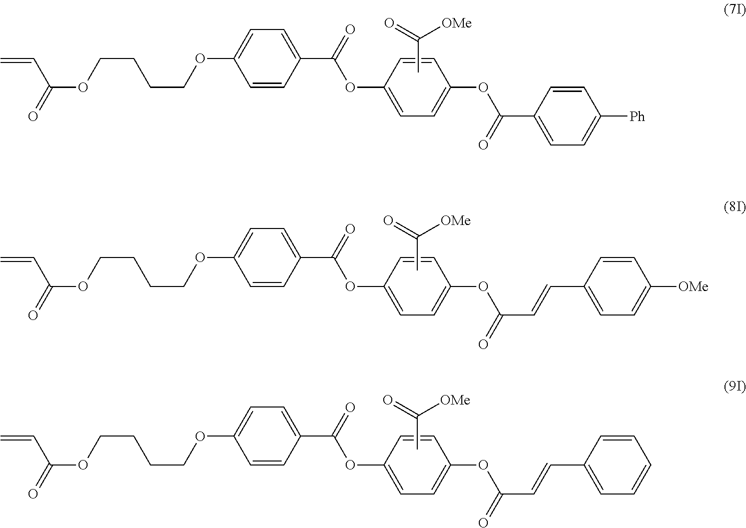

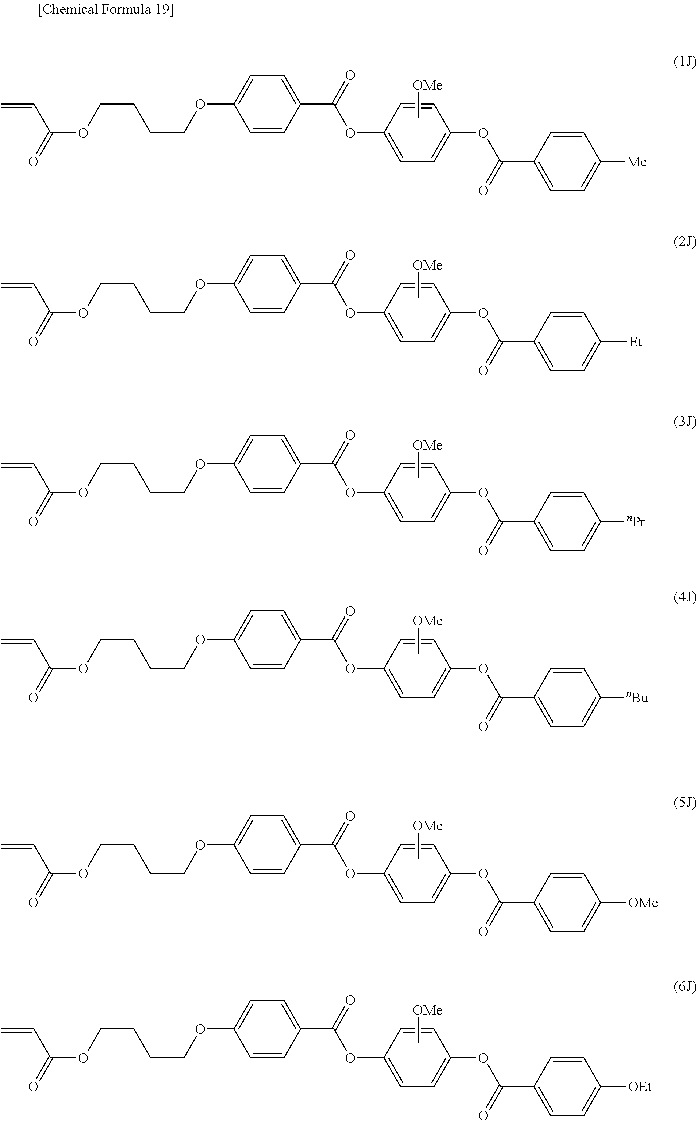

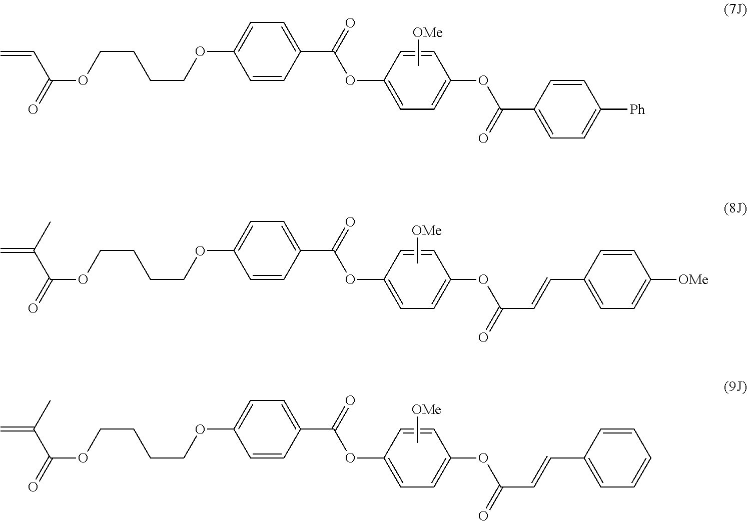

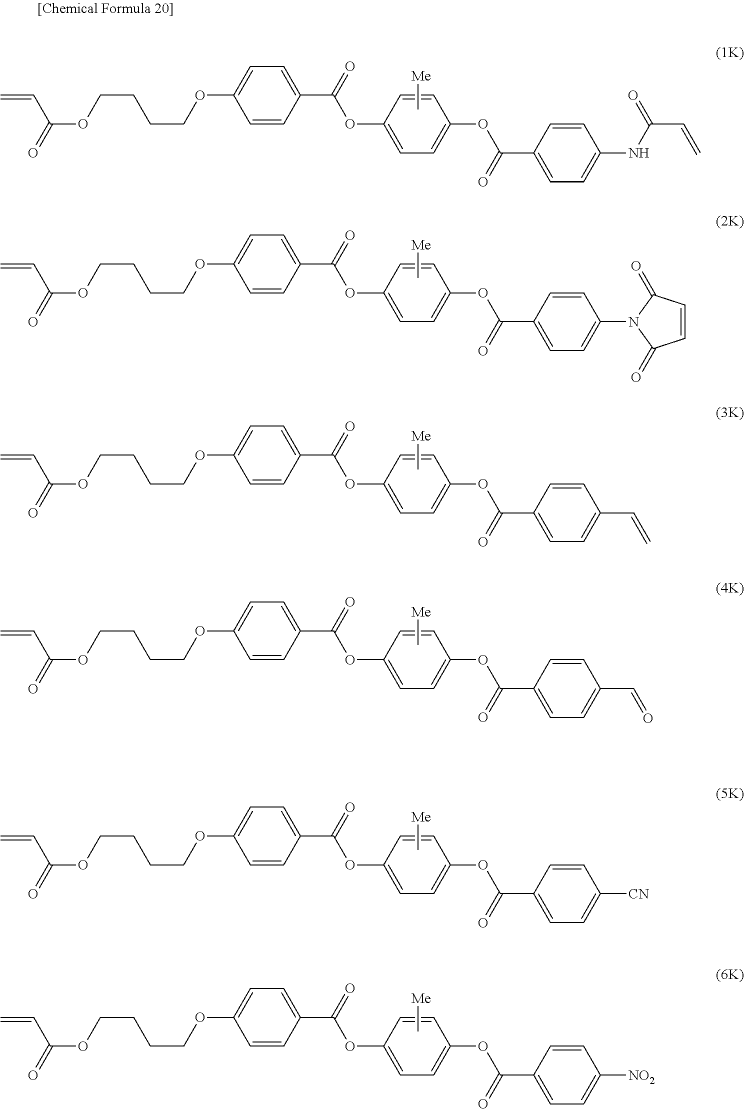

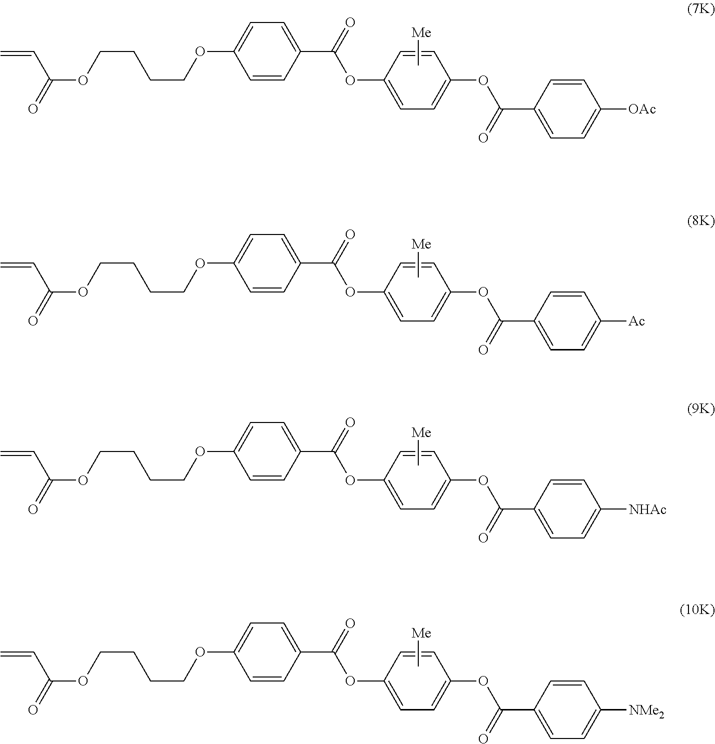

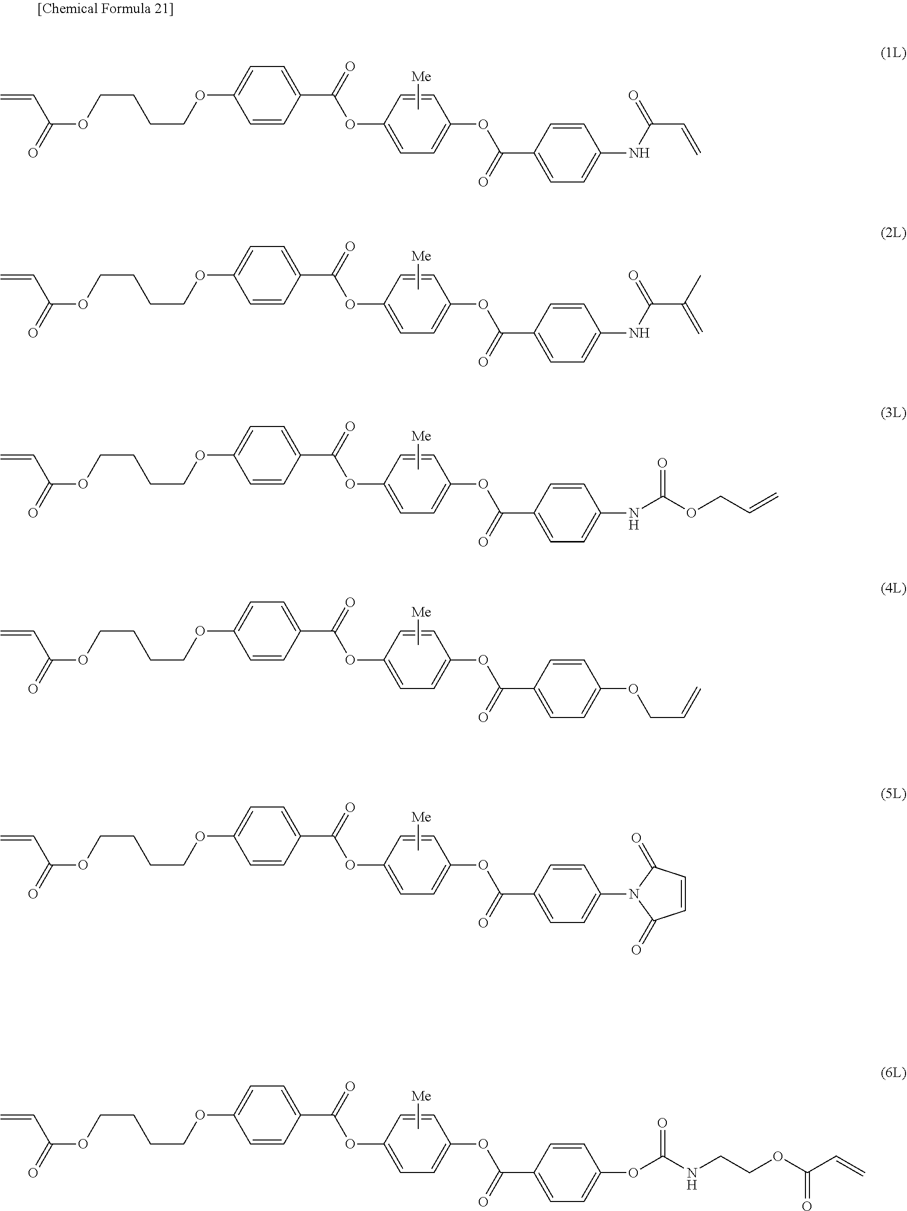

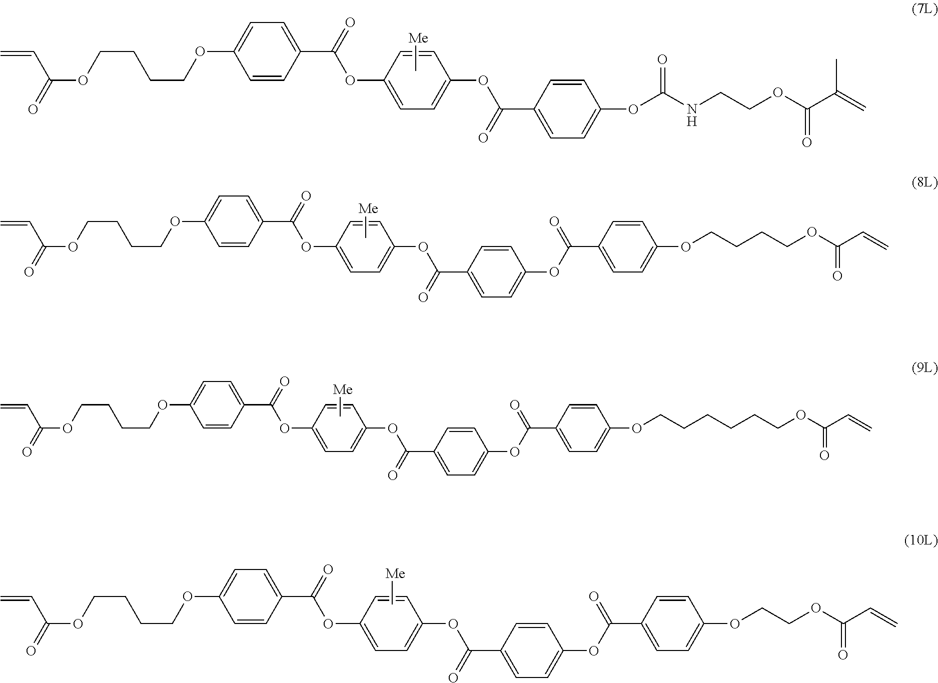

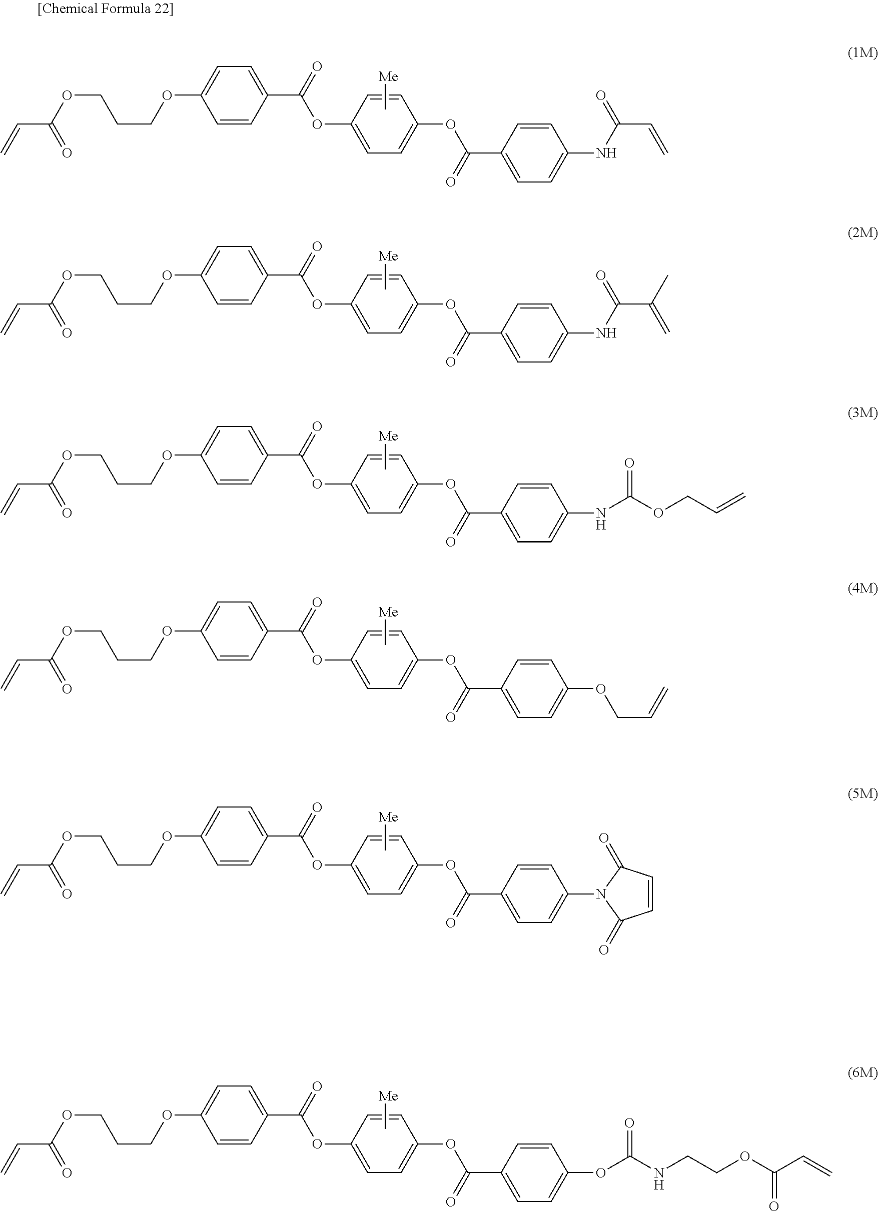

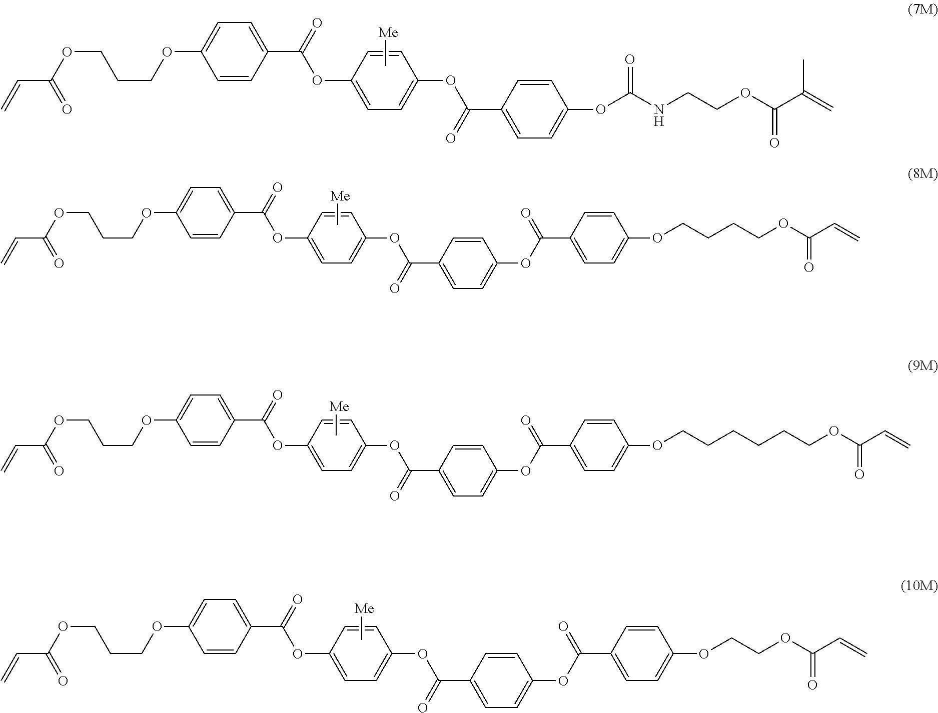

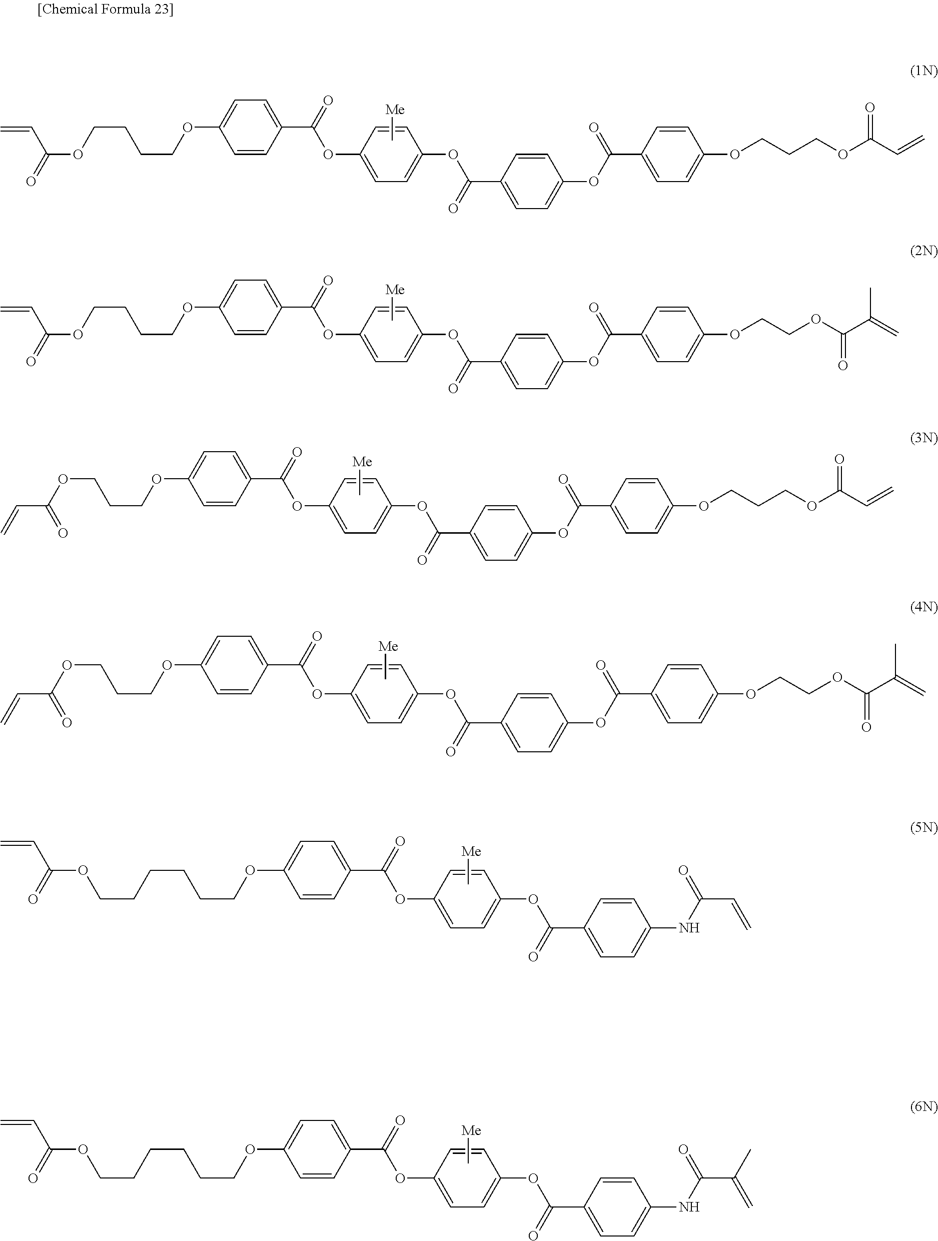

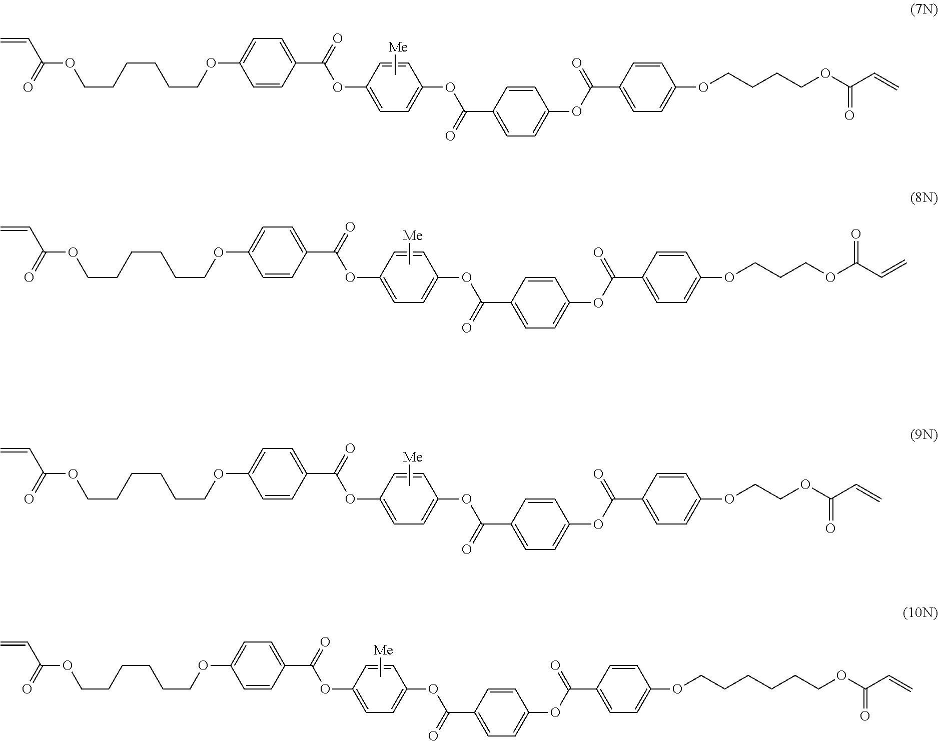

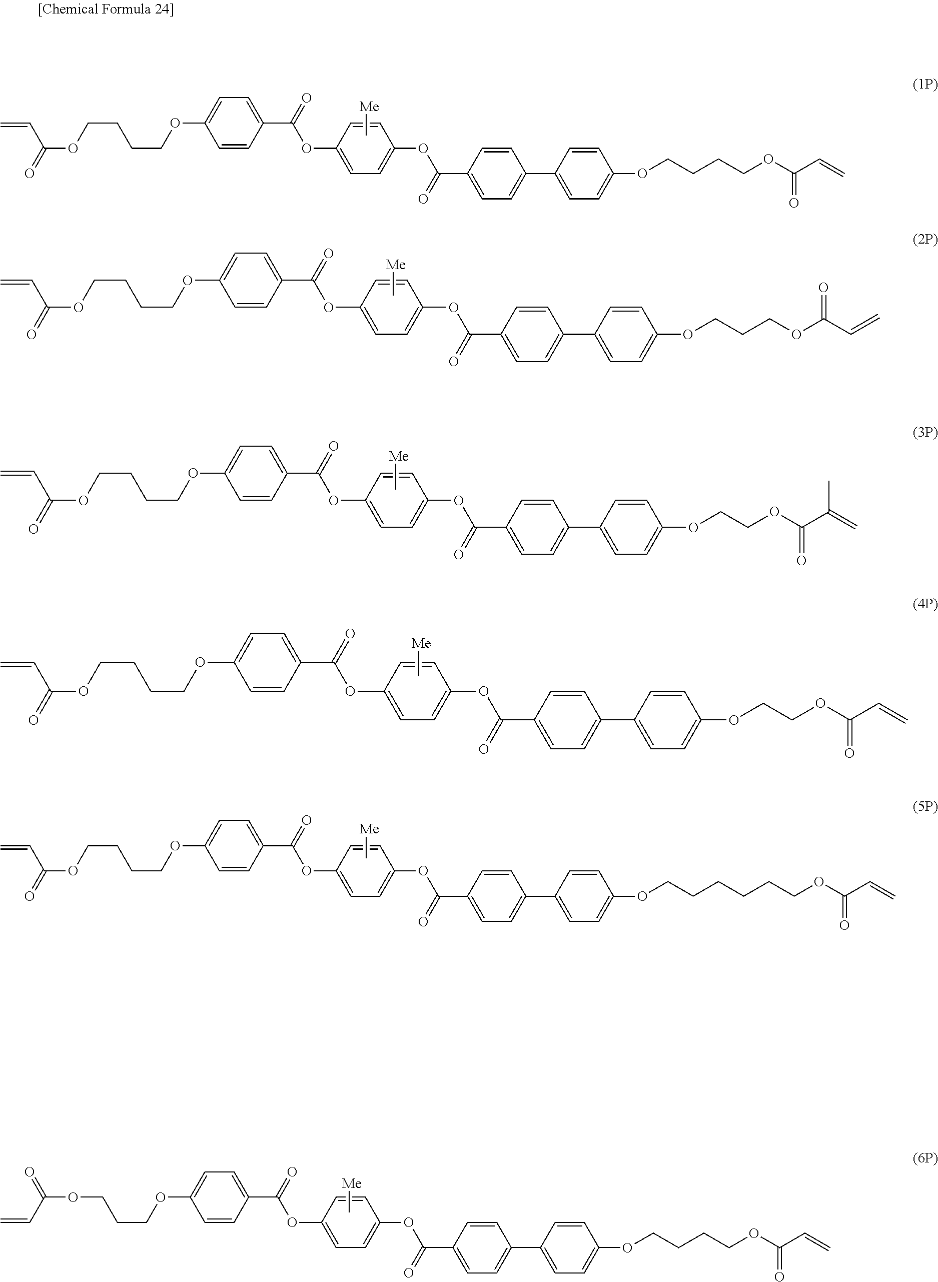

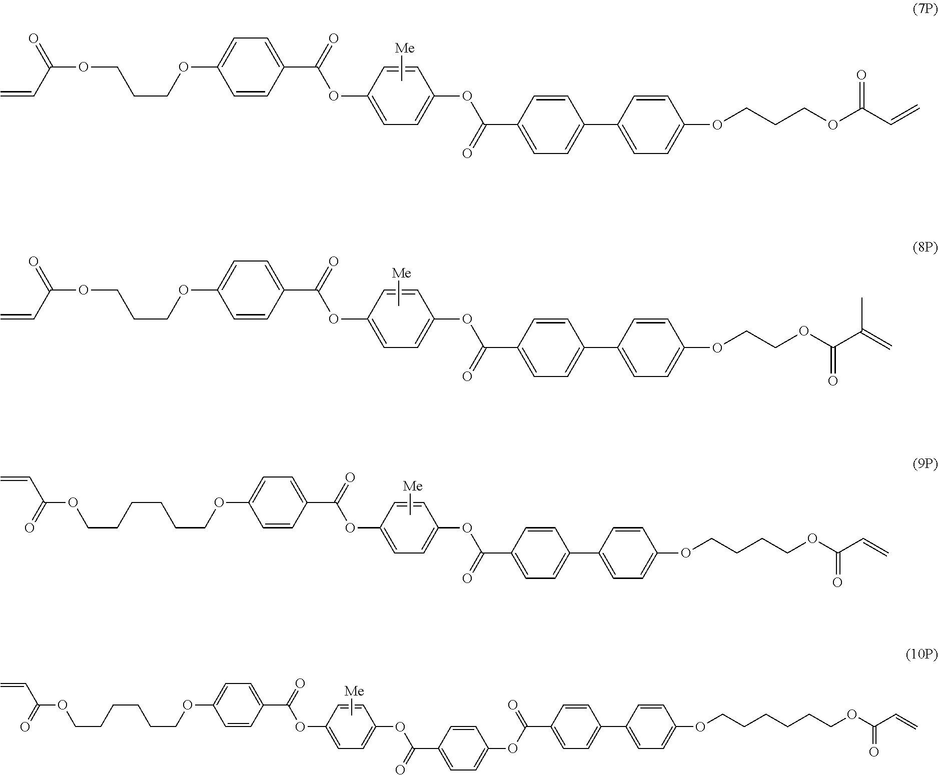

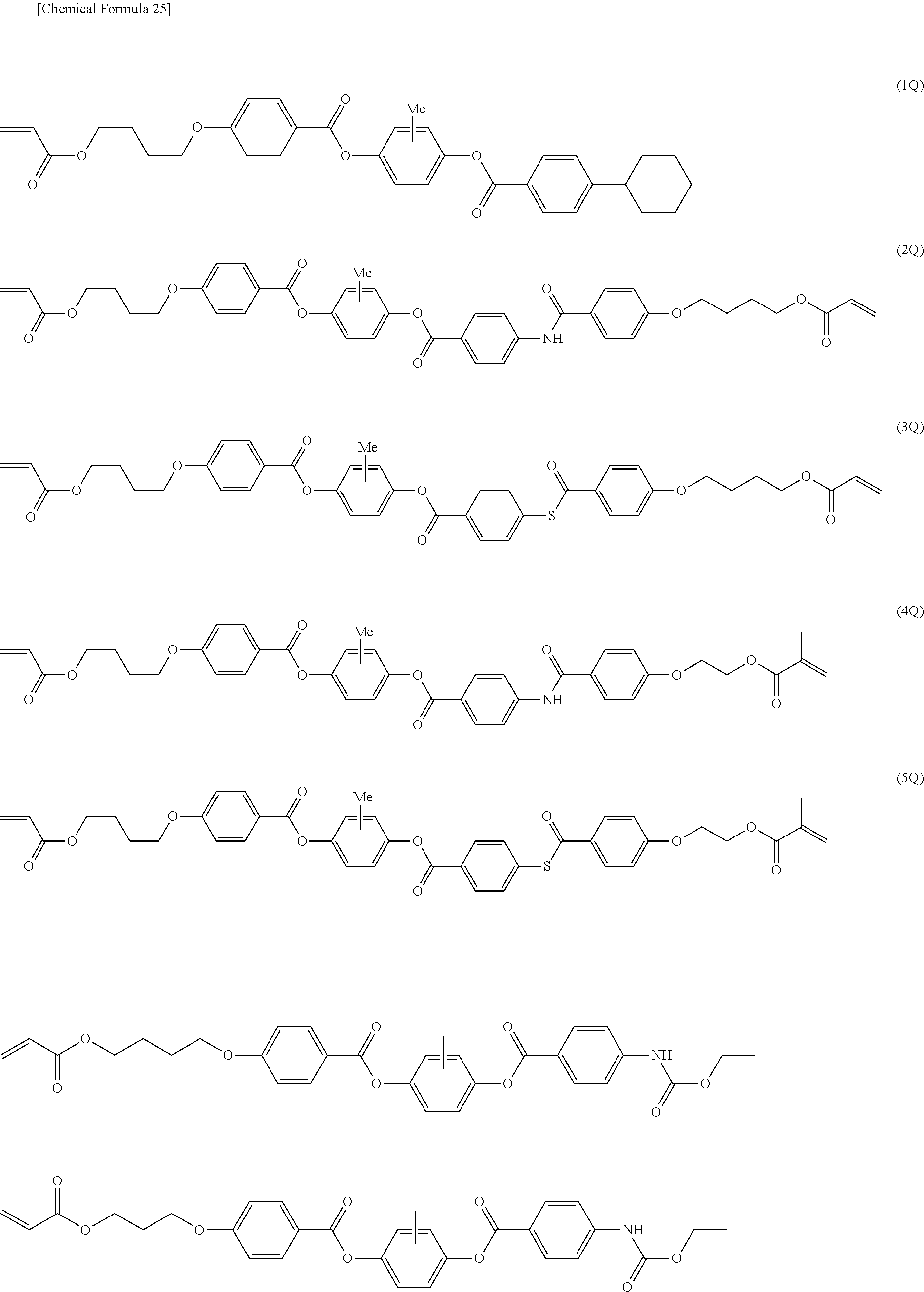

The compound represented by Formula (1) may be manufactured by methods described, for example, in JP-T2-2002-536529, or in Molecular Crystals and Liquid Crystals (2010), 530, 169-174, without special limitation.

### [Compound Represented by Formula (2)]

The compound used for the liquid crystal composition of this invention is a compound represented by the following formula (2), and preferably a liquid crystal compound represented by the following formula (2), and not having (meth)acrylate group.

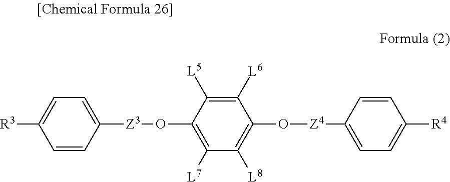

(In Formula (2), Z³ represents —CO— or —CH═CH—CO—;

Z⁴ represents —CO— or —CO—CH═CH—;

each of R³ and R⁴ independently represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, acryloylamino group, N, N-dimethylamino group, maleimide group, methacryloylamino group, allyloxy group, allyloxycarbamoyl group, alkyl group having 1 to 4 carbon atoms N-alkyloxycarbamoyl group, N-(2-methacryloyloxyethyl) carbamoyloxy group, N-(2-acryloyloxyethyl) carbamoyloxy group or a structure represented by Formula (1-2) below;

each of L⁵, L⁶, L⁷ and L⁸ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, wherein at least one of L⁵, L⁶, L⁷ and L⁸ represents a group other than hydrogen atom.)

—Z⁵-T-Sp-P Formula (1-2)

(In Formula (1-2), P represents an acryl group, methacryl group or hydrogen atom, Z⁵ represents —COO—, —CONR¹—(R¹ represents a hydrogen atom or methyl group) or —COS—, T represents a 1,4-phenylene group, Sp represents an optionally substituted divalent aliphatic group having 1 to 12 carbon atoms, wherein one CH₂ group or two or more non-adjacent CH₂ groups in the aliphatic group may be replaced by —O—, —S—, —OCO—, —COO— or —OCOO—.)

Z³ represents —CO— or —CO—CH═CH—, and preferably represents —CO—.

Each of R³ and R⁴ independently represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, acryloylamino group, N,N-dimethylamino group, maleimide group, methacryloylamino group, allyloxy group, allyloxycarbamoyl group, N-alkyloxycarbamoyl group with the alkyl group thereof having 1 to 4 carbon atoms, N-(2-methacryloyloxyethyl)carbamoyloxy group, N-(2-acryloyloxyethyl) carbamoyloxy group or a structure represented by Formula (1-2) below; preferably represents a straight-chain alkyl group having 1 to 4 carbon atoms, methoxy group, ethoxy group, phenyl group, acryloylamino group, methacryloylamino group, allyloxy group, or a structure represented by Formula (1-2); more preferably represents a methyl group, ethyl group, propyl group, methoxy group, ethoxy group, phenyl group, acryloylamino group, methacryloylamino group, or a structure represented by Formula (1-3); and even more preferably represents a methyl group, ethyl group, methoxy group, ethoxy group, phenyl group, acryloylamino group, methacryloylamino group or a structure represented by Formula (1-3).

While R³ and R⁴ may be different from each other, they are preferably same.

L⁵, L⁶, L⁷ and L⁸ are synonymous to L¹, L², L³ and L⁴ in the compound represented by Formula (1), defined by the same preferable ranges.

The compound represented by Formula (2) is preferably a compound represented by Formula (5) below.

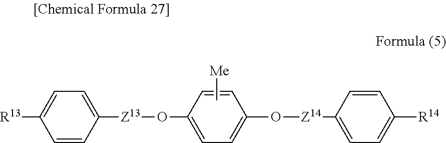

(In Formula (5), Z¹³ represents —CO— or —CO—CH═CH—;

Z¹⁴ represents —CO— or —CH═CH—CO—;

each of R¹³ and R¹⁴ independently represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3).)

Z¹³ represents —CO— or —CO—CH═CH—, and preferably represents —CO—.

Each of R¹³ and R¹⁴ independently represents a hydrogen atom, straight-chain alkyl group having 1 to 4 carbon atoms, methoxy group, ethoxy group, phenyl group, acryloylamino group, methacryloylamino group, allyloxy group or a structure represented by Formula (1-3); more preferably represents a methyl group, ethyl group, propyl group, methoxy group, ethoxy group, phenyl group, acryloylamino group, methacryloylamino group, or a structure represented by Formula (1-3); and even more preferably represents a methyl group, ethyl group, methoxy group, ethoxy group, phenyl group, acryloylamino group, methacryloylamino group or a structure represented by Formula (1-3).

Specific examples of the compound represented by Formula (2) will be shown below, without limiting this invention.

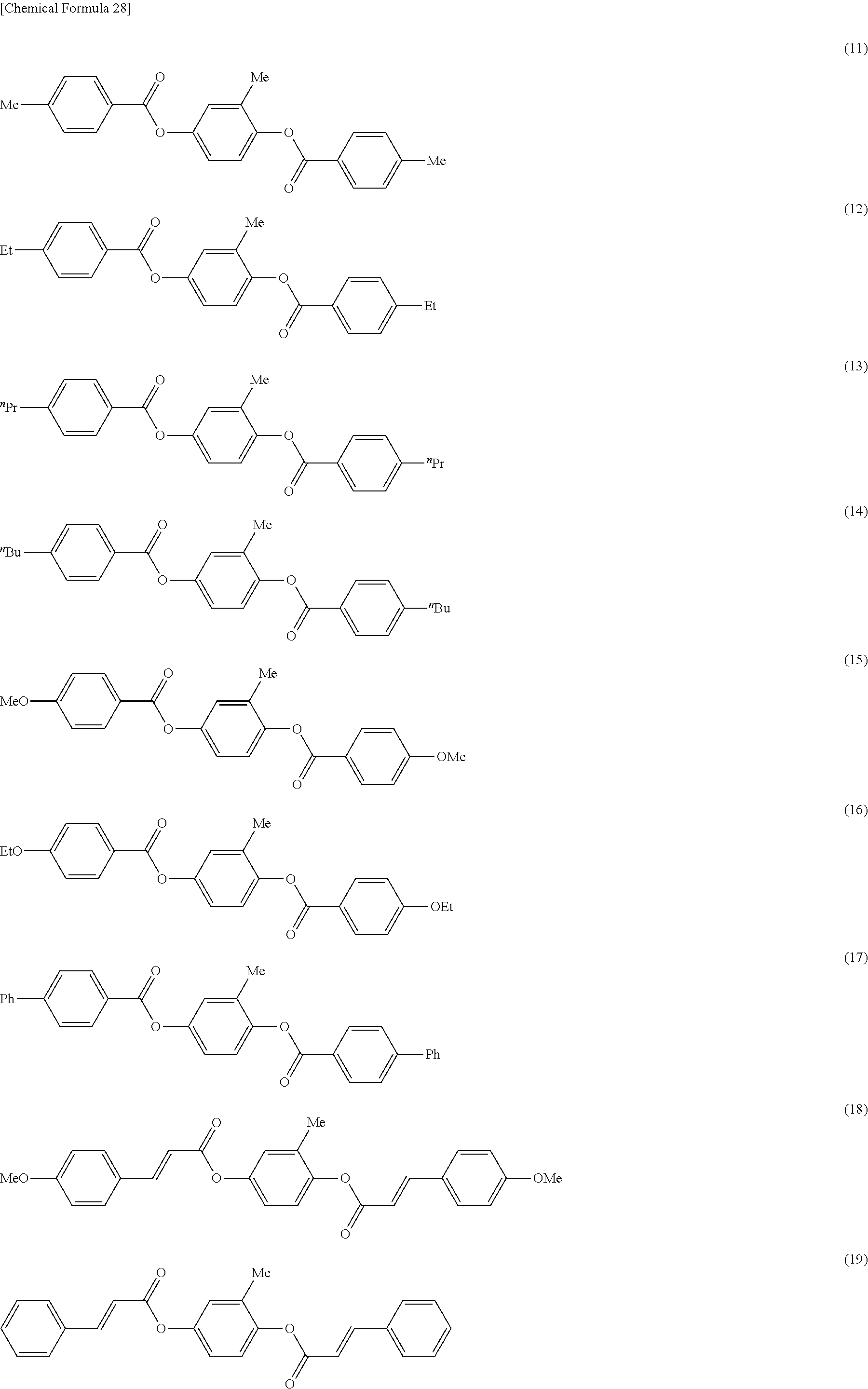

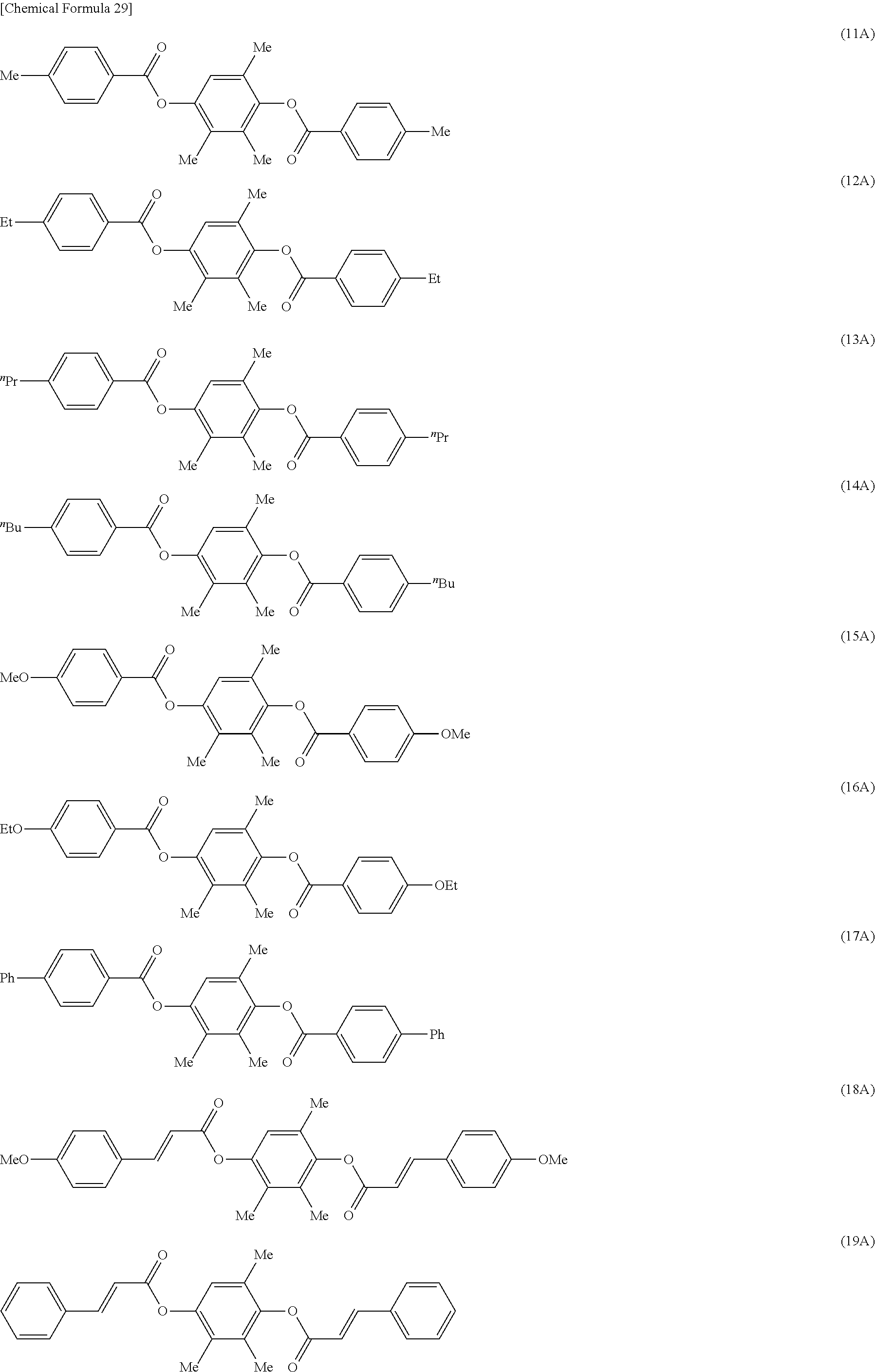

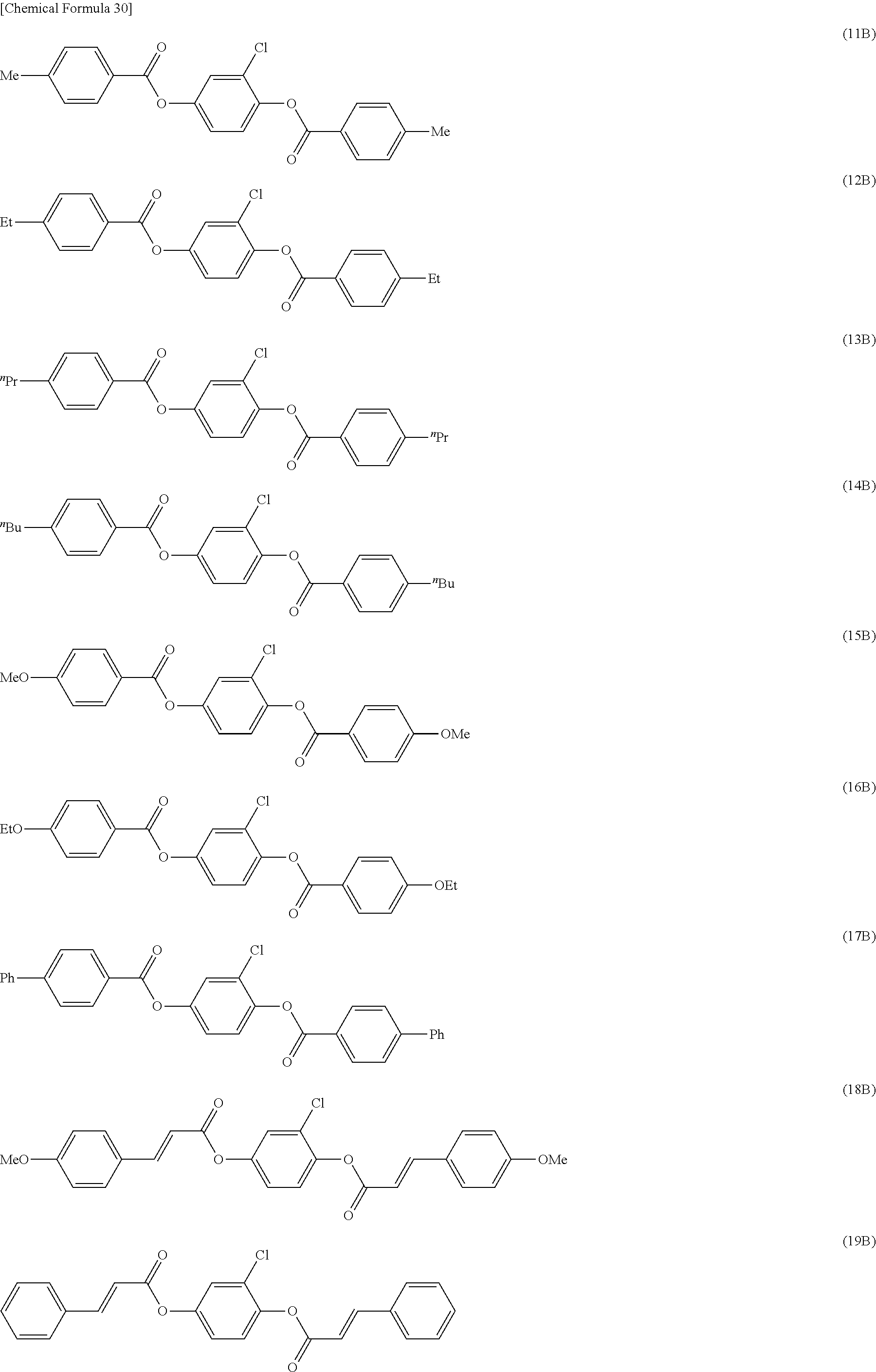

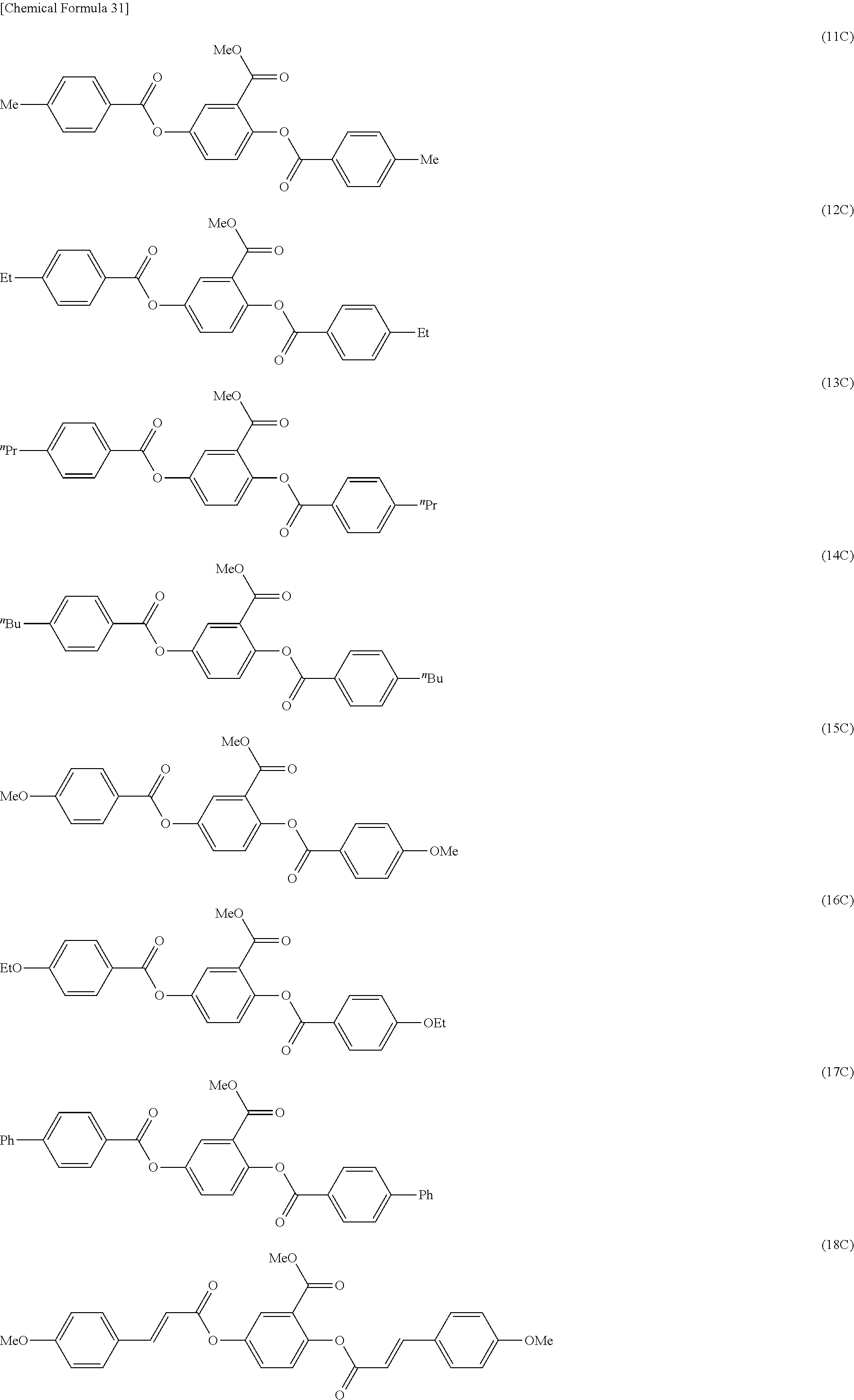

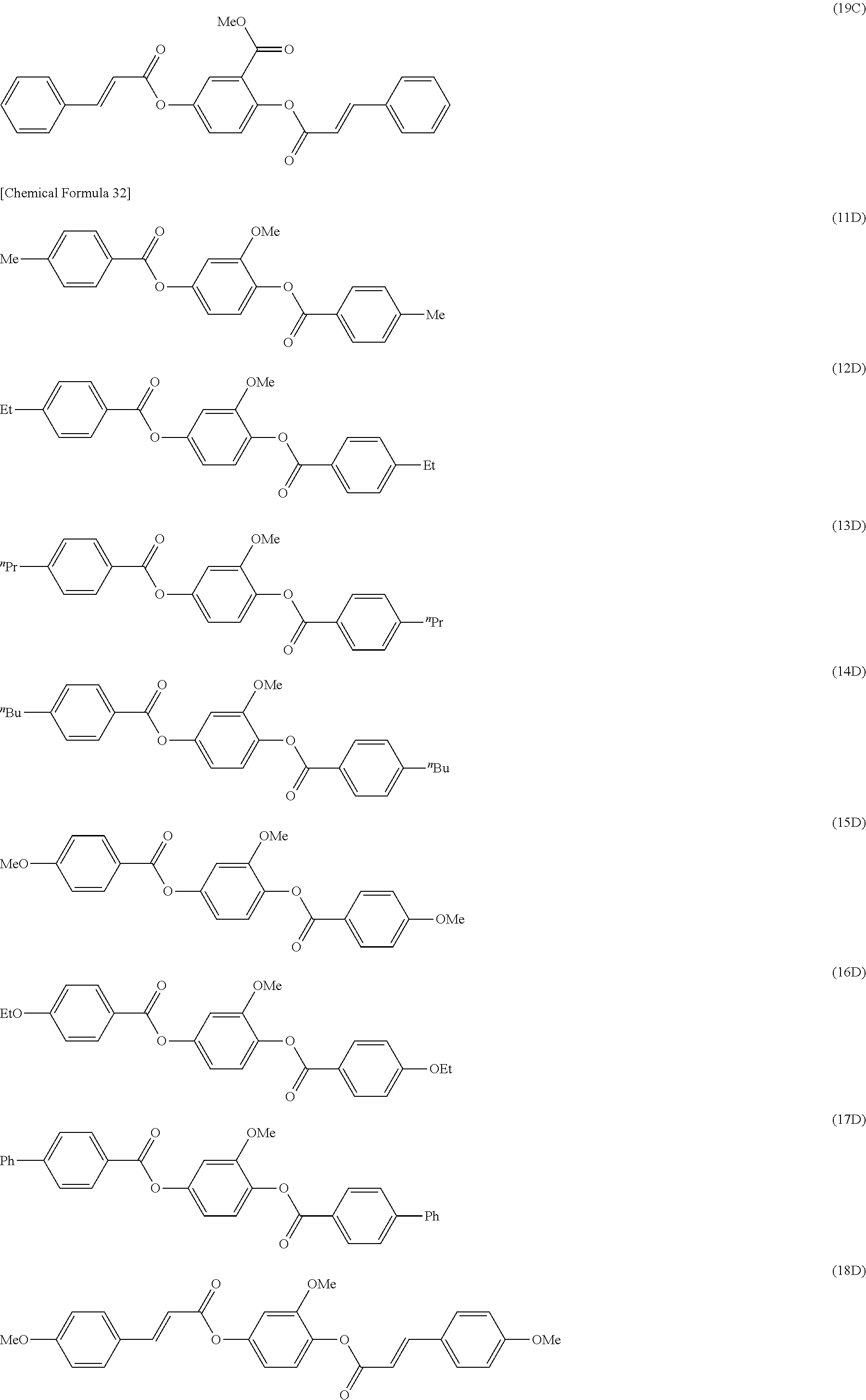

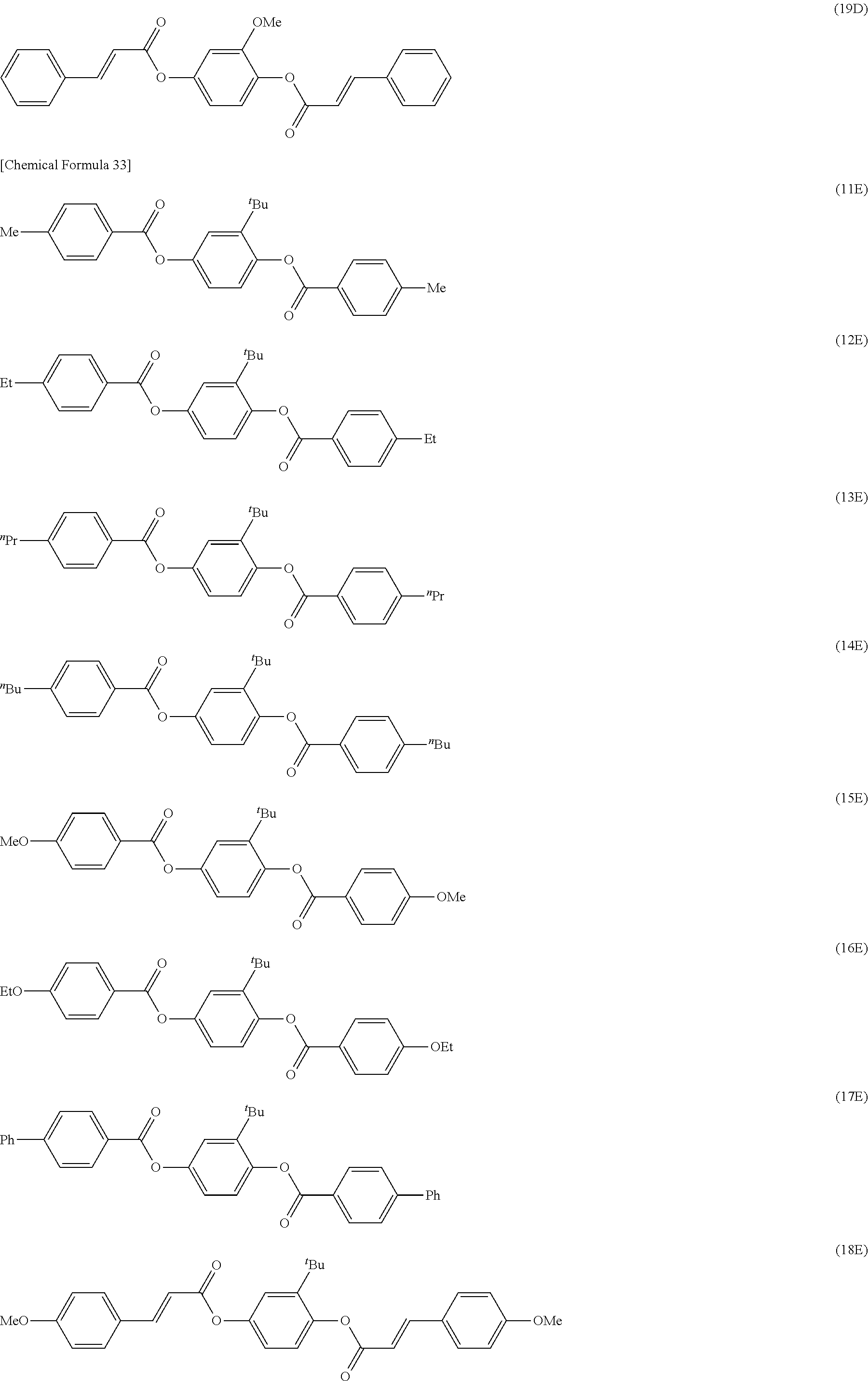

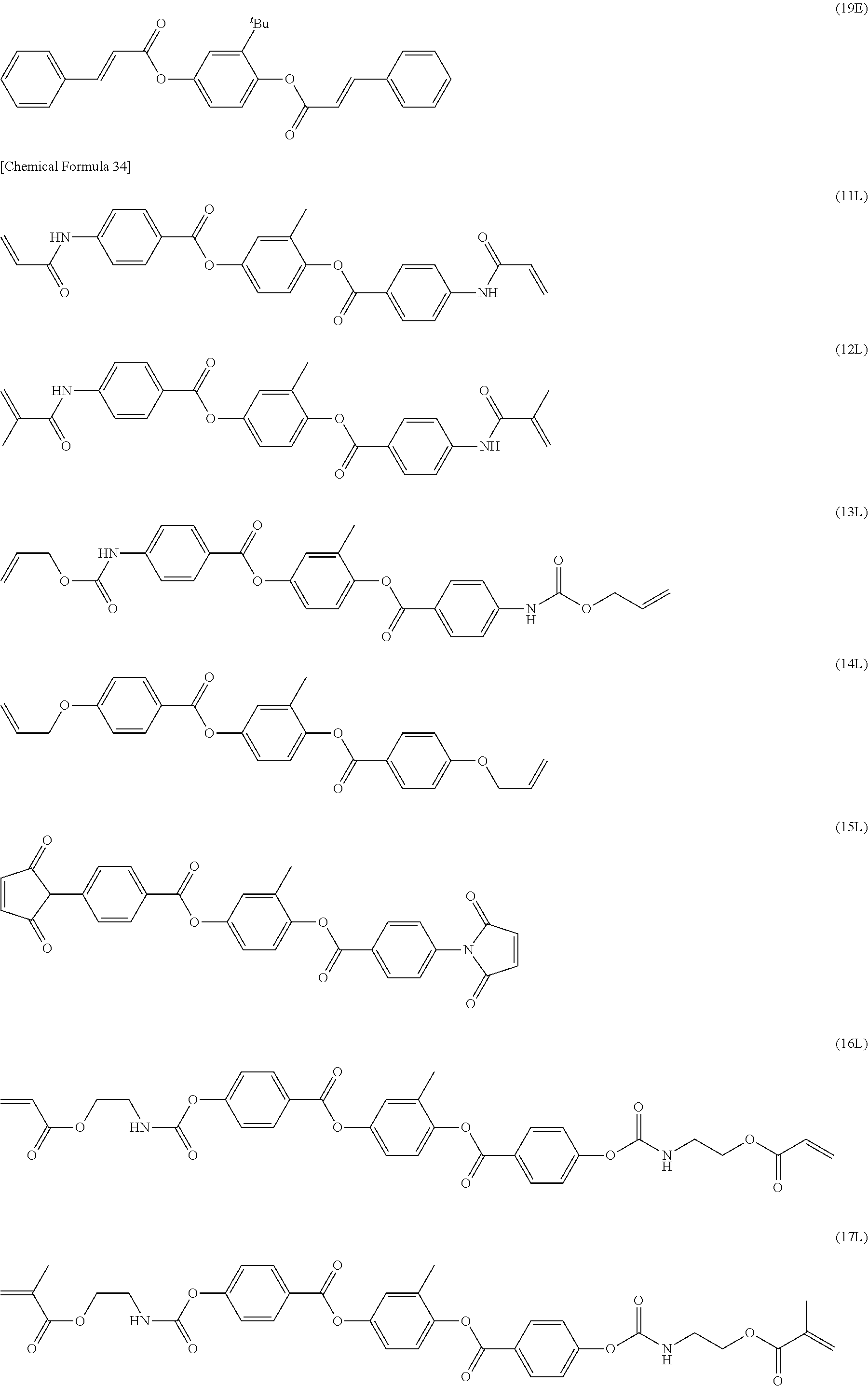

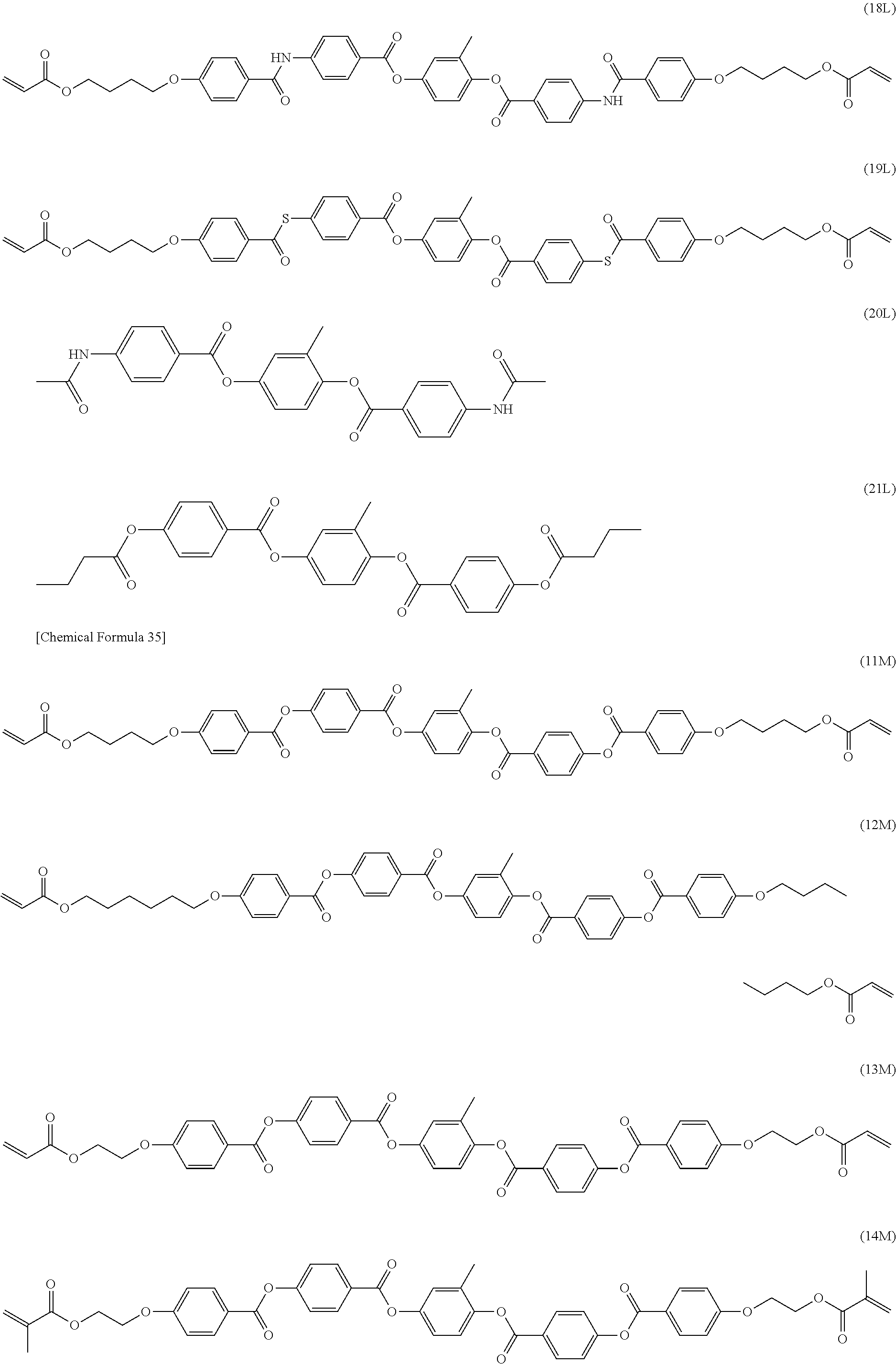

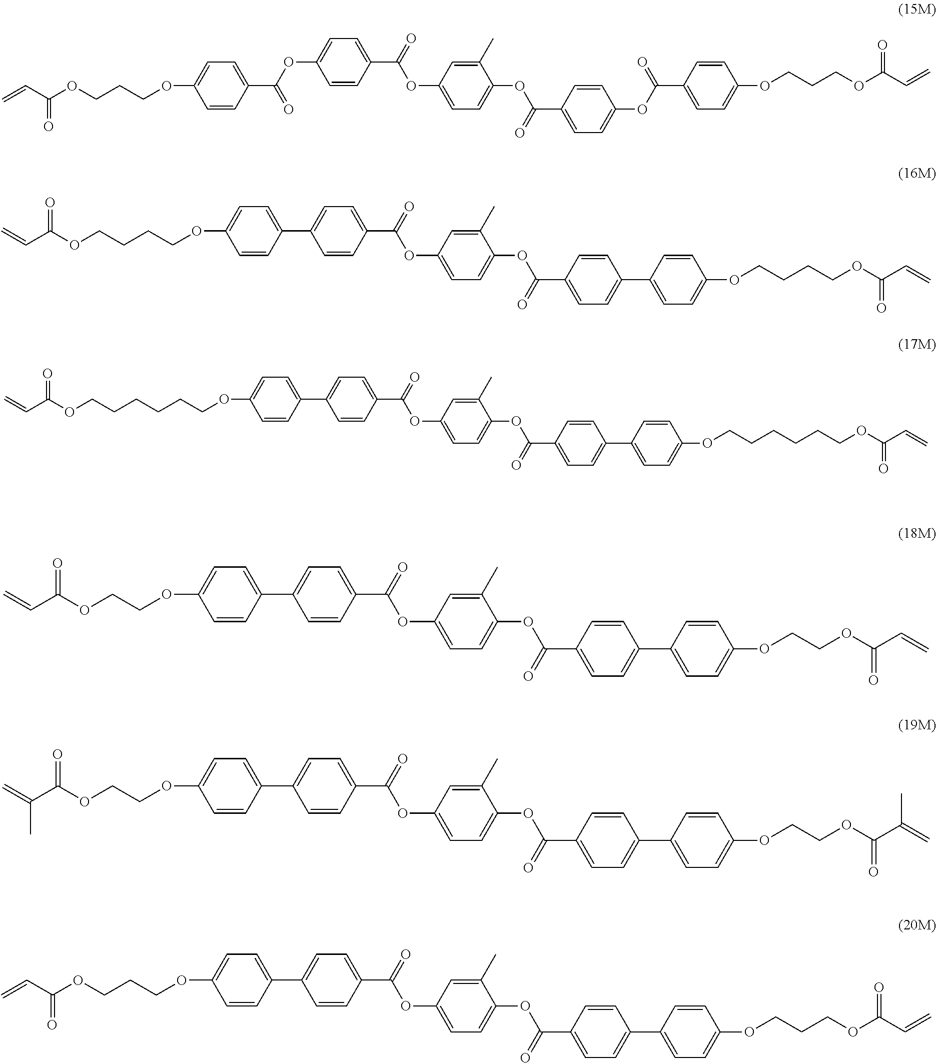

### [Compound Represented by Formula (3)]

The compound used for the liquid crystal composition of this invention is a compound represented by the following formula (3), and is preferably a polymerizable liquid crystal compound represented by the following formula (3), and having two (meth)acrylate groups.

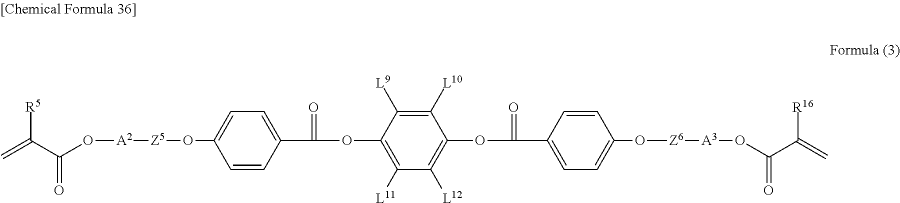

(In Formula (3), each of A² and A³ independently represents an alkylene group having 2 to 18 carbon atoms, wherein one CH₂ group or two or more non-adjacent CH₂ groups in the methylene group may be replaced by —O—;

Z⁵ represents —CO—, —O—CO— or single bond;

Z⁶ represents —CO—, —CO—O— or single bond;

each of R⁵ and R⁶ independently represents a hydrogen atom or methyl group;

each of L⁹, L¹⁰, L¹¹ and L¹² independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, wherein at least one of L⁹, L¹⁰, L¹¹ and L¹² represents a group other than hydrogen atom.)

Each of A² and A³ independently represents an alkylene group having 2 to 18 carbon atoms, and one CH₂ group or two or more non-adjacent CH₂ groups in the methylene group may be replaced by —O—.

It is preferable that each of A² and A³ independently represents a methylene group having 2 to 7 carbon atoms, and more preferably represents a methylene group having 3 to 6 carbon atoms. It is particularly preferable that each of A² and A³ represents a methylene group having 4 carbon atoms. While one CH₂ group or two or more non-adjacent CH₂ groups in the methylene group may be replaced by —O—, the number of CH₂ groups contained in the methylene group and substituted by —O— is preferably 0 to 2, more preferably 0 or 1, and particularly 0.

Z⁵ represents —CO—, —O—CO— or single bond, and more preferably represents a single bond or —O—CO—.

Z⁶ represents —CO—, —CO—O— or single bond, and more preferably a single bond or —CO—O—.

Each of R⁵ and R⁶ independently represents a hydrogen atom or methyl group, and preferably represents a hydrogen atom.

L⁹, L¹⁰, L¹¹ and L¹² are synonymous to L¹, L², L³ and L⁴ in the compound represented by Formula (1), defined by the same preferable ranges.

The compound represented by Formula (3) is preferably a compound represented by Formula (6) below.

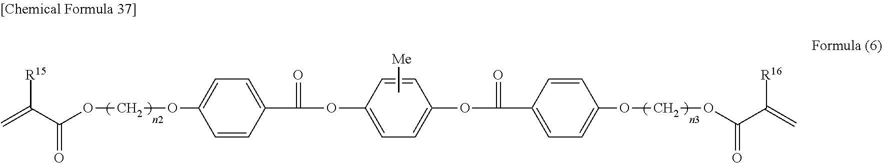

(in Formula (6), each of n2 and n3 independently represents an integer of 3 to 6; and
each of R¹⁵ and R¹⁶ independently represents a hydrogen atom or methyl group.)

In Formula (6), each of n2 and n3 independently represents an integer of 3 to 6, and each of n2 and n3 preferably represents 4.

In Formula (6), each of R¹⁵ and R¹⁶ independently represents a hydrogen atom or methyl group, and each of R¹⁵ and R¹⁶ preferably represents a hydrogen atom.

Specific examples of the compound represented by Formula (3) will be shown below, without limiting this invention.

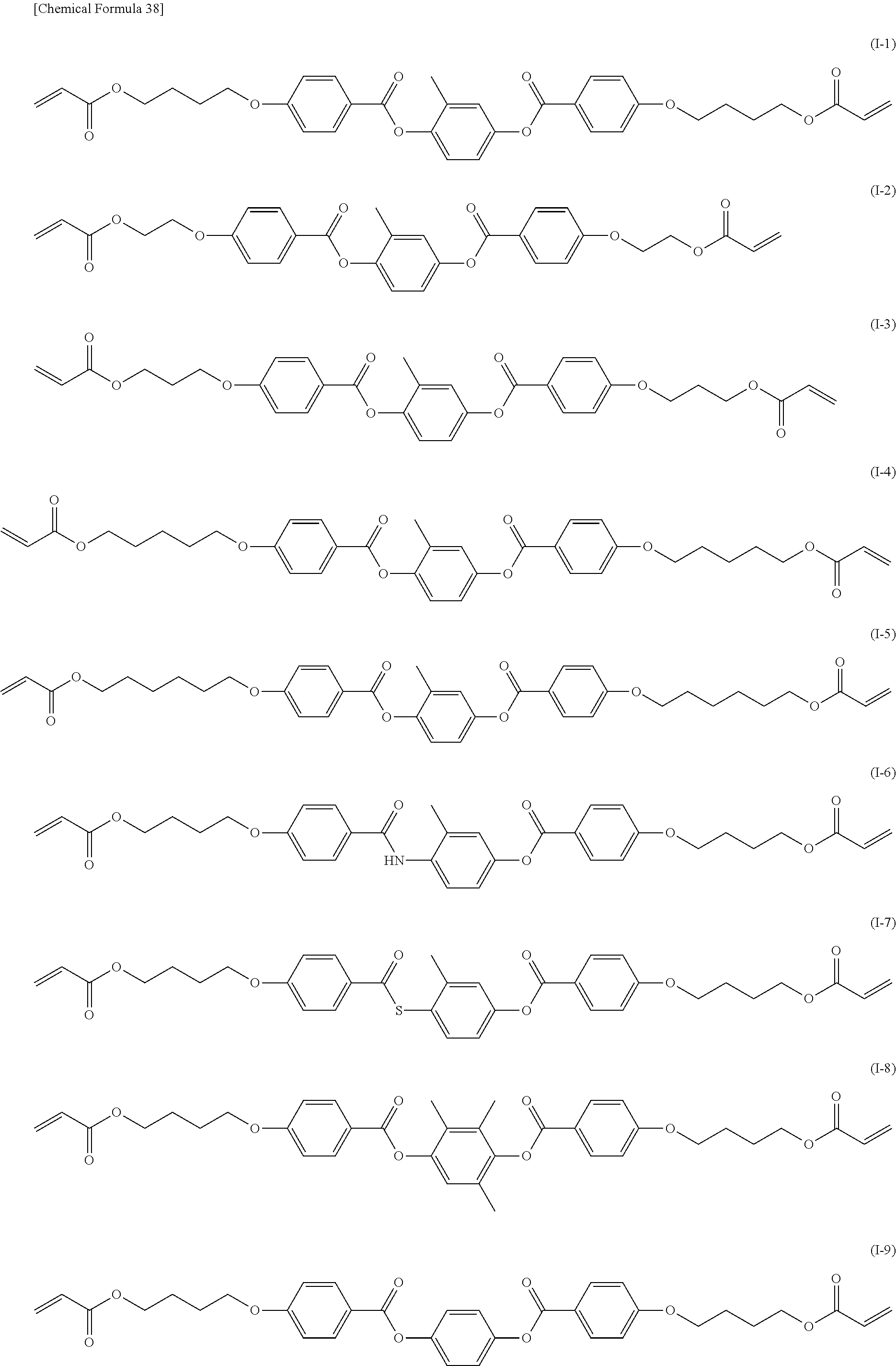

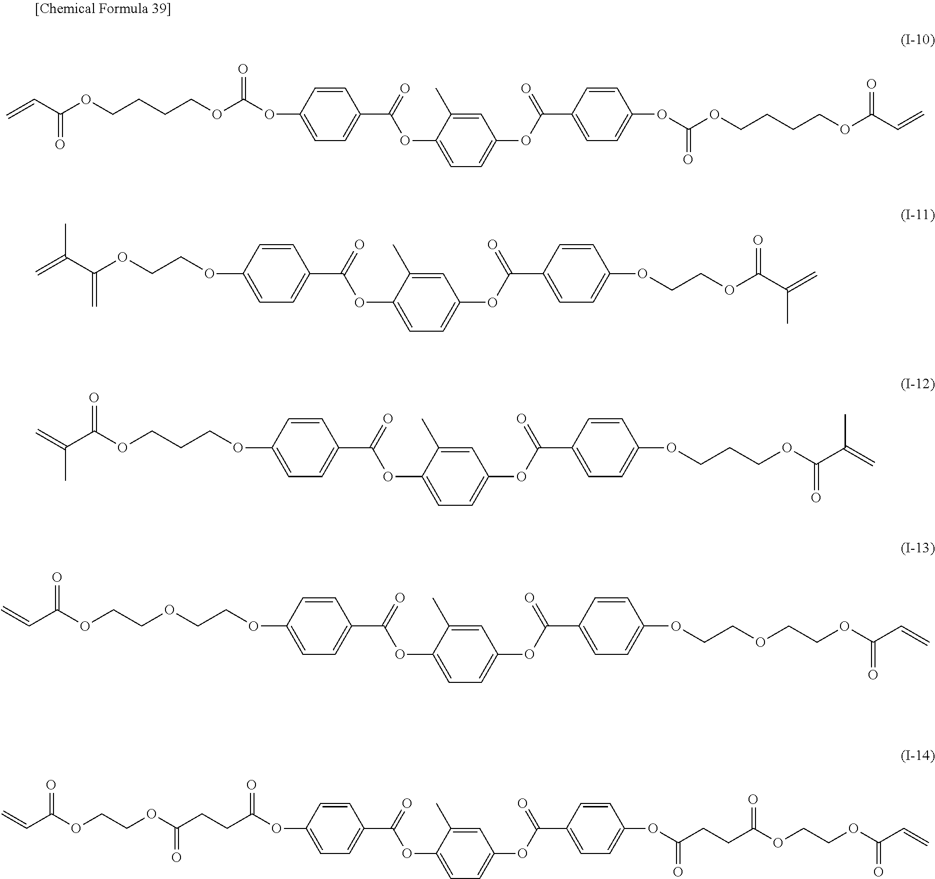

The polymerizable liquid crystal compound represented by Formula (3) may be manufactured by a method described, for example, in JP-A-2009-184975, without special limitation.

(Preferable Embodiment of Liquid Crystal Composition of this Invention)

Preferable embodiments of the liquid crystal composition of this invention are as follows.

(A) Liquid crystal composition containing the compounds represented by Formulae (4), (5) and (6).

(B) Liquid crystal composition containing the compounds represented by Formulae (4), (5) and (6), wherein in Formulae (4) and (5), at least two of R¹², R¹³ and R¹⁴ represent the same substituent, and more preferably R¹², R¹³ and R¹⁴ represent the same substituent.

(C) Liquid crystal composition containing the compounds represented by Formulae (4), (5) and (6), wherein in Formula (4), n1 is 4.

(D) Liquid crystal composition containing the compounds represented by Formulae (4), (5) and (6), wherein in Formulae (4) and (6), each of R¹¹, R¹⁵ and R¹⁶ represents a hydrogen atom.

(E) Liquid crystal composition containing the compounds represented by Formulae (4), (5) and (6), wherein in Formulae (4) and (5), each of Z¹², Z¹³ and Z¹⁴ represents —CO—.

(F) Liquid crystal composition containing the compounds represented by Formulae (4), (5) and (6), wherein in Formulae (4) and (5), each of R¹², R¹³ and R¹⁴ independently represents a straight-chain alkyl group having 1 to 4 carbon atoms, methoxy group, ethoxy group or phenyl group, and preferably, each of the R¹², R¹³ and R¹⁴ independently represents a methyl group, ethyl group, methoxy group, ethoxy group or phenyl group.

### (Compositional Ratio of Polymerizable Liquid Crystal Compound)

The liquid crystal composition of this invention preferably contains, relative to the compound represented by Formula (3), 3 to 50% by mass of the compound represented by Formula (1), and 0.01 to 10% by mass of the compound represented by Formula (2), and more preferably, again relative to the compound represented by Formula (3), 5 to 40% by mass of the compound represented by Formula (1), and 0.1 to 5% by mass of the compound represented by Formula (2). With the compositional ratio controlled in these ranges, the liquid crystal composition will further be improved in the suppressive effect on crystallization.

### Second Embodiment of this Invention

### Method for Manufacturing Liquid Crystal Composition

The liquid crystal composition of this invention may be obtained typically by the method for manufacturing described below. More specifically, a liquid crystal compound represented by Formula (I) below, and a liquid crystal compound represented by Formula (II) below may be obtained concurrently, by allowing a compound represented by Formula (III) to react with a carboxylic acid represented by Formula (IV) below and a carboxylic acid represented by Formula (V) below.

P¹-Sp¹-T¹-A²¹-B-A²²-T¹-Sp¹-P¹ Formula (I)

P¹-Sp¹-T¹-A²¹-B-A²²-T²-X Formula (II)

HY¹—B—Y²H Formula (III)

P¹-Sp¹-T¹-COOH Formula (IV)

X-T²-COOH Formula (V)

(In Formulae (I) to (V), P¹ represents a polymerizable group. Sp¹ represents an optionally substituted divalent aliphatic group having 3 to 12 carbon atoms, wherein one CH₂ group or two or more non-adjacent CH₂ groups in the aliphatic group may be replaced by —O—, —S—, —OCO—, —COO— or —OCOO—. T¹ represents a 1,4-phenylene group. T² represents a single bond or divalent group having a cyclic structure. A²¹ represents —COO—, (R¹ represents a hydrogen atom or methyl group) or —COS—. Each of A²² and A²³ independently represents —OCO—, —NR^{1A}CO— (R^{1A} represents a hydrogen atom or methyl group) or —SCO—. B represents an optionally substituted divalent group having a cyclic structure.

X represents a hydrogen atom, branched or straight-chain alkyl group having 1 to 12 carbon atoms, branched or straight-chain alkoxy group having 1 to 12 carbon atoms, phenyl group, cyano group, halogen atom, nitro group, acetyl group or vinyl group. Each of Y¹ and Y² independently represents O, NR^{1B} (R^{1B} represents a hydrogen atom or methyl group) or S). X represents a hydrogen atom, branched or straight-chain alkyl group having 1 to 12 carbon atoms, branched or straight-chain alkoxy group having 1 to 12 carbon atoms, phenyl group, cyano group, halogen atom, nitro group, acetyl group or vinyl group, formyl group, —OC(═O)R (R represents an alkyl group having 1 to 12 carbon atoms), N-acetylamide group, acryloylamino group, N,N-dimethylamino group, N-maleimide group, methacryloylamino group, allyloxy group, N-alkyloxycarbamoyl group with the alkyl group thereof having 1 to 4 carbon atoms, allyloxycarbamoyl group, N-(2-methacryloyloxyethyl) carbamoyloxy group, N-(2-acryloyloxyethyl) carbamoyloxy group or a structure represented by Formula (V-I) below.

-A⁴-T⁴-Sp²-P² Formula (V-I)

(in Formula (V-I), P² represents a polymerizable group or hydrogen atom, and each of A⁴, T⁴ and Sp² is synonymous to A²³, T² and Sp¹, respectively.

According to this manufacturing method, by using two different species of carboxylic acid as a part of raw materials, it now becomes possible to manufacture a liquid crystal composition which is excellent in the suppressive effect on crystallization, solubility and liquid crystallinity, in a one-pot manner.

According to the manufacturing method of this invention, by allowing the compound represented by Formula (III) to react with the carboxylic acid represented by Formula (IV) and the carboxylic acid represented by Formula (V), not only the liquid crystal compound represented by Formula (I) and the liquid crystal compound represented by Formula (II), but also a liquid crystal compound represented by Formula (II-a) may be obtained concurrently.

X-T²-A²³-B-A²³-T²-X Formula (II-a)

(In Formula (II-a), B represents an optionally substituted divalent group having a cyclic structure. A²³ is synonymous to A²³ in Formula (II). T² is synonymous to T² in Formula (II). X is synonymous to X in Formula (II).

### <Synthetic Scheme, Order of Synthesis, and Reaction Conditions>

Now the phrase of “concurrently” obtaining the liquid crystal compound represented by Formula (I) and liquid crystal compound represented by Formula (II) means not only that both liquid crystal compounds are synthesized at the same time, but also that they are obtained in a one-pot manner, by allowing the compound represented by Formula (III) to react with the carboxylic acid represented by Formula (IV) and the carboxylic acid represented by Formula (V).

An exemplary synthetic scheme of the method for manufacturing a liquid crystal composition of this invention will be shown below. Note in this specification, Compounds (I) to (V) represent the compounds represented by Formulae (I) to (V), respectively.

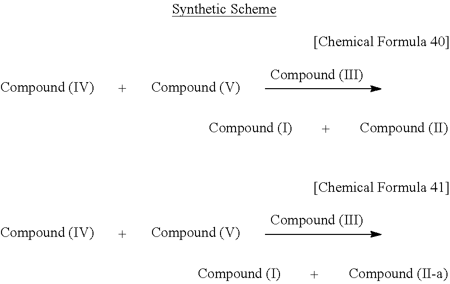

In the method for manufacturing a liquid crystal composition of this invention, the order of synthesis is not specifically limited, and may follow any order other than the synthetic scheme shown above.

The order of addition of the carboxylic acid represented by Formula (IV) and the carboxylic acid represented by Formula (V) is not specifically limited.

It is preferable that the method for manufacturing a liquid crystal composition of this invention further includes a step of activating the carboxylic acid represented by Formula (IV) and the carboxylic acid represented by Formula (V) by deriving them into a mixed acid anhydride or acid halide, and that, following the activation step, the compound represented by Formula (III) is allowed to react with the thus activated carboxylic acid represented by Formula (IV) and the carboxylic acid represented by Formula (V), in the presence of a base.

An activator used for the activation step is not specifically limited, for which methanesulfonyl chloride or toluenesulfonyl chloride is typically used. Also the base is not specifically limited, for which tertiary amine (for example, triethylamine, or diisopropylethylamine), or inorganic salt is typically used. The activation step is preferably allowed to proceed under cooling on ice.

The compound represented by Formula (III) is preferably added after the activation step, from the viewpoint of avoiding the activator from adversely affecting the compound represented by Formula (III). The compound represented by Formula (III) is preferably added, after the activation step, and under the presence of a base, to the activated carboxylic acid represented by Formula (IV) and the carboxylic acid represented by Formula (V), under cooling on ice. While there is no special limitation on condition under which the compound represented by Formula (III) is added to the activated carboxylic acid represented by Formula (IV) and the carboxylic acid represented by Formula (V), the condition is preferably 0 to 30° C., and is more preferably 10 to 25° C.

### <Compound Represented by Formula (III)>

In the method for manufacturing a liquid crystal composition of this invention, the compound represented by Formula (III) below may be used as a part of the raw material.

HY¹—B—Y²H Formula (III)

(in Formula (III), B represents an optionally substituted divalent group having a cyclic structure. Each of Y¹ and Y² independently represents O, NR^{1C} (R^{1C} represents a hydrogen atom or methyl group) or S).

B represents an optionally substituted divalent group having a cyclic structure, and is preferably any one linking group contained in the group of linking groups (VI) below.

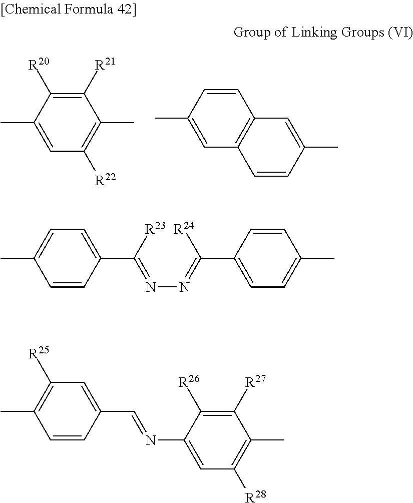

In the group of Formulae (VI), each of R²⁰ to R²⁸ independently represents a hydrogen atom, branched or straight-chain having 1 to 4 carbon atoms alkyl group, branched or straight-chain alkoxy group having 1 to 4 carbon atoms, halogen atom, or, alkoxycarbonyl group having 1 to 3 carbon atoms.

Each of R²⁰ to R²⁸ independently represents a hydrogen atom, branched or straight-chain alkyl group having 1 to 4 carbon atoms, and particularly a hydrogen atom, or straight-chain alkyl group having 1 or 2 carbon atoms.

It is particularly preferable that B represents any one linking group contained in the group of linking groups (VIII) below.

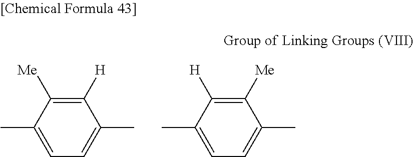

Each of Y¹ and Y² independently represents O, NR^{1D} (R^{1D} represents a hydrogen atom or methyl group) or S, and preferably represents O.

Examples of the compounds represented by Formula (III) will be shown below, without limiting this invention.

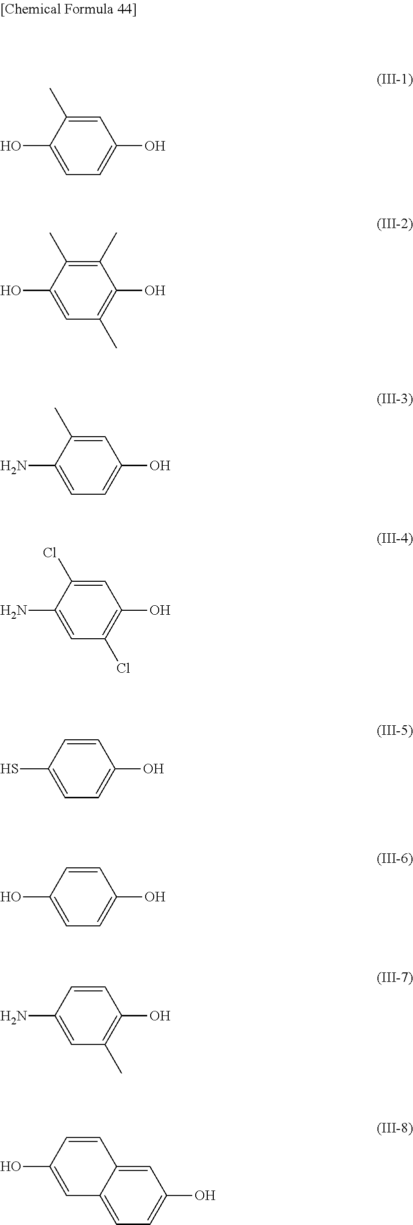

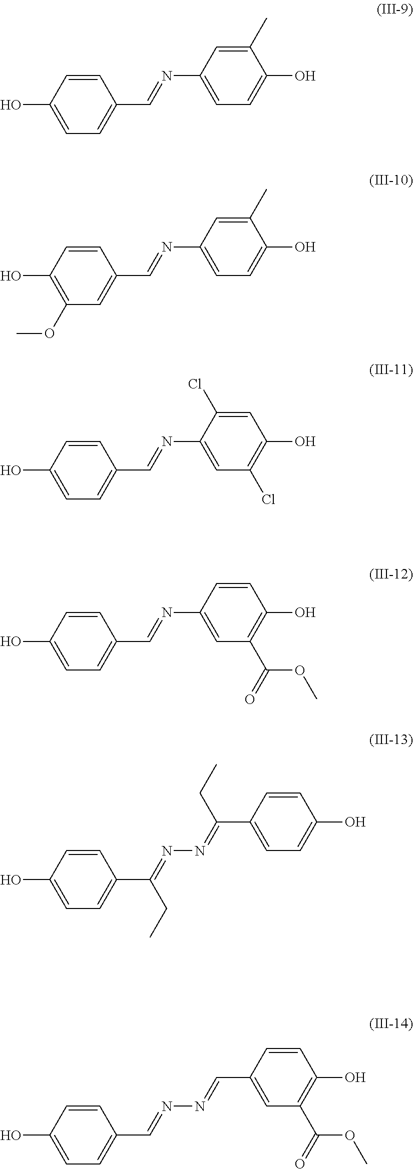 [SMILES: Cc1cc(/N=C/c2ccc(O)cc2)ccc1O ; COc1cc(/C=N/c2ccc(O)c(C)c2)ccc1O ; Oc1ccc(/C=N/c2cc(Cl)c(O)cc2Cl)cc1 ; COC(=O)c1cc(/N=C/c2ccc(O)cc2)ccc1O ; CC/C(=N\N=C(/CC)c1ccc(O)cc1)c1ccc(O)cc1 ; COC(=O)c1cc(/C=N/N=C/c2ccc(O)cc2)ccc1O]

### <Carboxylic Acid Represented by Formula (IV)>

In the method for manufacturing a liquid crystal composition of this invention, the carboxylic acid represented by Formula (IV) below may be used as a part of the raw material.

P¹-Sp¹-T¹-COOH Formula (IV)

In Formula (IV), P¹ represents a polymerizable group. Sp¹ represents an optionally substituted divalent aliphatic group having 3 to 12 carbon atoms, wherein one CH₂ group or two or more non-adjacent CH₂ groups in the aliphatic group may be substituted by —O—, —S—, —OCO—, —COO— or —OCOO—. T¹ represents a 1,4-phenylene group.

P¹ represents a polymerizable group, without special limitation. Details and preferable ranges of the polymerizable group may be referred to paragraphs [0161] to [0171] of JP-A-2002-129162, the contents of which may be incorporated into this specification. P¹ preferably represents an ethylenic unsaturated double bond group, more preferably represents a methacryloyl group or acryloyl group, and particularly represents an acryloyl group.

Sp¹ represents an optionally substituted divalent aliphatic group having 3 to 12 carbon atoms, wherein one CH₂ group or two or more non-adjacent CH₂ groups in the aliphatic group may be replaced by —O—, —S—, —OCO—, —COO— or —OCOO—.

Sp¹ represents an optionally substituted divalent alkylene group having 3 to 12 carbon atoms, more preferably an alkylene group having 3 to 8 carbon atoms, and even more preferably an alkylene group having 3 to 6 carbon atoms, wherein the non-adjacent methylene groups in the alkylene group may be substituted by —O—. While the alkylene group may be branched or not branched, more preferable is a straight-chain alkylene group having no branching.

Examples of the carboxylic acid represented by Formula (IV) will be shown below, without limiting this invention.

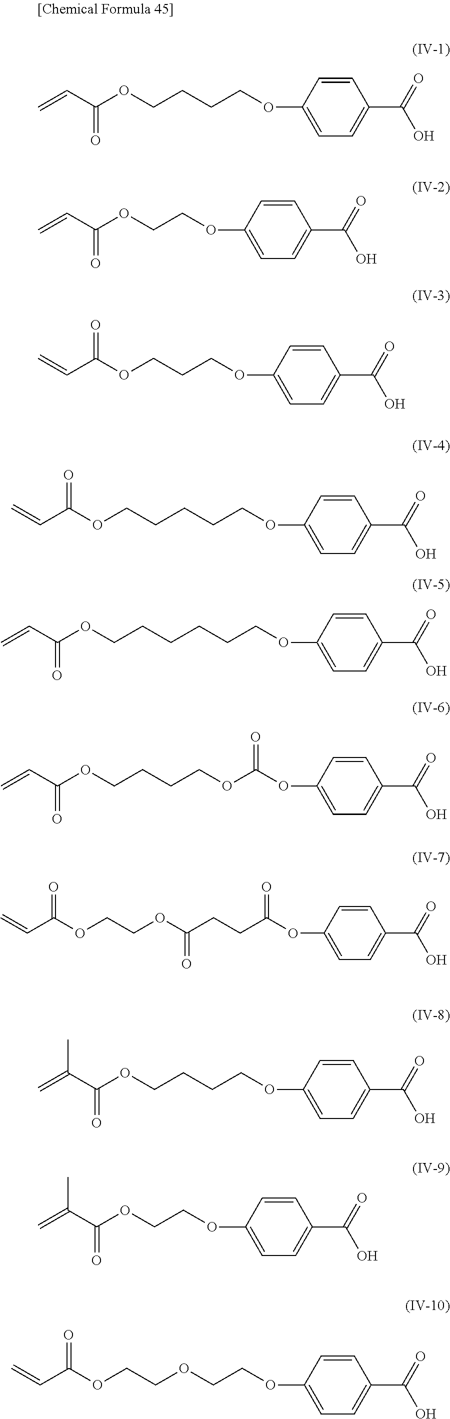

### <Carboxylic Acid Represented by Formula (V)>

In the method for manufacturing a liquid crystal composition of this invention, the carboxylic acid represented by Formula (V) below may be used as a part of the raw material.

X-T²-COOH Formula (V)

In Formula (V), T² represents a single bond or divalent group having a cyclic structure. X represents a hydrogen atom, branched or straight-chain alkyl group having 1 to 12 carbon atoms, branched or straight-chain alkoxy group having 1 to 12 carbon atoms, phenyl group, cyano group, halogen atom, nitro group, acetyl group, vinyl group, formyl group, —OC(═O)R (R represents an alkyl group having 1 to 12 carbon atoms), N-acetylamide group, acryloylamino group, N,N-dimethylamino group, N-maleimide group, methacryloylamino group, allyloxy group, N-alkyloxycarbamoyl group with the alkyl group thereof having 1 to 4 carbon atoms, allyloxycarbamoyl group, N-(2-methacryloyloxyethyl) carbamoyloxy group, N-(2-acryloyloxyethyl) carbamoyloxy group or a structure represented by Formula (V-I).

T² represents a single bond or divalent group having a cyclic structure, preferably represents a single bond, or a divalent group having a divalent aromatic hydrocarbon group or divalent heterocyclic group, and more preferably represents a divalent aromatic hydrocarbon group or divalent heterocyclic group.

The number of carbon atoms of the aromatic hydrocarbon group is preferably 6 to 22, more preferably 6 to 14, even more preferably 6 to 10, and yet more preferably 6. The divalent aromatic hydrocarbon group, when having 6 carbon atoms, preferably has bonds at the meta position or para position, and particularly has bonds at the para position.

The divalent heterocyclic group preferably has a five-membered, six-membered or seven-membered heterocycle. Five-membered ring or six-membered ring is more preferable, and six-membered ring is most preferable. Heteroatom which composes the heterocycle is preferably nitrogen atom, oxygen atom or sulfur atom. The heterocycle is preferably an aromatic heterocycle. The aromatic heterocycle is generally an unsaturated heterocycle. The unsaturated heterocycle more preferably has the largest possible number of double bonds. Examples of the heterocycle include furan ring, thiophene ring, pyrrole ring, pyrroline ring, pyrrolidine ring, oxazole ring, isooxazole ring, thiazole ring, isothiazole ring, imidazole ring, imidazoline ring, imidazolidine ring, pyrazole ring, pyrazoline ring, pyrazolidine ring, triazole ring, furazan ring, tetrazole ring, pyrane ring, thiine ring, pyridine ring, piperidine ring, oxazine ring, morpholine ring, thiazine ring, pyridazine ring, pyrimidine ring, pyrazine ring, piperazine ring, and triazine ring.

The divalent aromatic hydrocarbon group or divalent heterocyclic group may have an additional divalent linking group. The divalent linking group is preferably an alkenyl group having 2 to 4 carbon atoms, and more preferably an alkenyl group having 2 carbon atoms.

In the method for manufacturing a liquid crystal composition of this invention, T² is preferably any one linking group contained in the group of linking groups (VII) below.

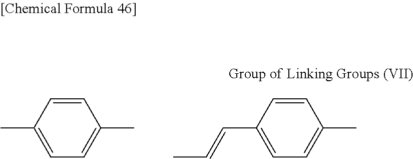

X represents a hydrogen atom, branched or straight-chain alkyl group having 1 to 12 carbon atoms, branched or straight-chain alkoxy group having 1 to 12 carbon atoms, phenyl group, cyano group, halogen atom, nitro group, acetyl group or vinyl group; preferably represents a hydrogen atom, branched or straight-chain alkyl group having 1 to 4 carbon atoms, straight-chain alkoxy group having 1 or 2 carbon atoms, or phenyl group; even more preferably represents a branched or straight-chain alkyl group having 1 to 4 carbon atoms, straight-chain alkoxy group having 1 or 2 carbon atoms, or phenyl group; and particularly represents a straight-chain alkyl group having 1 to 4 carbon atoms, or phenyl group.

X preferably represents an acryloylamino group, methacryloylamino group, allyloxy group, N-alkyloxycarbamoyl group with the alkyl group thereof having 1 to 4 carbon atoms, allyloxycarbamoyl group, or a structure represented by Formula (V-I); and more preferably represents an acryloylamino group, methacryloylamino group, or a structure represented by Formula (V-I).

In Formula (V-I), P² represents a polymerizable group or hydrogen atom, wherein the polymerizable group is preferable. Preferable range of the polymerizable group is synonymous to that of P¹ described previously. Also A⁴, T⁴ and Sp² are independently synonymous to A²³, T² and Sp¹, defined by the same preferable ranges.

It is particularly preferable that, in Formula (V-I), P² represents a methacryloyl group or acryloyl group, Sp² represents a divalent non-branched alkylene group having 1 to 12 carbon atoms, wherein one CH₂ group or two or more non-adjacent CH₂ groups in the alkylene group may be replaced by —O—, —OCO—, —COO— or —OCOO—, T⁴ represents a 1,4-phenylene group, and A⁴ represents —OCO—.

Examples of the carboxylic acid represented by Formula (V) will be shown below, without limiting this invention.

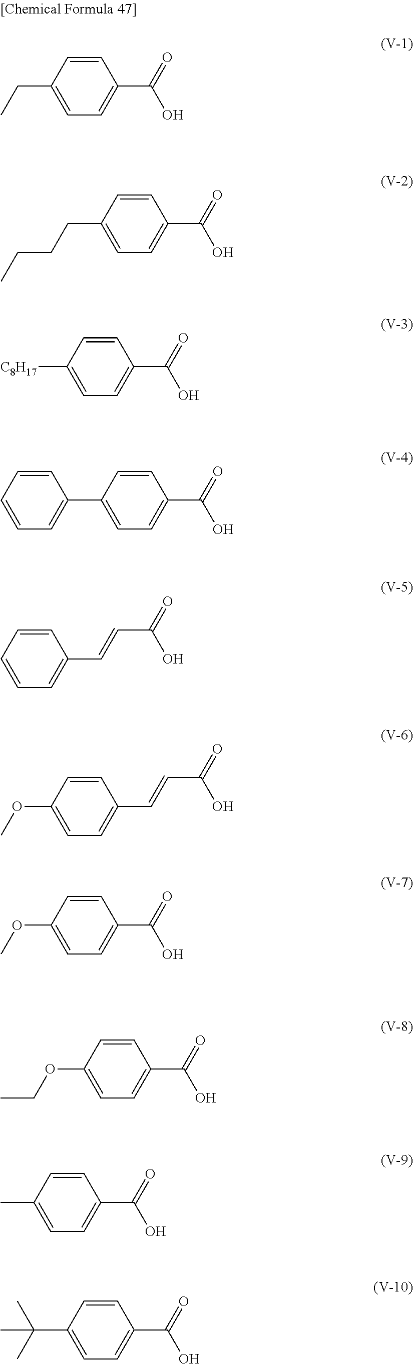

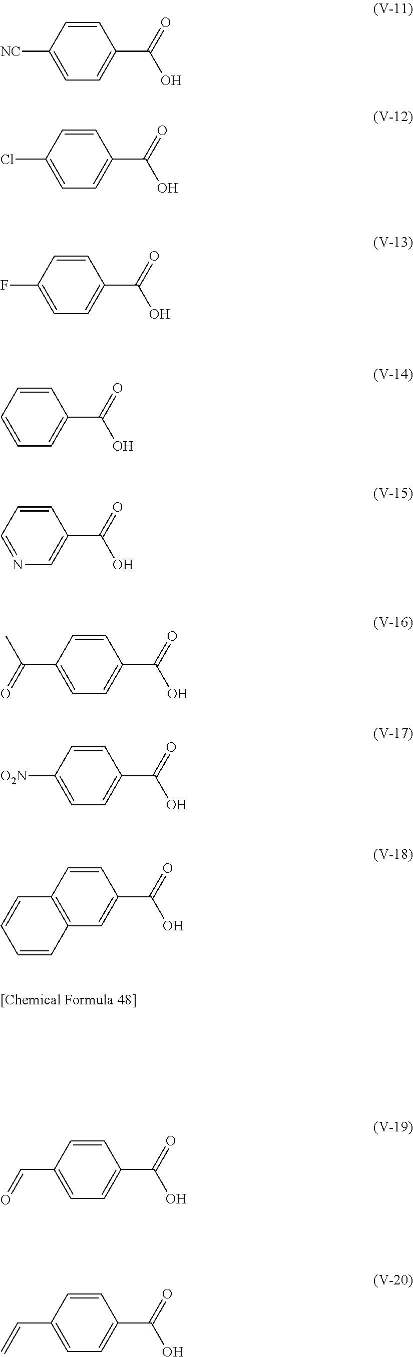

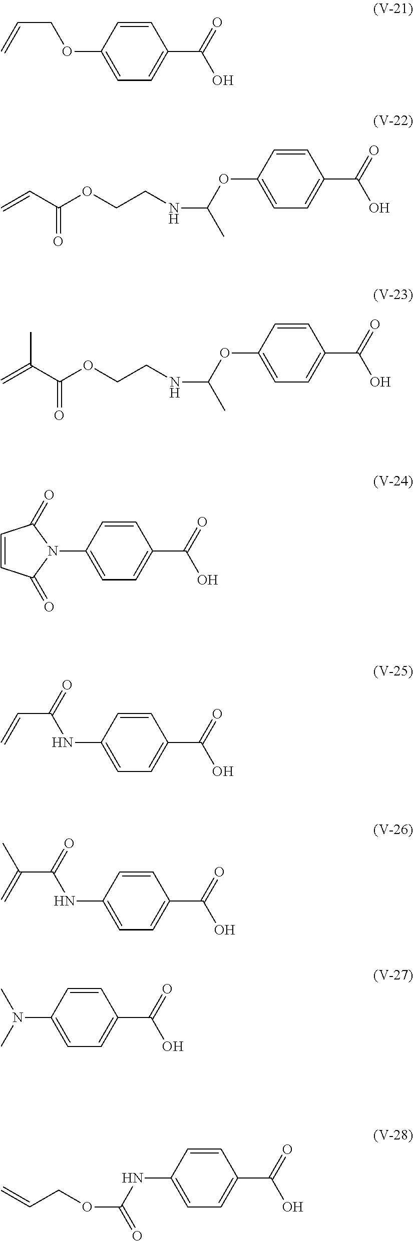

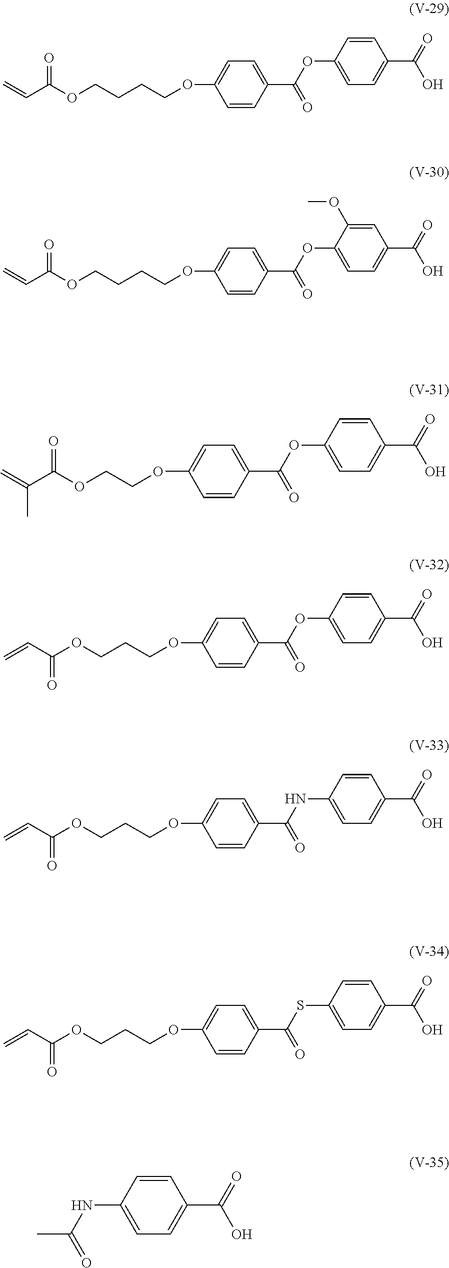

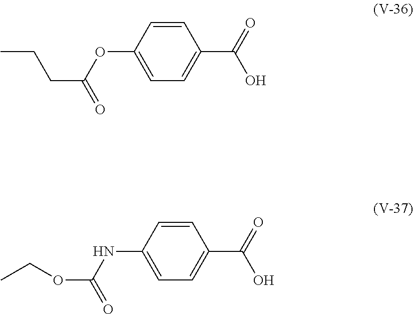

In the method for manufacturing a liquid crystal composition of this invention, the feed ratio by mole of the carboxylic acid represented by Formula (IV) and the carboxylic acid represented by Formula (V) is preferable in the range from 75:25 to 99:1, more preferably in the range from 77:33 to 95:5, and particularly preferably in the range from 80:20 to 90:10.

### <Liquid Crystal Compound Represented by Formula (I) and Liquid Crystal Compound Represented by Formula (II)>

In the method for manufacturing a liquid crystal composition of this invention, the liquid crystal compound represented by Formula (I) below and the liquid crystal compound represented by Formula (II) below are obtained concurrently.

P¹-Sp¹-T¹-A²¹-B-A²²-T¹-Sp¹-P¹ Formula (I)

P¹-Sp¹-T¹-A²¹-B-A²³-T²-X Formula (II)

In Formulae (I) and (II), P¹ represents a polymerizable group. Sp¹ represents an optionally substituted divalent aliphatic group having 3 to 12 carbon atoms, wherein one CH₂ group or two or more non-adjacent CH₂ groups in the aliphatic group may be replaced by —O—, —S—, —OCO—, —COO— or —OCOO—. T¹ represents a 1,4-phenylene group. T² represents a single bond or divalent group having a cyclic structure. A²¹ represents —COO—, —CONR^{1E}— (R^{1E} represents a hydrogen atom or methyl group) or —COS—. Each of A²² and A²³ independently represents a —OCO—, —NR^{1F}CO— (R^{1F} represents a hydrogen atom or methyl group) or —SCO—. B represents an optionally substituted divalent group having a cyclic structure. X represents a hydrogen atom, branched or straight-chain alkyl group having 1 to 12 carbon atoms, branched or straight-chain alkoxy group having 1 to 12 carbon atoms, phenyl group, cyano group, halogen atom, nitro group, acetyl group, vinyl group, formyl group, —OC(═O)R (R represents an alkyl group having 1 to 12 carbon atoms), N-acetylamide group, acryloylamino group, N, N-dime thylamino group, N-maleimide group, methacryloylamino group, allyloxy group, N-alkyloxycarbamoyl group with the alkyl group thereof having 1 to 4 carbon atoms, allyloxycarbamoyl group, N-(2-methacryloyloxyethyl) carbamoyloxy group, N-(2-acryloyloxyethyl) carbamoyloxy group or a structure represented by Formula (V-I).

Preferable ranges for P¹, Sp¹, T², B and X in Formulae (I) and (II) are same as the preferable ranges for P¹, Sp¹, T², B and X in Formulae (III) to (V).

In Formulae (I) and (II), A²¹ represents —COO—, —CONR^{1E}— (R^{1E} represents a hydrogen atom or methyl group) or —COS—, and preferably represents —COO—.

In Formulae (I) and (II), each of A²² and A²³ independently represents —OCO—, —NR^{1F}CO— (R^{1F} represents a hydrogen atom or methyl group) or —SCO—, and more preferably represents —OCO—.

In Formulae (I) and (II), it is particularly preferable that A²¹ represents —COO—, and, that each of A²² and A²³ represents —OCO—.

Specific examples of the compound represented by Formula (I), other than I-1 to I-14 described above, will be shown below, without limiting this invention.

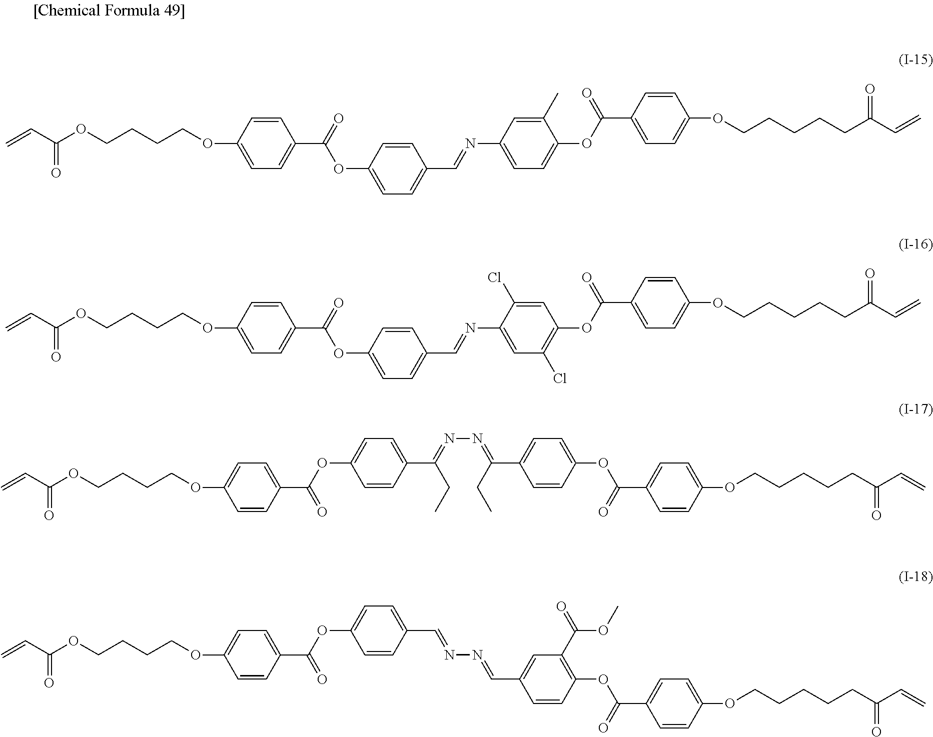

Specific examples of the compound represented by Formula (II) will be shown below, without limiting this invention.

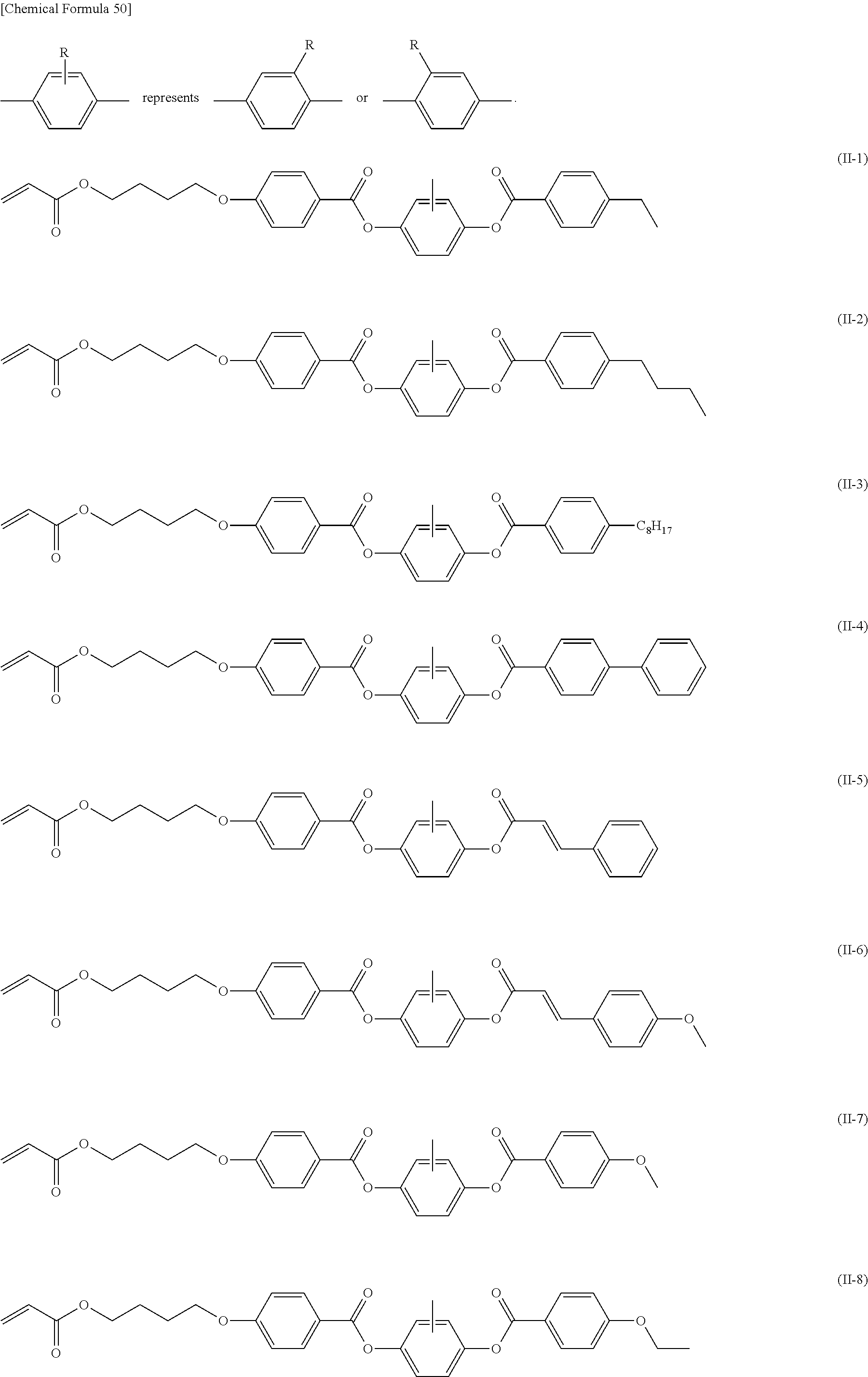

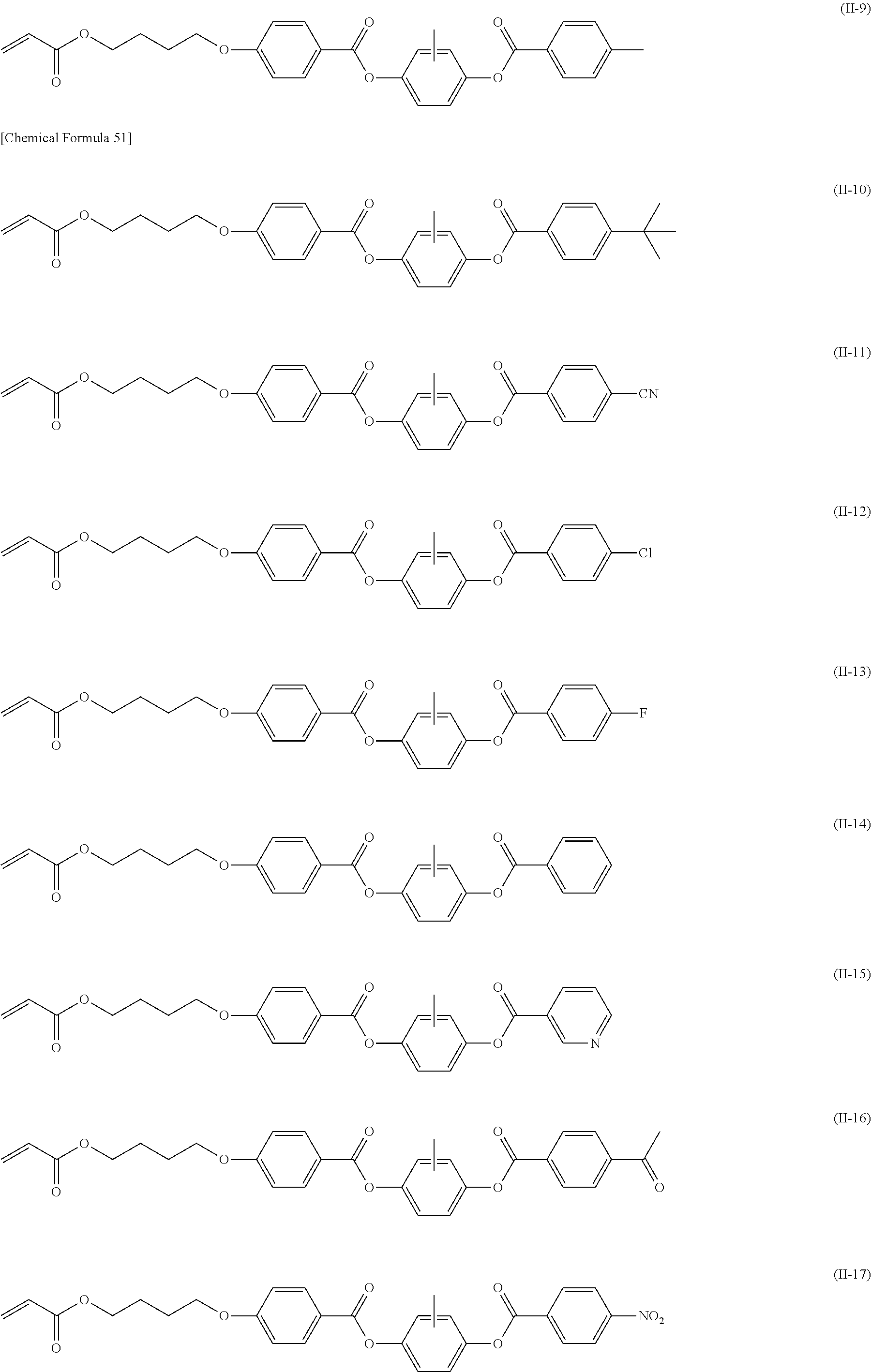

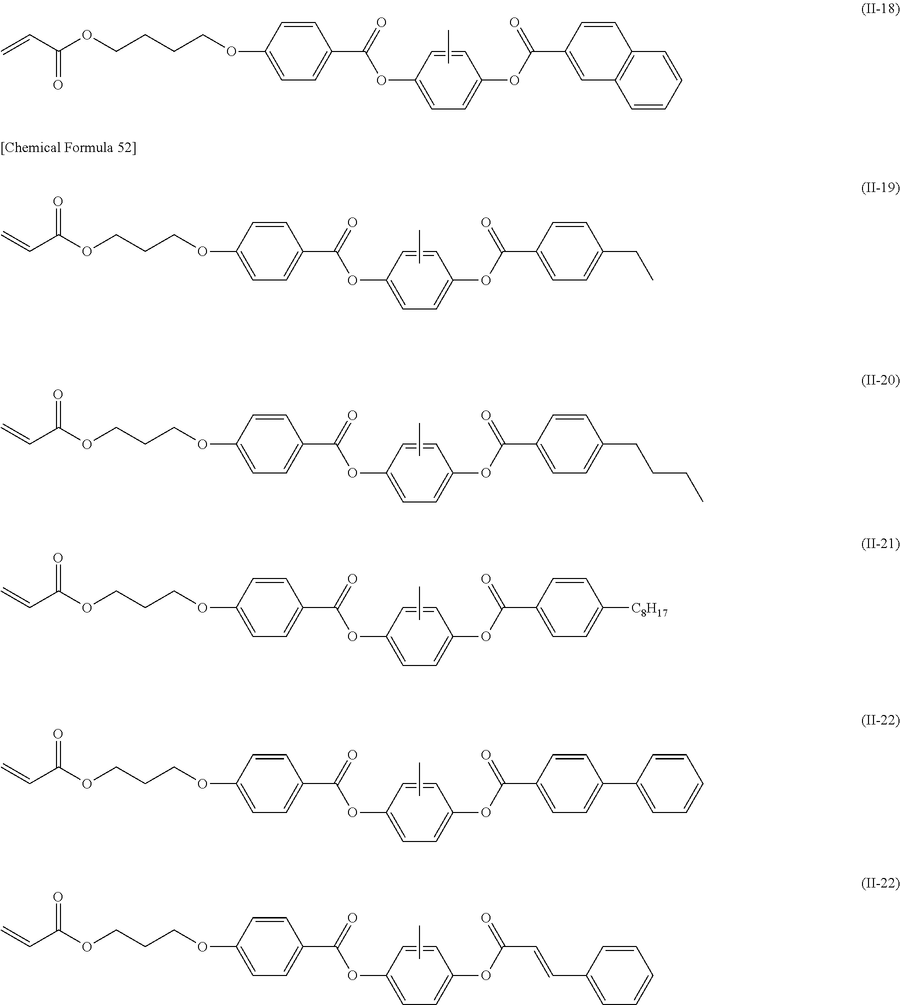

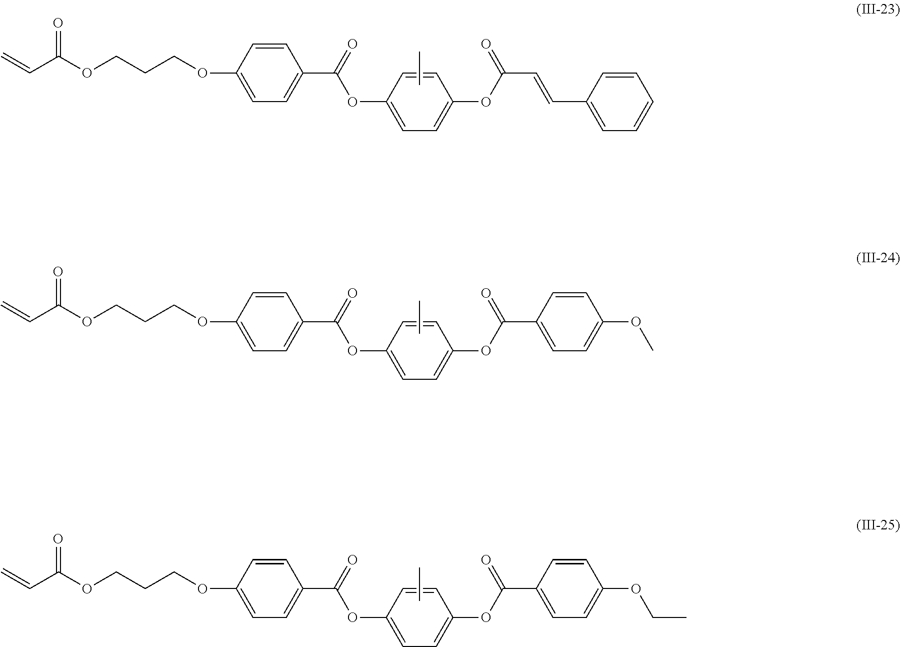

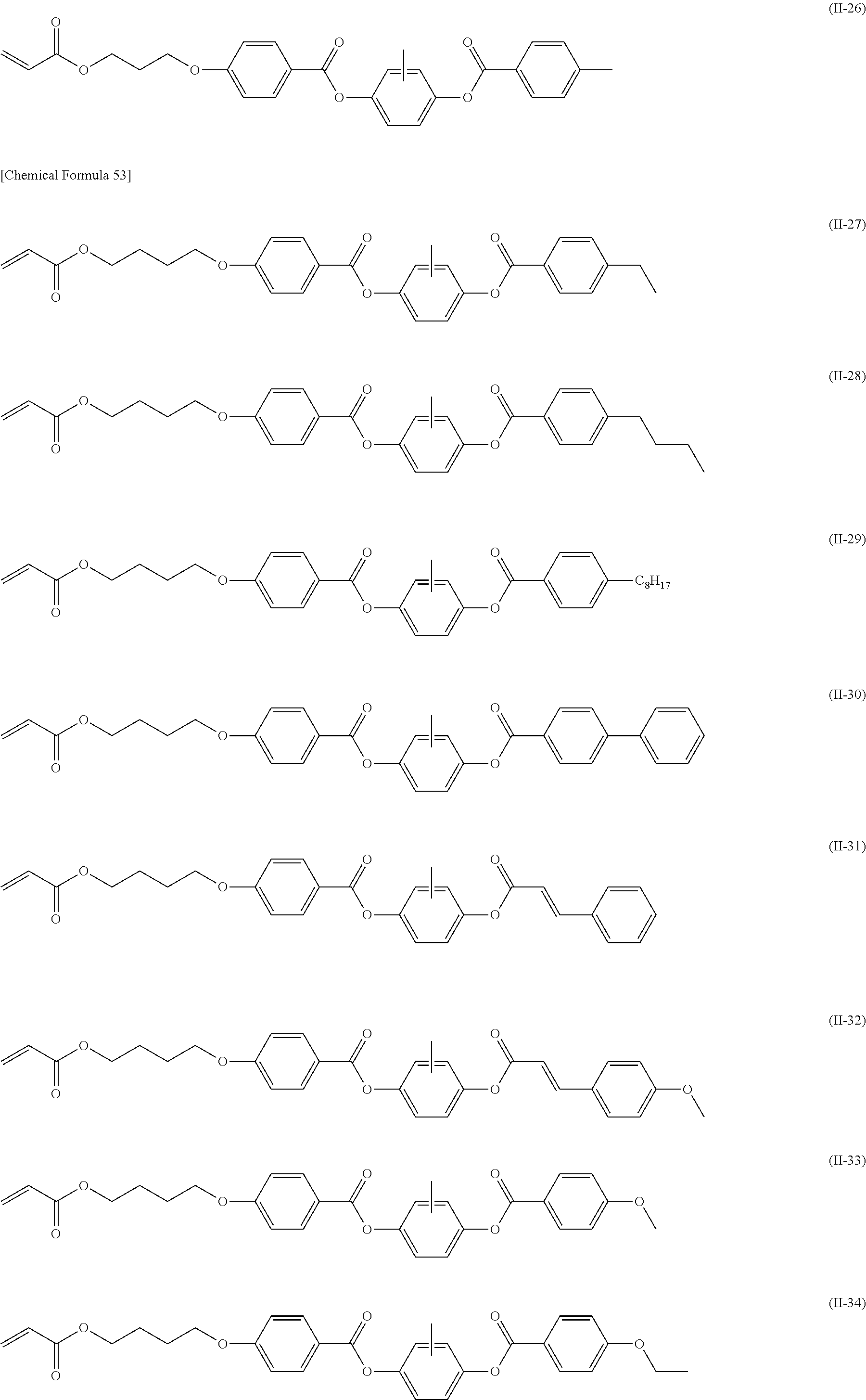

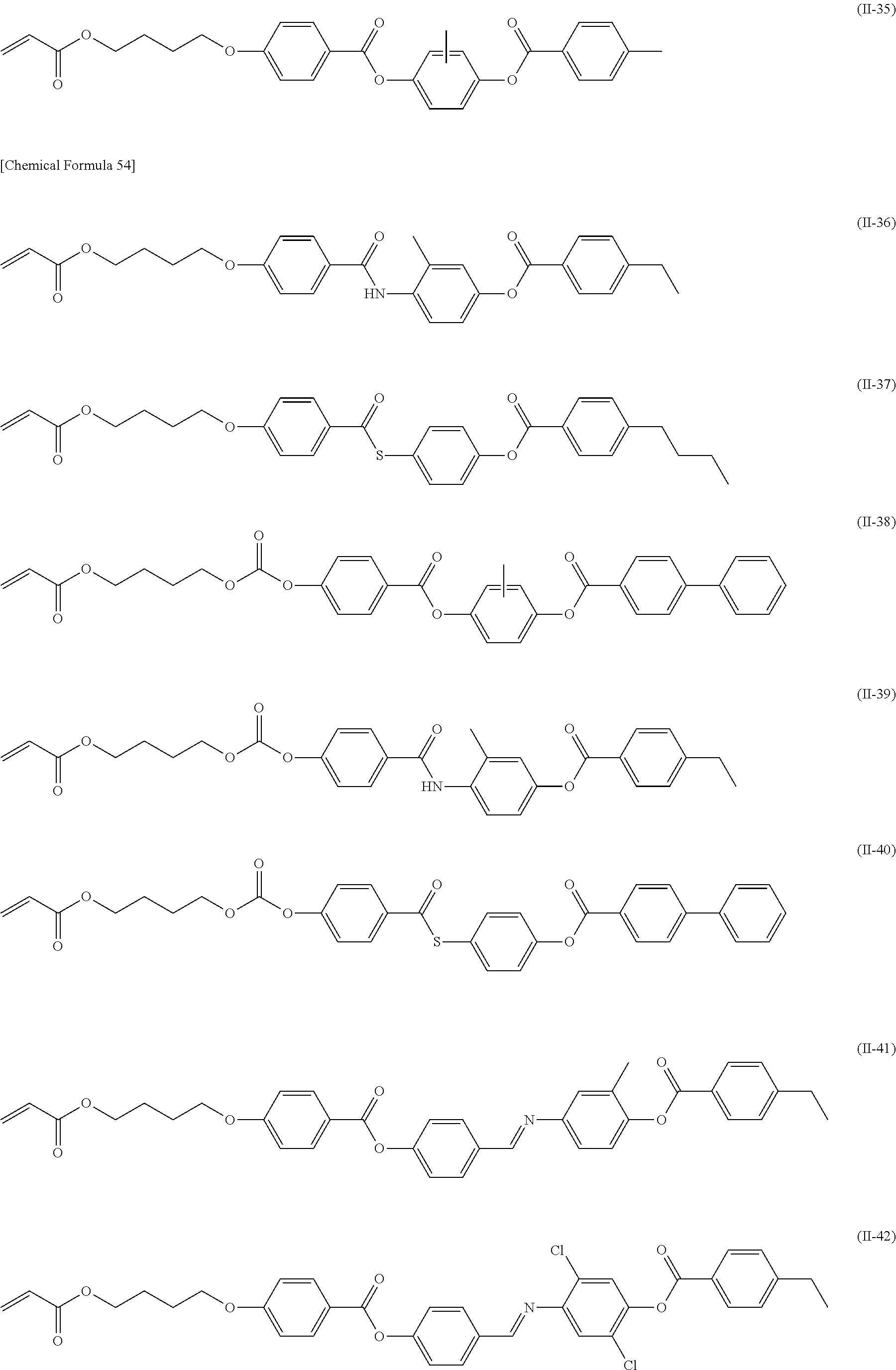

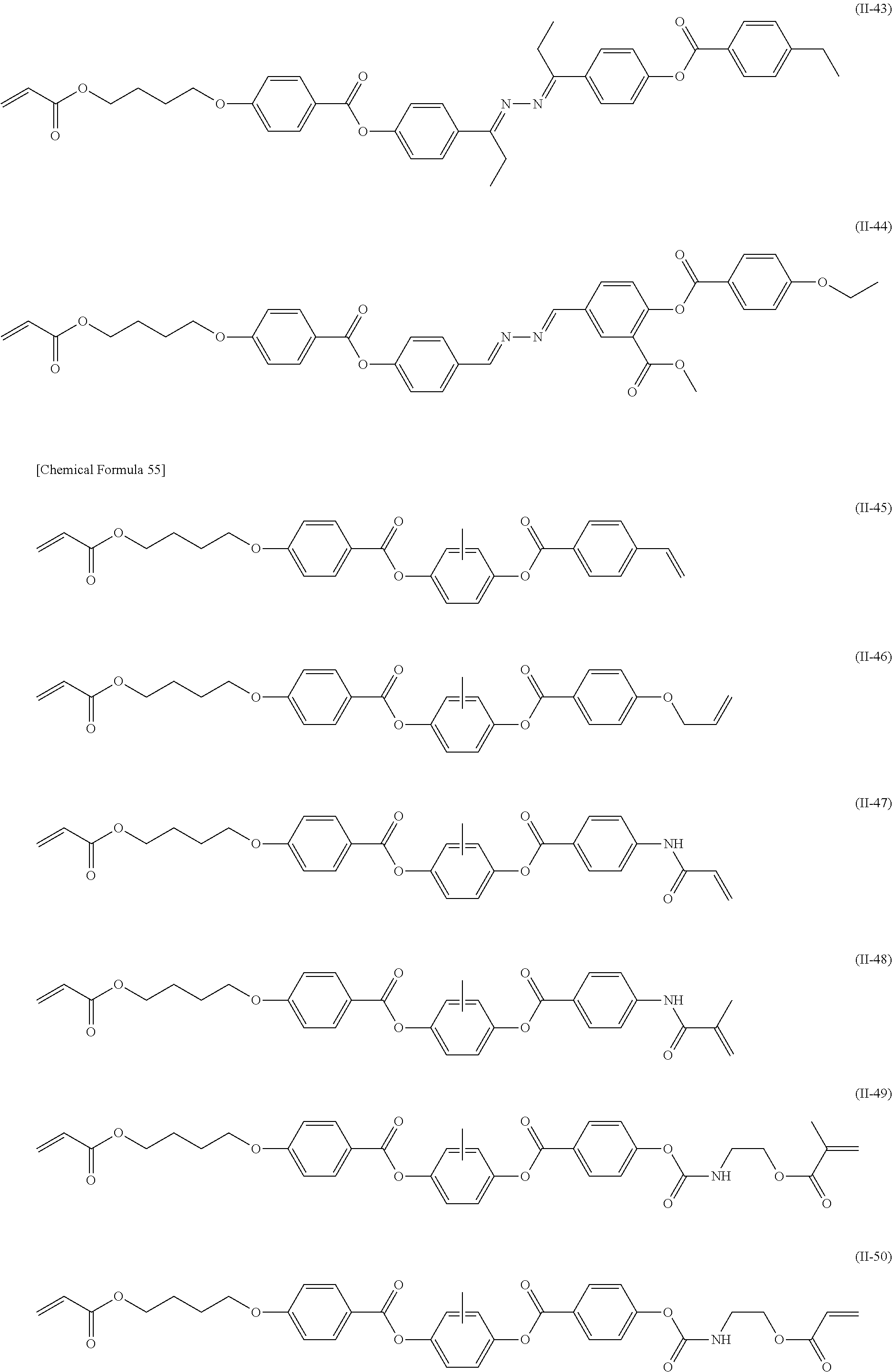

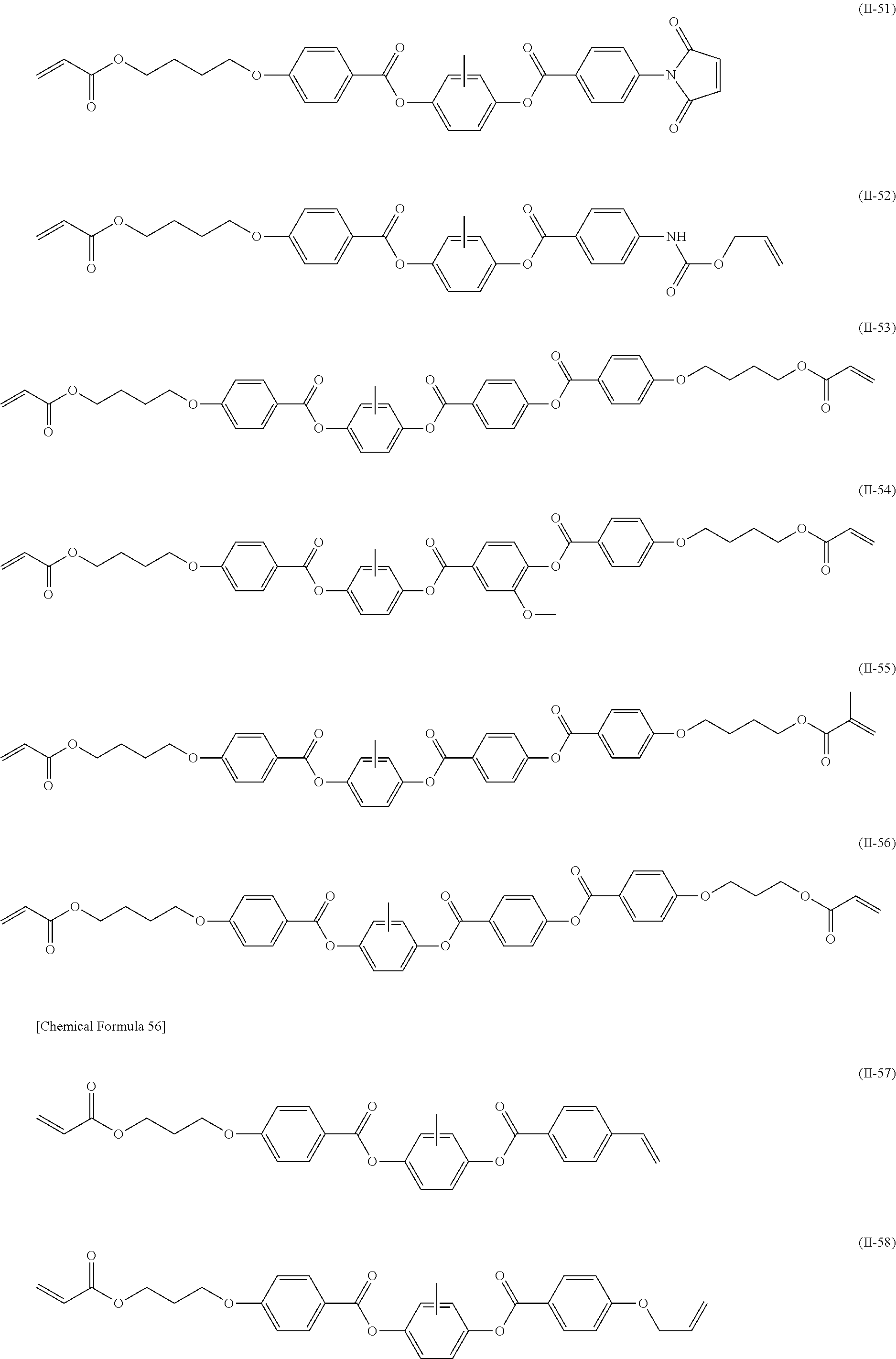

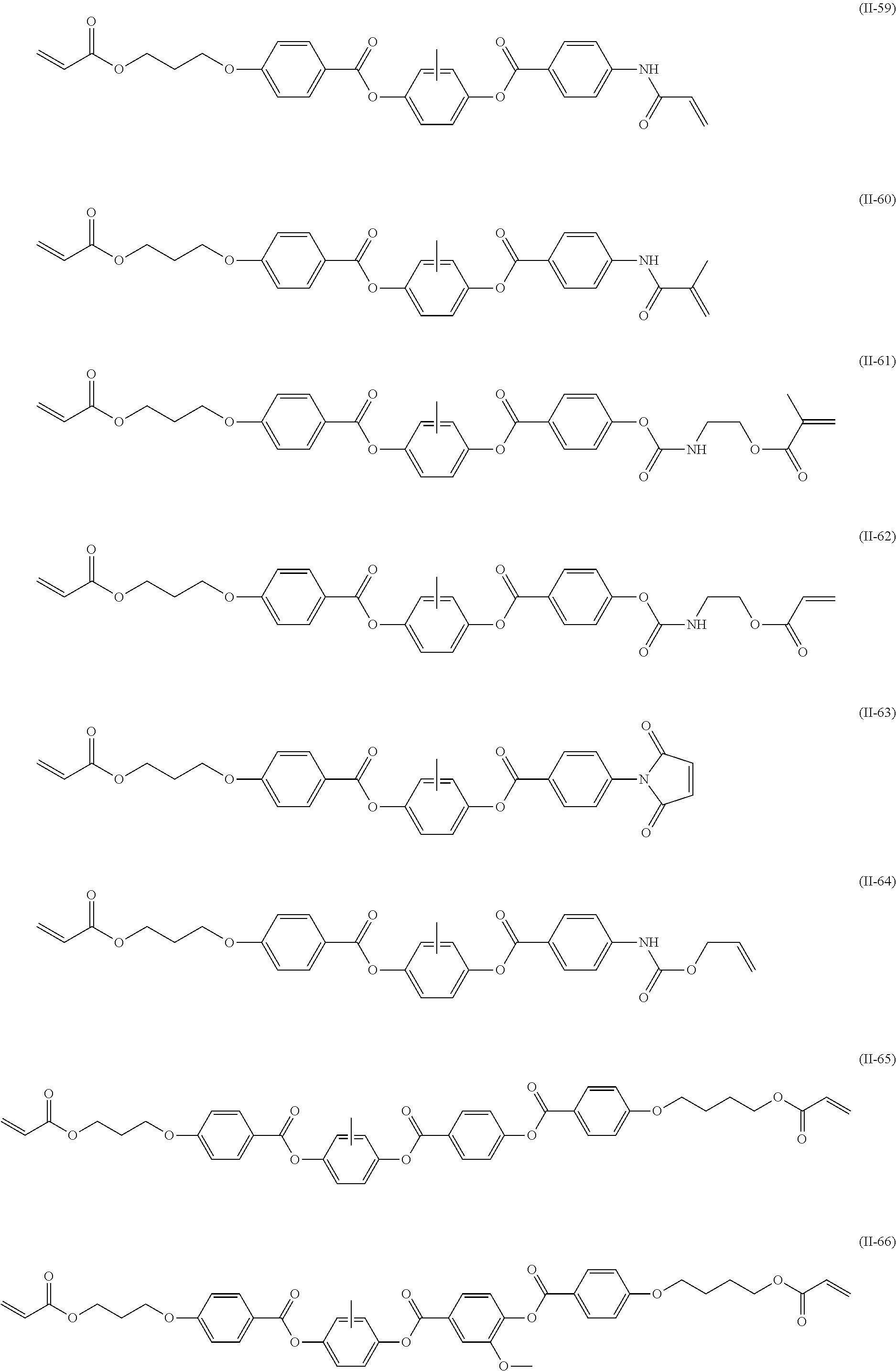

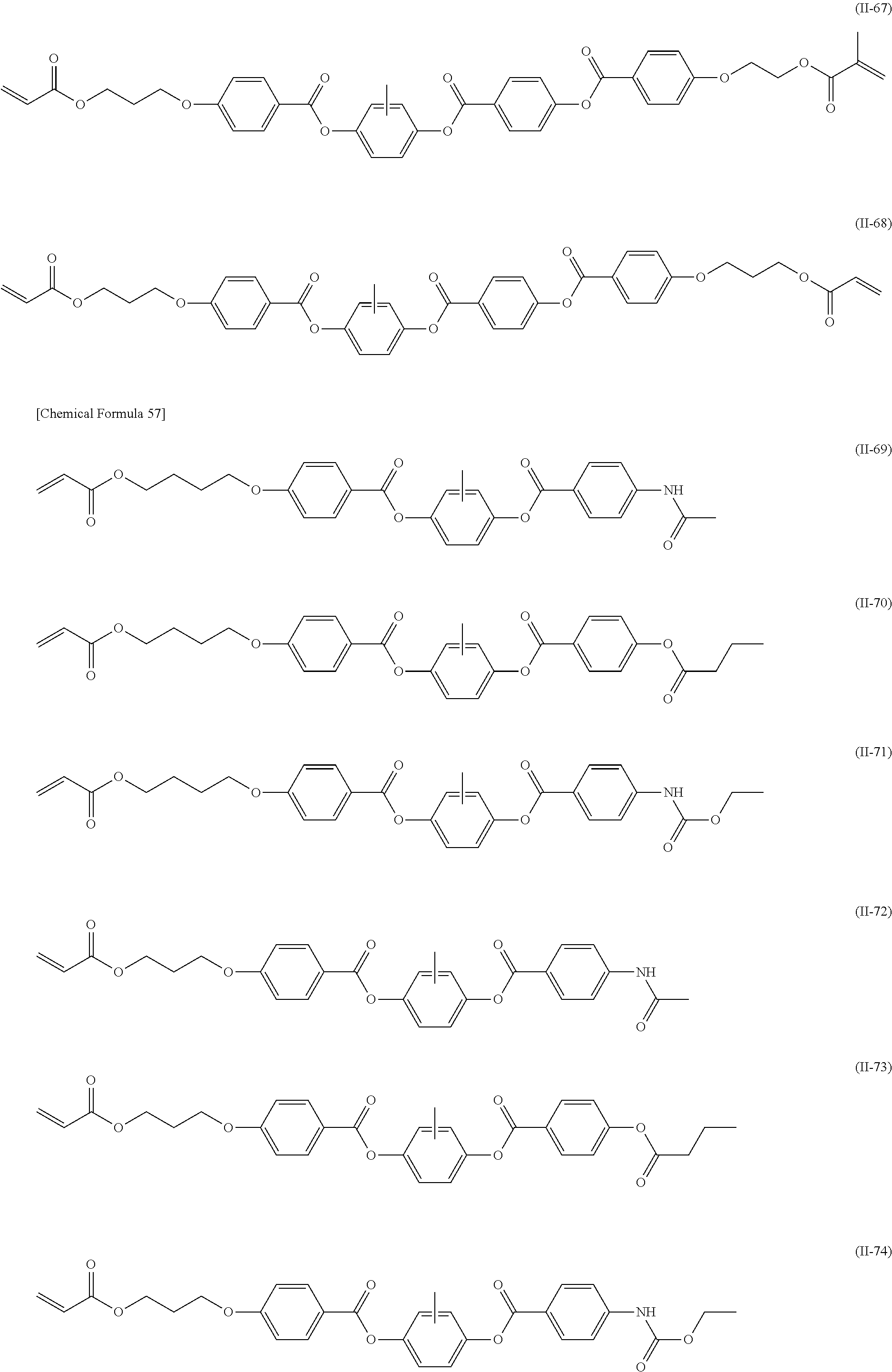

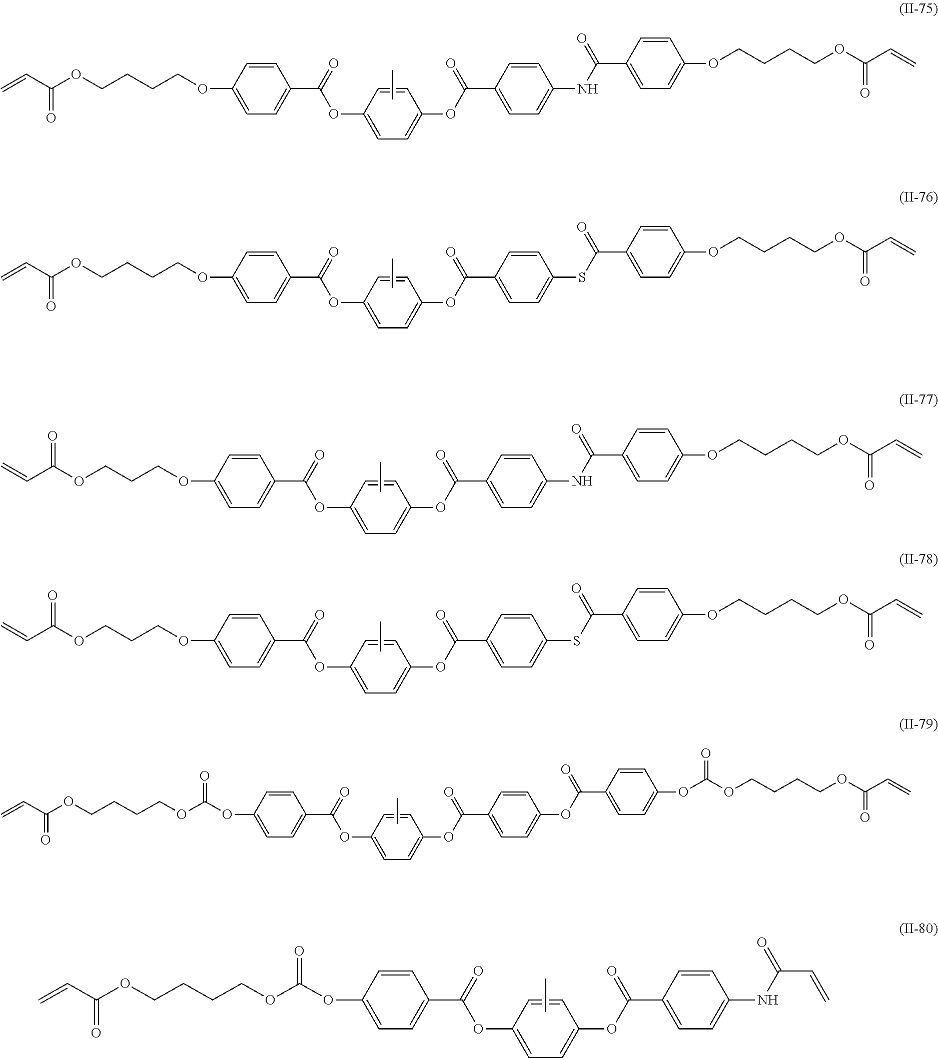

### <Chemical Composition of Liquid Crystal Composition>

In the method for manufacturing a liquid crystal composition of this invention, the production ratio by mole of the compound represented by Formula (I) and the compound represented by Formula (II) is preferably in the range from 50:50 to 98:2, more preferably in the range from 60:40 to 96:4, and particularly preferably in the range from 70:30 to 94:6.

In the method for manufacturing a liquid crystal composition of this invention, the production ratio by mole of the compound represented by Formula (I), the compound represented by Formula (II), and the compound represented by Formula (II-a) is preferably in the range from 50:40:10 to 94.99:5:0.01, and more preferably in the range from 60:30:10 to 94.9:8:0.1.

The compositional ratio by mass of the compound represented by Formula (I) and the compound represented by Formula (II), in the liquid crystal composition obtained by the method for manufacturing a liquid crystal composition of this invention, is preferably in the range from 50:50 to 95:5, more preferably in the range from 60:40 to 95:5, and particularly preferably in the range from 70:30 to 92:8.

As for the compositional ratios by mass among the compound represented by Formula (I), the compound represented by Formula (II) and the compound represented by Formula (II-a), in the liquid crystal composition obtained by the method for manufacturing a liquid crystal composition of this invention, in particular when intended for use in an optically-compensatory film, it is preferable that 3 to 50% by mass of the compound represented by Formula (II) and 0.01 to 10% by mass of the compound represented by Formula (II-a) are contained therein relative to the compound represented by Formula (I); and, it is more preferable that 5 to 40% by mass of the compound represented by Formula (I) and 0.1 to 5% by mass of the compound represented by Formula (II) are contained therein relative to the compound represented by Formula (II-a).

As for the compositional ratios by mass among the compound represented by Formula (I), the compound represented by Formula (II) and the compound represented by Formula (II-a), in the liquid crystal composition obtained by the method for manufacturing a liquid crystal composition of this invention, in particular when intended for use in a reflection film, it is preferable that 3 to 50% by mass of the compound represented by Formula (II) and 0.01 to 10% by mass of the compound represented by Formula (II-a) are contained therein relative to the compound represented by Formula (I); and, it is more preferable that 5 to 40% by mass of the compound represented by Formula (I) and 0.1 to 5% by mass of the compound represented by Formula (II) are contained therein relative to the compound represented by Formula (II-a).

### [Polymer Material, Film Configuration]

The polymer material and the film of the present invention each has the polymerizable liquid crystal compound or the optically anisotropic layer obtained by fixing alignment (for example, homogeneous alignment, homeotropic alignment, cholesteric alignment, hybrid alignment, etc.) of the liquid crystal compounds of the liquid crystal composition of the present invention, and has an optical anisotropy. The optically anisotropic layer may be have two or more optically anisotropic layers. The film is usable as an optical compensation film, ½ wavelength film, ¼ wavelength film or phase difference film of liquid crystal display devices based on TN mode, IPS mode and so forth, and as a reflection film making use of selective reflection ascribable to the cholesteric alignment. More preferably the film of the present invention is a film in which the optically anisotropic layer obtainable by fixing a cholesteric alignment of the liquid crystal compounds, and a film obtainable by fixing a cholesteric alignment of the polymerizable liquid crystal compounds of the present invention or the liquid crystal compounds of the liquid crystal composition of the present invention.

Therefore, the liquid crystal composition of the present invention, it is preferable to contain various additives, depending on the application. Following, describing the additive.

### (Other Additives)

The liquid crystal composition of the present invention when used, for example, as a reflection film making use of selective reflection ascribable to the cholesteric alignment, may contain not only the polymerizable liquid crystal, but also optionally contain solvent, compound having chiral carbon atom, polymerizable initiator (described later), and other additives (for example, cellulosic ester).

### Optically Active Compound (Chiral Agent):

The liquid crystal composition may show a cholesteric liquid crystal phase, and for this purpose, preferably contains an optically active compound. Note that if the rod-like liquid crystal compound has a chiral carbon atom, it may sometimes be possible to form the cholesteric liquid crystal phase in a stable manner, without adding the optically active compound. The optically active compound is selectable from publicly known various chiral agents (for example, those described in “Ekisho Debaisu Handobukku (Handbook of Liquid Crystal Devices)”, Chapter 3, Section 4-3, “TN, STN-yo Kairaru-zai (Chiral Agent for TN and STN)”, p. 199, edited by the 142th Committee of Japan Society for Promoting Science, 1989). While the optically active compound generally has a chiral carbon atom, also axial chirality compound or planar chirality compound having no chiral carbon atom is usable as the chiral agent. Examples of the axial chirality compound and the planar chirality compound include binaphthyl, helicene, paracyclophane, and derivatives of them. The optically active compound (chiral agent) may have a polymerizable group. If the optically active compound has a polymerizable group, and also the rod-like liquid crystal compound used in combination has a polymerizable group, it is now possible to form a polymer having a repeating unit derived from the rod-like liquid crystal compound and a repeating unit derived from the optically active compound, by polymerization reaction between the polymerizable optically active compound and the polymerizable rod-like liquid crystal compound. In this embodiment, the polymerizable group possessed by the polymerizable optically active compound is preferably the same species as the polymerizable group possessed by the polymerizable rod-like liquid crystal compound. Accordingly, also the polymerizable group of the optically active compound is preferably an unsaturated polymerizable group, epoxy group or aziridinyl group, more preferably an unsaturated polymerizable group, and particularly an ethylenic unsaturated polymerizable group.

The optically active compound may also be a liquid crystal compound.

The amount of consumption of the optically active compound in the liquid crystal composition is preferably 1 to 30 mol % of the liquid crystal compound used in combination. The lesser the amount of use of the optically active compound, the better since the liquid crystallinity is less likely to be adversely affected. Accordingly, the optically active compound used as the chiral agent preferably has a strong twisting power, so that a twisted alignment with a desired helical pitch may be obtained only with a small amount of consumption. Such chiral agent showing a strong twisting power is exemplified, for example, by those described in JP-A-2003-287623, which are preferably applicable to the present invention.

### Polymerization Initiator

The polymerization initiator includes a thermal polymerization initiator and a photo-polymerization initiator, and it is preferable to use a photo-polymerization initiator.

Examples of the photo-polymerization initiator include α-carbonyl compounds (described in the specifications of U.S. Pat. Nos. 2,367,661 and 2,367,670), acyloin ether (described in the specification of U.S. Pat. No. 2,448,828), α-hydrocarbon-substituted aromatic acyloin compound (described in the specification of U.S. Pat. No. 2,722,512), polynuclear quinone compounds (described in the specifications of U.S. Pat. Nos. 3,046,127 and 2,951,758), combination of triarylimidazole dimer and p-aminophenyl ketone (described in the specification of U.S. Pat. No. 3,549,367), acridine and phenazine compounds (described in the specification of JP-A-S60-105667 and U.S. Pat. No. 4,239,850), oxadiazole compound (described in the specification of U.S. Pat. No. 4,212,970), and acylphosphine oxide compounds (described in JP-B-S63-40799, JP-B-H05-29234, JP-A-H10-95788 and JP-A-H10-29997).

The amount of consumption of the photo-polymerization initiator is preferably 0.01 to 20% by mass of the solid content in the coating liquid, and more preferably 0.5 to 5% by mass.

### (Solvent)

Organic solvent is preferably used for dissolving the liquid crystal composition. Examples of the organic solvent include amides (for example, N,N-dimethylformamide), sulfoxides (for example, dimethyl sulfoxide), heterocyclic compounds (for example, pyridine), hydrocarbons (for example, benzene and hexane), alkyl halides (for example, chloroform and dichloromethane), esters (for example, methyl acetate and butyl acetate), ketones (for example, acetone, methyl ethyl ketone, cyclohexanone), and ethers (for example, tetrahydrofuran and 1,2-dimethoxyethane). Alkyl halides and ketones are preferable. Two or more organic solvents may be used in combination.

When the liquid crystal composition of the present invention is used for the optical compensation film of the liquid crystal display device, the liquid crystal composition may contain alignment controlling agent, surfactant, fluorine-containing polymer and so forth, besides the polymerization initiator and the above-described solvent.

### (Alignment Control Agent)

The alignment control agent in this invention means a compound typically added to a coating liquid of the liquid crystal composition of this invention, and after the coating, allowed to segregate to the surface of the liquid crystal composition, that is, the air interface side, to be able to control alignment of the liquid crystal composition on the air interface side (aligning agent for air interface side). Alternatively, it means a compound which segregates, after the coating, at the interface between a layer of the liquid crystal composition and the substrate, and allowed to control the alignment of the liquid crystal composition on the substrate side, which is exemplified by onium salt.

As the alignment control agent on the air interface side, low molecular alignment control agent or polymer alignment control agent may typically be used. The low molecular alignment control agent may be referred to descriptions, for example, in paragraphs [0009] to [0083] of JP-A-2002-20363, paragraphs [0111] to [0120] of JP-A-2006-106662, and paragraphs [0021] to [0029] of JP-A-2012-211306, the contents of which are incorporated into this specification. The polymer alignment control agent may be referred to descriptions, for example, in paragraphs [0021] to [0057] of JP-A-2004-198511, and paragraphs [0121] to [0167] of JP-A-2006-106662, the contents of which are incorporated into this specification.

The amount of consumption of the alignment control agent is preferably 0.01 to 10% by mass relative to the solid content in the coating liquid of the liquid crystal composition of this invention, and is more preferably 0.05 to 5% by mass.

By using such alignment control agent and alignment film, the liquid crystal compound of this invention may be kept in a homogeneous alignment in which the molecules are aligned in parallel with the surface of the layer.

When the onium salt or the like is used as the alignment controlling agent, it now becomes possible to promote the homeotropic alignment, at the interface, of the liquid crystal compounds. As for the onium salt which act as a vertical alignment agent, paragraphs [0052] to [0108] of JP-A-2006-106662 may be referred to, the content of which is incorporated into the present specification.

The amount of consumption of the onium salt is preferably 0.01 to 10% by mass of the solid content in the coating liquid containing the liquid crystal composition of the present invention, and more preferably 0.5 to 5% by mass.

### (Surfactant)

Surfactant is exemplified by publicly known compounds, and particularly by fluorine-containing compounds. As for the surfactant, for example, the compounds described in paragraphs [0028] to [0056] of JP-A-2001-330725, and the compounds described in paragraphs [0199] to [0207] of JP-A-2006-106662 may be referred to, the contents of which are incorporated into the present specification.

The amount of consumption of the surfactant is preferably 0.01 to 10% by mass of the solid content in the coating liquid containing the liquid crystal composition of the present invention, and more preferably 0.5 to 5% by mass.

### (Other Additives Applicable to Optical Compensation Film)

As for other additives applicable to the optical compensation film, for example, the compounds described in paragraphs [0099] to [0101] of JP-A-2005-97377 may be referred to, the content of which is incorporated into the present specification.

The film of the present invention may be formed, for example, by coating the liquid crystal composition of the present invention. A preferable method for forming the film of the present invention is such as coating a composition, which contains at least the liquid crystal composition of the present invention, onto the surface of the support, or onto the surface of the alignment film formed thereon, aligning the liquid crystal composition into a desired state, curing it by polymerization, and fixing the state of alignment of the liquid crystal composition.

The liquid crystal composition may be coated by any of publicly known methods (for example, extrusion coating, direct gravure coating, reverse gravure coating, die coating, bar coating, and spin coating). The liquid crystalline molecules are preferably fixed while keeping the state of alignment. The fixation is preferably carried out by a polymerization reaction involving the polymerizable group introduced into the liquid crystalline molecules.

The polymerization reaction includes heat polymerization reaction using a heat polymerization initiator, and photo-polymerization reaction using a photo-polymerization initiator. The photo-polymerization reaction is preferable.

Examples of the photo-polymerization initiator include α-carbonyl compound (described in U.S. Pat. No. 2,367,661, and ibid. 2,367,670), acyloin ether (described in U.S. Pat. No. 2,448,828), α-hydrocarbon-substituted aromatic acyloin compound (described in U.S. Pat. No. 2,722,512), polynuclear quinone compound (described in U.S. Pat. No. 3,046,127, and ibid. U.S. Pat. No. 2,951,758), combination of triarylimidazole dimer and p-aminophenyl ketone (described in U.S. Pat. No. 3,549,367), acridine and phenazine compounds (described in JP-A-S60-105667, and U.S. Pat. No. 4,239,850), oxadiazole compound (described in U.S. Pat. No. 4,212,970), and acylphosphine oxide compound (described in JP-B2-S63-40799, JP-B2-H05-29234, JP-A-H10-95788, and JP-A-H10-29997).

The amount of consumption of the photo-polymerization initiator is preferably 0.01 to 20% by mass relative to the solid content of the coating liquid, and more preferably 0.5 to 5% by mass. For photo-irradiation for polymerizing discotic liquid crystalline molecules, ultraviolet radiation is preferably used. The irradiation dose is preferably 20 mJ/cm² to 50 J/cm², and more preferably 100 to 800 mJ/cm². The photo-irradiation may be conducted under a heating condition, so as to accelerate the photo-polymerization reaction.

The thickness of the optically anisotropic layer composed of the liquid crystal composition is preferably 0.1 to 50 μm, and more preferably 0.5 to 30 μm.

For a particular case where selective reflectivity of the film, having the cholesteric alignment of the liquid crystal compounds fixed therein, is utilized, the thickness is more preferably 1 to 30 μm, and most preferably 2 to 20 μm. The total amount of coating of the compound represented by the formula (1) and the compound represented by the formula (3) in the liquid crystal layer (amount of coating of liquid crystal alignment accelerator) is preferably 0.1 to 500 mg/m², more preferably 0.5 to 450 mg/m², furthermore preferably 0.75 to 400 mg/m², and most preferably 1.0 to 350 mg/m².

On the other hand, when the optically anisotropic layer is used as the optical compensation film (for example, A-plate having a state of homogeneous alignment fixed therein, and C-plate having a state of homeotropic alignment fixed therein), the thickness thereof is preferably 0.1 to 50 μm, and more preferably 0.5 to 30 μm.

The alignment film may be provided by a technique such as rubbing of organic compound (preferably polymer), oblique vapor deposition of inorganic compound, formation of a layer having micro-grooves, or accumulation of organic compound by the Langmuir-Blodgett process (LB film) (for example, w-tricosanoic acid, dioctadecylmethylammonium chloride, methyl stearate). Also known is an alignment film which turns to demonstrate the alignment function after exposed to electric field, magnetic field, or photo-irradiation. The alignment film formed by rubbing polymer is particularly preferable. The rubbing process is carried out by unidirectionally rubbing the surface of a polymer layer several times with paper or cloth. Species of the polymer used for the alignment film is determined depending on alignment of the liquid crystalline molecules (in particular, average tilt angle). A polymer, general polymer for forming alignment film, which is unlikely to reduce the surface energy of the alignment film is used for the purpose of horizontally aligning the liquid crystalline molecules (with an average tilt angle of 0 to 50°). A polymer capable of reducing the surface energy of the alignment film is used for the purpose of vertically aligning the liquid crystalline molecules (with an average tilt angle of 50 to 90°). In order to reduce the surface energy of the alignment film, it is preferable to introduce a C₁₀₋₁₀₀ hydrocarbon group to a side chain of the polymer.

Species of the polymer are specifically described in literatures regarding the optical compensation sheet using the liquid crystalline molecules adapted to various types of display mode.

The thickness of the alignment film is preferably 0.01 to 5 μm, and more preferably 0.05 to 1 μm. It is also possible to align, by using the alignment film, the liquid crystalline molecules for the optically anisotropic layer, and then transfer the liquid crystal layer onto a transparent support. The liquid crystalline molecules fixed in the aligned state can keep such aligned state without the alignment film. If the average tilt angle is smaller than 5°, rubbing is no longer necessary, and also the alignment film is no longer necessary. However, for the purpose of improving adhesiveness between the liquid crystalline molecules and the transparent support, it is also recommendable to use an alignment film (described in JP-A-H09-152509) which can form a chemical bond with the liquid crystalline molecule at the interface. When the alignment film is used for the purpose of improving the adhesiveness, rubbing is omissible. When two types of liquid crystal layers are provided on the same side of the transparent support, the liquid crystal layer formed on the transparent support may be allowed to function as an alignment film for the liquid crystal layer formed thereon.

The film of the present invention or an optically anisotropic element having the film of the present invention may have the transparent support. Glass plate or polymer film may be used as the transparent support, wherein the polymer film is preferably used. When stating that “the support is transparent”, it means that the light transmittance is 80% or above. The transparent support generally used is an optically isotropic polymer film. The optical isotropy is preferably represented by an in-plane retardation (Re) of smaller than 10 nm, and more preferably smaller than 5 nm. As for the optically isotropic transparent support, also the thickness direction retardation (Rth) is preferably smaller than 10 nm, and more preferably smaller than 5 nm.

### (Selective Reflection Characteristic)

The film of the present invention, having fixed therein the cholesteric liquid crystal phase of the liquid crystal composition of the present invention, preferably shows a selective reflection characteristic, and more preferably shows a selective reflection characteristic in the infrared wavelength region. The light reflective layer having the cholesteric liquid crystal phase fixed therein is detailed in relation to methods described in JP-A-2011-107178 and JP-A-2011-018037, which are also preferably used in the present invention.

### (Laminate)

The film of the present invention is also preferably configured as a laminate of a plurality of layers each having fixed therein the cholesteric liquid crystal phase of the liquid crystal composition of the present invention. The liquid crystal composition of the present invention is also suitable for lamination, and can therefore form such laminate easily.

### (Optical Compensation Film)

The film of the present invention is also usable as an optical compensation film.

When the film of the present invention is used as the optical compensation film, optical properties of the optically anisotropic layer in the optical compensation film are determined based on optical properties of a liquid crystal cell, and more specifically based on variation in the display mode. By using the liquid crystal composition of the present invention, it is now possible to manufacture the optically anisotropic layer having various optical properties adaptable to various display modes of the liquid crystal cell.

For example, as for the optically anisotropic layer for TN-mode liquid crystal cell, descriptions in JP-A-H06-214116, U.S. Pat. No. 5,583,679, U.S. Pat. No. 5,646,703 and German Patent No. 3911620A1 may be referred to, the contents of which are incorporated into the present specification. As for the optically anisotropic layer for IPS-mode or FLC-mode liquid crystal cell, descriptions in JP-A-H09-292522 and JP-A-H10-54982 may be referred to, the contents of which are incorporated into the present specification. As for the optically anisotropic layer for OCB-mode or HAN-mode liquid crystal cell, the descriptions in U.S. Pat. No. 5,805,253 and International Patent Application WO96/37804 may be referred to, the contents of which are incorporated into the present specification. As for the optically anisotropic layer for STN-mode liquid crystal cell, the description in JP-A-H09-26572 may be referred to, the content of which is incorporated into the present specification. As for the optically anisotropic layer for VA-mode liquid crystal cell, the description in Japanese Patent JP-B02-2866372 may be referred to, the content of which is incorporated into the present specification.

In particular, in the present invention, the film of this invention is preferably used as the optically anisotropic layer of the IPS-mode liquid crystal cell.

For example, a film having an optically anisotropic layer, in which the liquid crystal compounds of the present invention is in the state of homogeneous alignment, is usable as an A-plate. The A-plate now means a uniaxial birefringent layer characterized by the refractive index in the slow axis direction larger than the refractive index in the thickness direction. When the film of the present invention is the A-plate, only a single optically anisotropic layer will suffice for compensation, if the layer shows an in-plane retardation (Re) of 200 nm to 350 nm at 550 nm.

A film having an optically anisotropic layer, in which the liquid crystal compounds of the present invention is in the state of homeotropic alignment, is usable as a positive C-plate, possibly in combination with a biaxial film or the like. The positive C-plate now means a uniaxial birefringent layer characterized by the refractive index in the thickness direction larger than the in-plane refractive index. The film of the present invention, used as the positive C-plate, preferably has an in-plane retardation (Re) at 550 nm of −10 nm to 10 nm, and a thickness direction retardation (Rth) at 550 nm of −250 to −50 nm, although depending on optical characteristics of the biaxial film to be combined.

### [Polarizing Plate]

The present invention also relates to a polarizing plate having at least the film with the optically anisotropic layer (optical compensation film), and a polarizing film. In the polarizing plate having a polarizing film and a protective film disposed at least on one side thereof, the optically anisotropic layer is usable as such protective film.

Alternatively, in the polarizing plate configured to have the protective films on both sides of the polarizing film, the optically anisotropic layer is also usable as one of these protective films.

The polarizing film includes iodine-containing polarizing film, dye-containing polarizing film using dichroic dye, and polyene-based polarizing film. The iodine-containing polarizing film and the dye-containing polarizing film may be manufactured generally by using polyvinyl alcohol-based film.

Although the thickness of the polarizing film is not specifically limited, the thinner the polarizing film, the more thinner will be the polarizing plate and liquid crystal display device into which it is incorporated. From this point of view, the thickness of the polarizing film is preferably 10 μm or smaller. Since the optical path length in the polarizing film is necessarily longer than the wavelength of light, so that the minimum thickness of the polarizing film is preferably 0.7 μm or larger, substantially 1 μm or larger, and generally 3 μm or larger.

### [Liquid Crystal Display Device]

The present invention also relates to a liquid crystal display device having such polarizing plate. The liquid crystal display device may have any alignment mode, without special limitation, such as TN mode, IPS mode, FLC mode, OCB mode, HAN mode, or VA mode. As for the liquid crystal display device making use of VA mode, the description in paragraphs [0109] to [0129] of JP-A-2005-128503 may be referred to, the content of which is incorporated into the present specification. As for the liquid crystal display device making use of IPS mode, the description in paragraphs [0027] to [0050] of JP-A-2006-106662 may be referred to, the content of which is incorporated into the present specification.

For the liquid crystal display device of the present invention, for example, the A-plate and C-plate described above are usable.

The optically anisotropic layer may be incorporated into the liquid crystal display device, in the form of polarizing plate obtained by bonding with the polarizing film. Alternatively, the optically anisotropic layer may be incorporated as a viewing angle compensation film which is configured by the optically anisotropic layer by itself, or by a laminate combined with other phase difference layer. The other phase difference layer to be combined is selectable, depending on the alignment mode of the liquid crystal cell in need of compensation of viewing angle.

The optically anisotropic layer may be disposed between the liquid crystal cell and the polarizing film on the viewer's side, or between the liquid crystal cell and the polarizing film on the back light side.

In this description, Re(Λ) and Rth(Λ) are retardation (nm) in plane and retardation (nm) along the thickness direction, respectively, at a wavelength of Λ. Re(Λ) is measured by applying light having a wavelength of Λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(Λ) of the film is calculated as follows.

Rth(Λ) is calculated by KOBRA 21ADH or WR on the basis of the six Re(Λ) values which are measured for incoming light of a wavelength Λ nm in six directions which are decided by a 100 step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(Λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (1) and (2)

$$\begin{matrix} [ Mathematical formula 1 ] & \\ Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( θ )}{nx} ) \}} & Formula ( 1 ) \\ Rth = \{ ( nx + ny ) / 2 - nz \} \times d & Formula ( 2 )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(Λ) of the film may be calculated as follows:

Re(Λ) of the film is measured around the slow axis (defined by KOBRA 21ADH or WR) as the in-plane inclination axis (rotation axis), relative to the normal direction of the film from −50° up to +50° at intervals of 10°, in 11 points in all with a light having a wavelength of A nm applied in the inclined direction; and based on the thus-measured retardation values, the estimated value of the mean refractive index and the inputted film thickness value, Rth(Λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe's refractometer. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In this specification, the wavelength at which the refraction index is measured is 550 nm unless otherwise specified.

### EXAMPLE

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### Synthesis of Polymerizable Liquid Crystal Compound Represented by Formula (1)

### Synthesis Example 1

In accordance with the following scheme, compound (1) was synthesized. Compound (1-1) was synthesized according to [0085] to [0087], page 18 of JP Patent Registration No. 4397550.

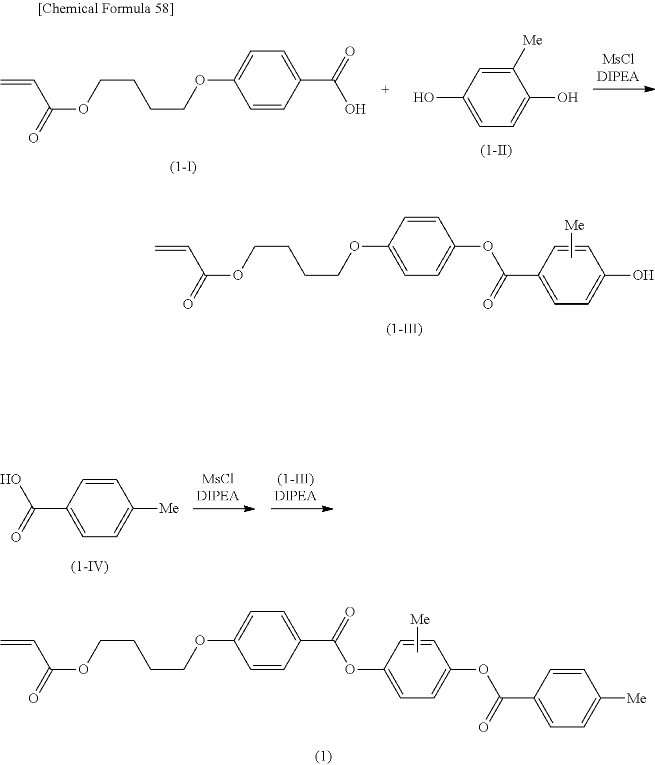

BHT (37 mg) was added to a tetrahydrofuran (THF) solution (20 mL) containing methanesulfonyl chloride (10.22 g), and the inner temperature was cooled down to −5° C. To the mixture, a THF solution (50 mL) containing 1-I (31.5 mmol, 8.33 g) and diisopropylethylamine (17.6 mL) were added dropwise, so as not to elevate the inner temperature to 0° C. or above. The mixture was stirred at −5° C. for 30 minutes, and thereto diisopropylethylamine (16.7 mL) and a THF solution (20 mL) containing and 1-II, and 4-dimethylaminopyridine (DMAP) (one spatula) were added. The mixture was then stirred at room temperature for 4 hours. To the mixture added was methanol (5 mL) to terminate the reaction, and further added were water and ethyl acetate. An organic layer as a result of extraction with ethyl acetate was evaporated using a rotary evaporator to remove the solvent, and the residue was purified by silica gel column chromatography, to obtain 1-III.

BHT (3 mg) was added to a THF solution (10 mL) containing methanesulfonyl chloride (355 mg), and the inner temperature was cooled down to −5° C. To the mixture, carboxylic acid 1-IV (404 mg) and diisopropylethylamine (472 μL) were added dropwise, so as not to elevate the inner temperature to 0° C. or above. The mixture was stirred at −5° C. for 30 minutes, and thereto diisopropylethylamine (472 μL) and a THF solution (2 mL) containing phenol 1-III (1.0 g), and DMAP (one spatula) were added. The mixture was then stirred at room temperature for two hours. Methanol (5 mL) was then added to the mixture to terminate the reaction, followed by further addition of water and ethyl acetate. An organic layer as a result of extraction with ethyl acetate was evaporated using a rotary evaporator to remove the solvent, to obtain a crude product of compound (1). Purification by silica gel column chromatography gave compound (1) in a yield of 58%.

¹H-NMR (solvent: CDCl₃) δ (ppm): 1.9-2.0 (m, 4H), 2.2 (s, 3H), 2.5 (s, 3H), 4.1-4.3 (m, 4H), 5.8 (d, 1H), 6.1 (dd, 1H), 6.4 (d, 1H), 6.9-7.0 (m, 2H), 7.1-7.2 (m, 3H), 7.3-7.4 (m, 2H), 8.1-8.2 (m, 4H)

Phase transition temperatures of the compound (1) were determined by texture observation under a polarizing microscope. Transition from crystal phase to nematic liquid crystal phase was observed at 83° C., and transition into isotropic phase was observed above 135° C.

### Synthesis Example 2

Compound (2) was obtained according to the synthetic method same as in Synthesis example 1, except that p-ethylbenzoic acid was used instead of carboxylic acid 1-IV. Also compound (2) showed the nematic liquid crystallinity same as compound (1).

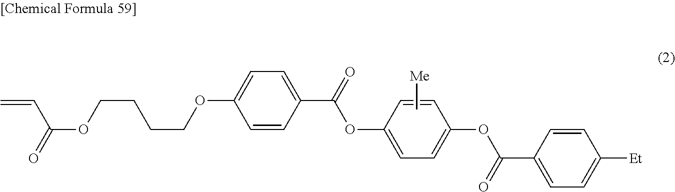

¹H-NMR (solvent: CDCl₃) δ (ppm): 1.3 (t, 3H), 1.9-2.0 (m, 4H), 2.3 (s, 3H), 2.7-2.8 (m, 2H), 4.1-4.3 (m, 4H), 5.8 (d, 1H), 6.1 (dd, 1H), 6.4 (d, 1H), 6.9-7.0 (m, 2H), 7.1-7.2 (m, 3H), 7.3-7.4 (m, 2H), 8.1-8.2 (m, 4H)

### Synthesis Example 3

Compound (3) was obtained according to the synthetic method same as in Synthesis example 1, except that p-n-propylbenzoic acid was used instead of carboxylic acid 1-IV. Also compound (3) showed the nematic liquid crystallinity same as compound (1).

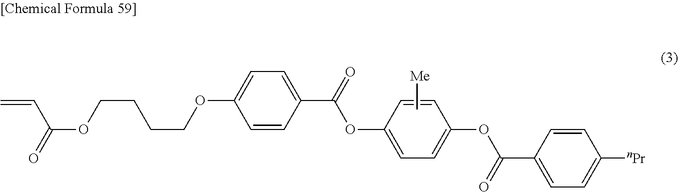

¹H-NMR (solvent: CDCl₃) δ (ppm): 1.0 (t, 3H), 1.6-1.8 (m, 2H), 1.9-2.0 (m, 4H), 2.3 (s, 3H), 2.7-2.8 (m, 2H), 4.1-4.3 (m, 4H), 5.8 (d, 1H), 6.1 (dd, 1H), 6.4 (d, 1H), 6.9-7.0 (m, 2H), 7.1-7.2 (m, 3H), 7.3-7.4 (m, 2H), 8.1-8.2 (m, 4H)

### Synthesis Example 4

Compound (4) was obtained according to the synthetic method same as in Synthesis example 1, except that p-n-butylbenzoic acid was used instead of carboxylic acid 1-IV. Also compound (4) showed the nematic liquid crystallinity same as compound (1).

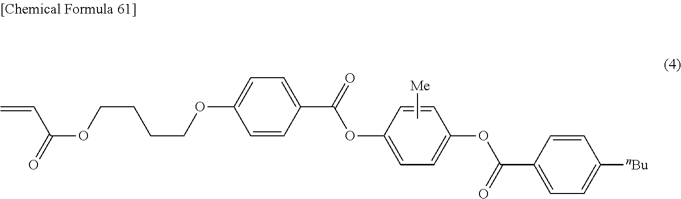

¹H-NMR (solvent: CDCl₃) δ (ppm): 0.9 (t, 3H), 1.3-1.5 (m, 2H), 1.6-1.7 (m, 2H), 1.9-2.0 (m, 4H), 2.3 (s, 3H), 2.7-2.8 (m, 2H), 4.1-4.3 (m, 4H), 5.8 (d, 1H), 6.1 (dd, 1H), 6.4 (d, 1H), 6.9-7.0 (m, 2H), 7.1-7.2 (m, 3H), 7.3-7.4 (m, 2H), 8.1-8.2 (m, 4H)

### Synthesis Example 5

Compound (5) was obtained according to the synthetic method same as in Synthesis example 1, except that p-methoxybenzoic acid was used instead of carboxylic acid 1-IV. Also compound (5) showed the nematic liquid crystallinity same as compound (1).

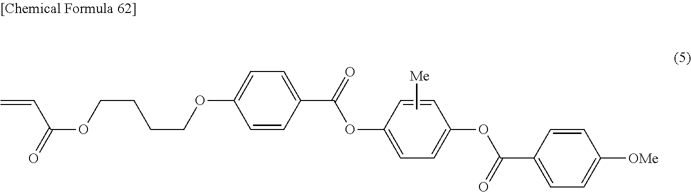

¹H-NMR (solvent: CDCl₃) δ (ppm): 1.9-2.0 (m, 4H), 2.2 (s, 3H), 3.9 (s, 3H), 4.1-4.3 (m, 4H), 5.8 (d, 1H), 6.1 (dd, 1H), 6.4 (d, 1H), 6.9-7.0 (m, 4H), 7.1-7.2 (m, 3H), 8.1-8.2 (m, 4H)

### [Chemical Formula 62]

Compound (6) was obtained according to the synthetic method same as in Synthesis example 1, except that p-ethoxybenzoic acid was used instead of carboxylic acid 1-IV. Also compound (6) showed the nematic liquid crystallinity same as compound (1).

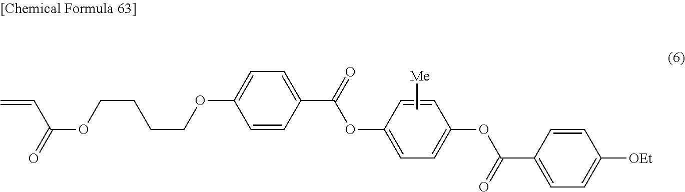

¹H-NMR (solvent: CDCl₃) δ (ppm): 1.5 (t, 3H), 1.9-2.0 (m, 4H), 2.3 (s, 3H), 4.0-4.3 (m, 6H), 5.8 (d, 1H), 6.1 (dd, 1H), 6.4 (d, 1H), 6.9-7.0 (m, 4H), 7.1-7.2 (m, 3H), 8.1-8.2 (m, 4H)

### Synthesis Example 7

Compound (7) was obtained according to the synthetic method same as in Synthesis example 1, except that p-phenylbenzoic acid was used instead of carboxylic acid 1-IV. Also compound (7) showed the nematic liquid crystallinity same as compound (1).

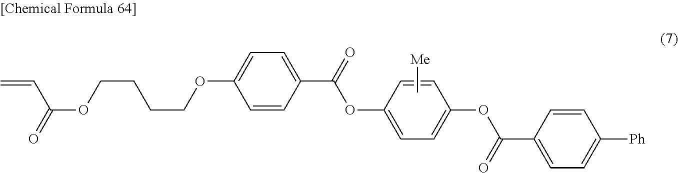

¹H-NMR (solvent: CDCl₃) δ (ppm): 1.9-2.0 (m, 4H), 2.3 (s, 3H), 4.1-4.3 (m, 4H), 5.8 (d, 1H), 6.1 (dd, 1H), 6.4 (d, 1H), 6.9-7.0 (m, 2H), 7.1-7.3 (m, 3H), 7.4-7.5 (m, 3H), 7.6-7.8 (m, 4H), 8.1-8.3 (m, 4H)

### Synthesis Example 8

Compound (8) was obtained according to the synthetic method same as in Synthesis example 1, except that p-methoxycinnamic acid was used instead of carboxylic acid 1-IV. Also compound (8) showed the nematic liquid crystallinity same as compound (1).

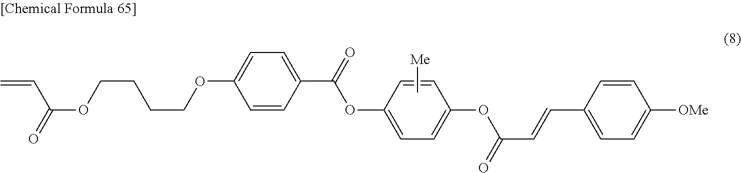

¹H-NMR (solvent: CDCl₃) δ (ppm): 1.9-2.0 (m, 4H), 2.2 (s, 3H), 3.9 (s, 3H), 4.1-4.3 (m, 4H), 5.8 (d, 1H), 6.1 (dd, 1H), 6.4-6.6 (m, 2H), 6.9-7.0 (m, 4H), 7.1-7.2 (m, 3H), 7.5-7.6 (m, 2H), 7.8-7.9 (m, 1H), 8.1-8.2 (m, 2H)

### Synthesis Example 9

Compound (9) was obtained according to the synthetic method same as in Synthesis example 1, except that cinnamic acid was used instead of carboxylic acid 1-IV. Also compound (9) showed the nematic liquid crystallinity same as compound (1).

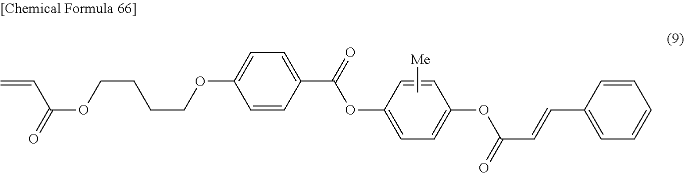

¹H-NMR (solvent: CDCl₃) δ (ppm): 1.9-2.0 (m, 4H), 2.2 (s, 3H), 4.1-4.3 (m, 4H), 5.8 (d, 1H), 6.1 (dd, 1H), 6.4 (d, 1H), 6.6-6.7 (d, 1H), 6.9-7.0 (m, 4H), 7.1-7.2 (m, 3H), 7.4-7.5 (m, 3H), 7.6-7.7 (m, 2H), 7.9 (d, 1H), 8.1-8.2 (m, 2H)

### Synthesis Example 10

Compound (2A) was obtained according to the same synthetic method as in Synthesis example 1, except that Compound (1-I) was replaced with Compound (1-II) instead of carboxylic acid 1-IV. Compound (1-II) was synthesized referring to paragraphs [0085] to [0087] on page 18 of JP-B2-4397550, except that 3-acryloyloxypropanol was used. Also Compound (2A) was found to show nematic liquid crystallinity, similarly to Compound (1).

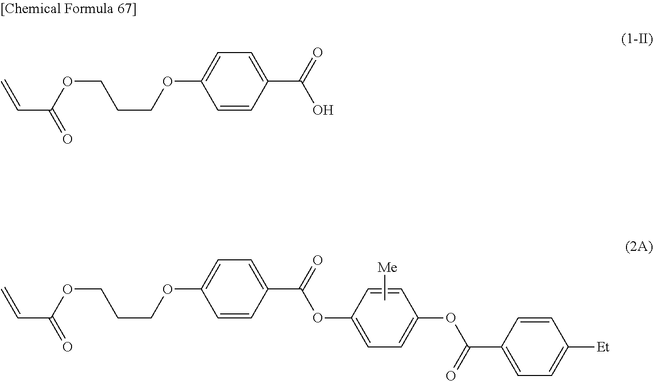

¹H-NMR (solvent: CDCl₃) δ(ppm): 1.3 (t, 3H), 2.1-2.3 (m, 2H), 2.3 (s, 3H), 2.7-2.8 (m, 2H), 4.1-4.5 (m, 4H), 5.8 (d, 1H), 6.1 (dd, 1H), 6.4 (d, 1H) 6.9-7.0 (m, 2H), 7.1-7.2 (m, 3H), 7.3-7.4 (m, 2H), 8.1-8.2 (m, 4H)

### Synthesis Example 11

Compound (7F) was obtained according to the same synthetic method as in Synthesis example 1, except that Compound (1-I) was replaced with Compound (1-III) instead of carboxylic acid 1-IV. Compound (1-III) was synthesized referring to a method described in paragraph [0185] on page 44 of JP-B2-4606195. Also Compound (7F) was found to show nematic liquid crystallinity, similarly to Compound (1).

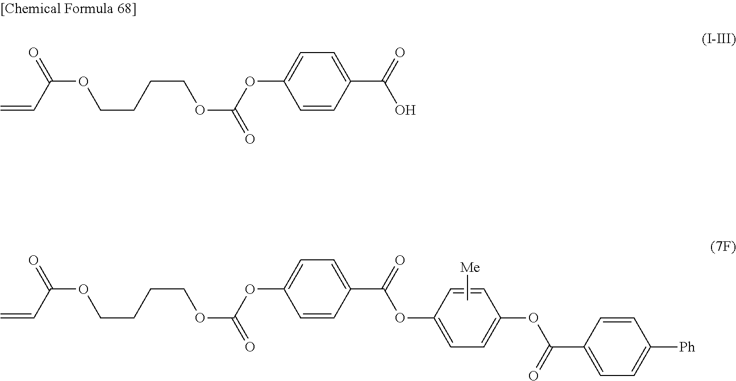

¹H-NMR (solvent: CDCl₃) δ (ppm): 1.8-2.0 (m, 4H), 2.3 (s, 3H), 4.2-4.5 (m, 4H), 5.8 (d, 1H), 6.1 (dd, 1H), 6.4 (d, 1H), 7.1-7.3 (m, 3H), 7.3-7.4 (m, 2H), 7.4-7.5 (m, 3H), 7.6-7.8 (m, 4H), 8.1-8.3 (m, 4H)

Compound (1L) was obtained according to the same synthetic method as in Synthesis example 1, except that 4-(acryloylamino)benzoic acid was used instead of carboxylic acid 1-IV. Also Compound (1L) was found to show nematic liquid crystallinity, similarly to Compound (1).

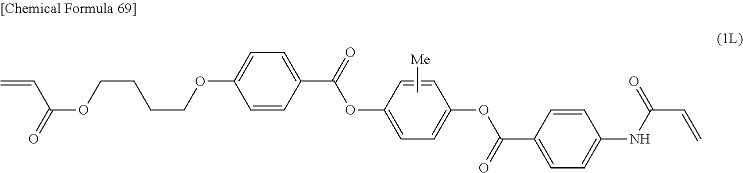

¹H-NMR (solvent: CDCl₃) δ(ppm): 1.9-2.0 (m, 4H), 2.25 (s, 3H), 4.1-4.3 (m, 4H), 5.8-5.9 (m, 2H), 6.1-6.2 (m, 1H), 6.3-6.5 (m, 3H), 6.9-7.0 (m, 2H), 7.1-7.2 (m, 3H), 7.6-7.7 (m, 2H), 7.8 (s, 1H), 8.1-8.2 (m, 4H)

Compound (2L) was obtained according to the same synthetic method as in Synthesis example 1, except that 4-(methacryloylamino)benzoic acid was used instead of carboxylic acid 1-IV. Also Compound (2L) was found to show nematic liquid crystallinity, similarly to Compound (1).

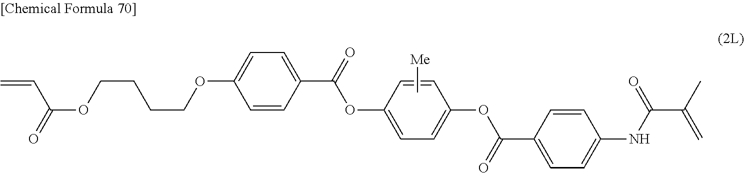

¹H-NMR (solvent: CDCl₃) δ (ppm): 1.9-2.0 (m, 4H), 2.05 (s, 3H), 2.25 (s, 3H), 4.1-4.3 (m, 4H), 5.5 (d, 1H), 5.8-5.9 (m, 2H), 6.1 (dd, 1H), 6.4 (d, 1H), 6.9-7.0 (m, 2H), 7.1-7.2 (m, 3H), 7.7-7.8 (m, 2H), 8.0 (s, 1H), 8.1-8.2 (m, 4H)

Compound (3L) was obtained according to the same synthetic method as in Synthesis example 1, except that 4-(allyloxycarbamoyl)benzoic acid was used instead of carboxylic acid 1-IV. Also Compound (3L) was found to show nematic liquid crystallinity, similarly to Compound (1).

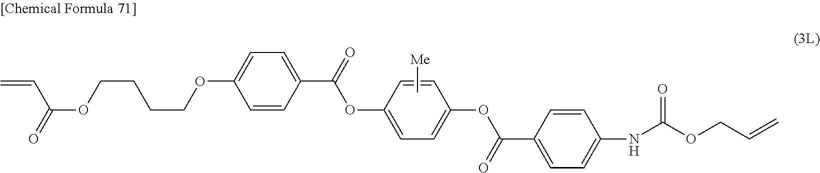

¹H-NMR (solvent: CDCl₃) δ(ppm): 1.9-2.0 (m, 4H), 2.25 (s, 3H), 4.1-4.3 (m, 4H), 4.7 (m, 2H), 5.25-5.45 (m, 2H), 5.8 (d, 1H), 5.9-6.0 (m, 1H), 6.15 (dd, 1H), 6.4 (d, 1H), 6.9-7.0 (m, 2H), 7.1-7.2 (m, 3H), 7.4 (m, 1H), 7.45-7.55 (m, 2H), 8.1-8.2 (m, 4H)

Compound (4L) was obtained according to the same synthetic method as in Synthesis example 1, except that 4-allyloxybenzoic acid was used instead of carboxylic acid 1-IV. Also Compound (4L) was found to show nematic liquid crystallinity, similarly to Compound (1).

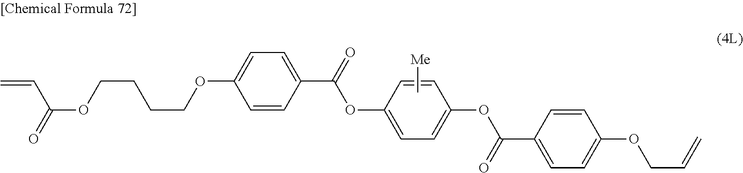

¹H-NMR (solvent: CDCl₃) δ (ppm): 1.9-2.0 (m, 4H), 2.25 (s, 3H), 4.1-4.3 (m, 4H) 4.65 (m, 2H), 5.3-5.5 (m, 2H), 5.8 (d, 1H), 6.0-6.1 (m, 1H), 6.15 (dd, 1H), 6.4 (d, 1H), 6.9-7.0 (m, 4H), 7.1-7.2 (m, 3H), 8.1-8.2 (m, 4H)

Compound (7L) was obtained according to the same synthetic method as in Synthesis example 1, except that 4-[N-(2-methacryloyloxyethyl)carbamoyloxy]benzoic acid was used instead of carboxylic acid 1-IV. Also Compound (7L) was found to show nematic liquid crystallinity, similarly to Compound (1).

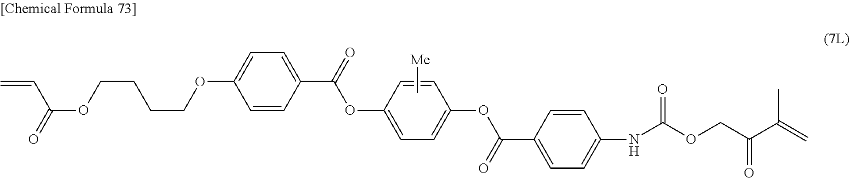

¹H-NMR (solvent: CDCl₃) δ(ppm): 1.9-2.0 (m, 4H), 2.0 (s, 3H), 2.25 (s, 3H), 3.6-3.7 (m, 2H), 4.1-4.4 (m, 6H), 5.4 (bd, 1H), 5.65 (d, 1H), 5.8-5.9 (d, 2H), 6.15 (dd, 1H), 6.4 (d, 1H), 6.9-7.0 (m, 4H), 7.1-7.2 (m, 3H), 8.1-8.2 (m, 4H)

Compound (8L) was obtained according to the same synthetic method as in Synthesis example 1, except that carboxylic acid (V-29) synthesized referring to paragraph [0082] of JP-A-2013-067603 was used instead of carboxylic acid 1-IV. Also Compound (8L) was found to show nematic liquid crystallinity, similarly to Compound (1).

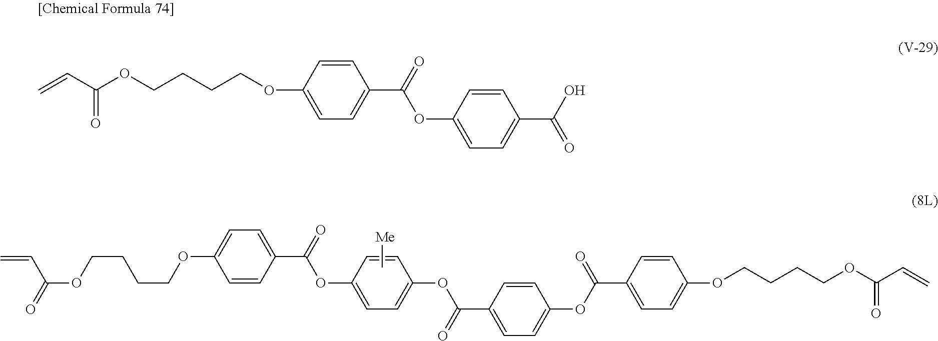

¹H-NMR (solvent: CDCl₃) δ (ppm) 1.8-2.0 (m, 8H), 2.3 (s, 3H), 4.2-4.5 (m, 8H), 5.8 (m, 2H), 6.1 (m, 2H), 6.4 (m, 2H), 6.9-7.0 (m, 4H), 7.1-7.2 (m, 3H), 7.3-7.4 (m, 2H), 8.1-8.2 (m, 4H), 8.2-8.3 (m, 2H)

Compound (1N) was obtained according to the same synthetic method as in Synthesis example 1, except that carboxylic acid (V-32) synthesized referring to paragraph [0082] of JP-A-2013-067603 was used instead of carboxylic acid 1-IV. Also Compound (1N) was found to show nematic liquid crystallinity, similarly as Compound (1).

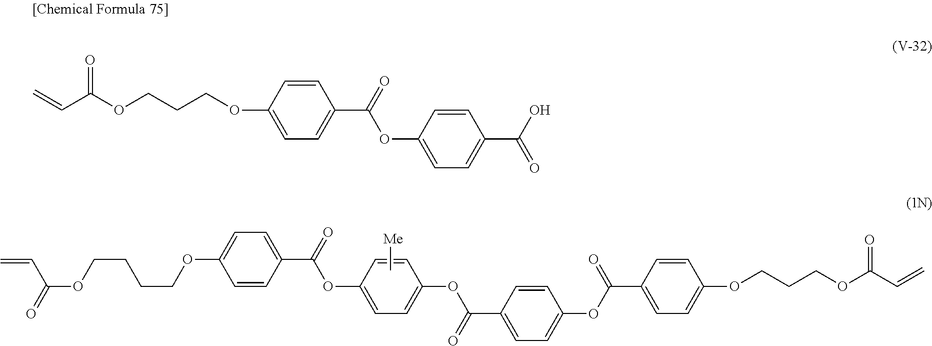

¹H-NMR (solvent: CDCl₃) δ (ppm) 1.8-2.0 (m, 6H), 2.3 (s, 3H), 4.2-4.5 (m, 8H), 5.8 (m, 2H), 6.1 (m, 2H), 6.4 (m, 2H), 6.9-7.0 (m, 4H), 7.1-7.2 (m, 3H), 7.3-7.4 (m, 2H), 8.1-8.2 (m, 4H), 8.2-8.3 (m, 2H)

Compound (2N) was obtained according to the same synthetic method as in Synthesis example 1, except that carboxylic acid (V-31) synthesized referring to paragraph [0082] of JP-A-2013-067603 was used instead of carboxylic acid 1-IV. Also Compound (2N) was found to show nematic liquid crystallinity, similarly to Compound (1).

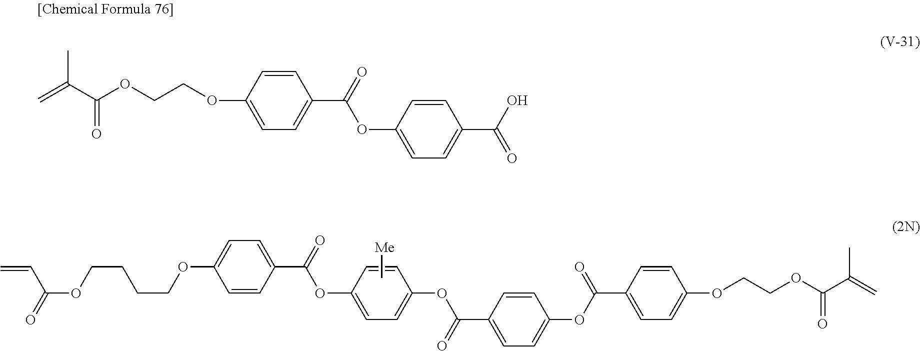

¹H-NMR (solvent: CDCl₃) δ(ppm): 1.9-2.0 (m, 4H), 2.0 (s, 3H), 2.25 (s, 3H), 4.1-4.5 (m, 8H), 5.65 (d, 1H), 5.8-5.9 (m, 2H), 6.15 (dd, 1H), 6.4 (d, 1H), 6.9-7.0 (m, 4H), 7.1-7.2 (m, 3H), 7.3-7.4 (m, 2H), 8.1-8.2 (m, 4H), 8.2-8.3 (m, 2H)

### Synthesis of Liquid Crystal Compound Represented by Formula (2) Used in this Invention

### Synthesis Example 12

Compound (11) was synthesized according to the scheme below.

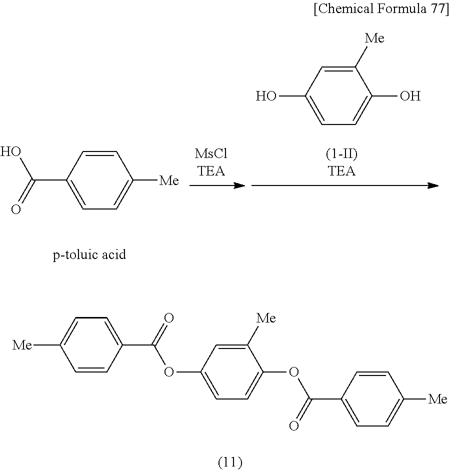 [SMILES: Cc1cc(O)ccc1O ; Cc1ccc(C(=O)O)cc1 ; Cc1ccc(C(=O)Oc2ccc(OC(=O)c3ccc(C)cc3)c(C)c2)cc1]

BHT (37 mg) was added to an ethyl acetate solution (14.2 mL) containing methanesulfonyl chloride (3.95 g, 34.5 mmol), and the inner temperature was lowered down to −5° C. To the content, a THF solution (9 mL) containing p-toluic acid (32.9 mmol, 4.48 g) and triethylamine (4.9 mL) was added dropwise, so as not to elevate the inner temperature up to 0° C. or above. The content was stirred at −5° C. for 30 minutes, then an ethyl acetate solution (10 mL) containing 1-II (2.0 g), and DMAP (a spatula full) were added, and triethylamine (4.9 mL) was dropwise over 15 minutes. The content was stirred at room temperature for 4 hours. The reaction was terminated by adding methanol and water, and the precipitate was collected by filtration to obtain a crude product of Compound (11). The crude product was purified by silica gel column chromatography, to thereby obtain Compound (11) in a yield of 76%. ¹H-NMR (solvent: CDCl₃) δ(ppm): 2.2 (s, 3H), 2.5 (s, 6H), 7.0-7.2 (m, 3H), 7.3-7.4 (m, 4H), 8.1-8.2 (m, 4H)

### Synthesis Example 13

Compound (12) was obtained according to the same synthetic method as in Synthesis example 12, except that p-ethylbenzoic acid was used instead of p-toluic acid.

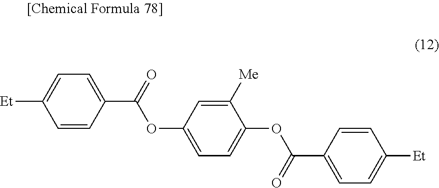 [SMILES: CCc1ccc(C(=O)Oc2ccc(OC(=O)c3ccc(CC)cc3)c(C)c2)cc1]

¹H-NMR (solvent: CDCl₃) δ (ppm): 1.3 (t, 6H), 2.3 (s, 3H), 2.7-2.8 (m, 4H), 7.0-7.2 (m, 3H), 7.3-7.4 (m, 4H), 8.1-8.2 (m, 4H)

### Synthesis Example 14

Compound (13) was obtained according to the same synthetic method as in Synthesis example 12, except that p-n-propylbenzoic acid was used instead of p-toluic acid.

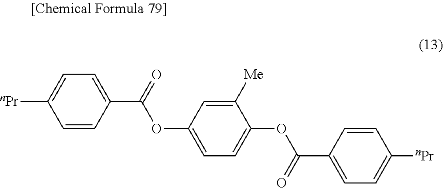

¹H-NMR (solvent: CDCl₃) δ(ppm): 1.0 (t, 6H), 1.6-1.8 (m, 4H), 2.3 (s, 3H), 2.7-2.8 (m, 4H), 7.0-7.2 (m, 3H), 7.3-7.4 (m, 4H), 8.1-8.2 (m, 4H)

### Synthesis Example 15

Compound (14) was obtained according to the same synthetic method as in Synthesis example 12, except that p-n-butylbenzoic acid was used instead of p-toluic acid.

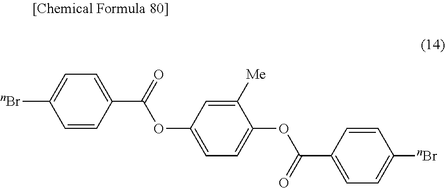

¹H-NMR (solvent: CDCl₃) δ (ppm): 0.9 (t, 6H), 1.3-1.5 (m, 4H), 1.6-1.7 (m, H) 2.3 (s, 3H), 2.7-2.8 (m, 4H), 7.0-7.2 (m, 3H), 7.3-7.4 (m, 4H), 8.1-8.2 (m, 4H)

### Synthesis Example 16

Compound (15) was obtained according to the same synthetic method as in Synthesis example 12, except that p-methoxybenzoic acid was used instead of p-toluic acid.

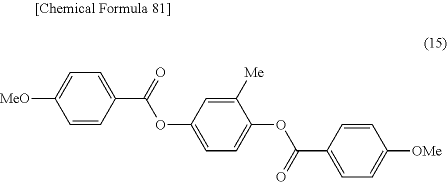 [SMILES: COc1ccc(C(=O)Oc2ccc(OC(=O)c3ccc(OC)cc3)c(C)c2)cc1]

¹H-NMR (solvent: CDCl₃) δ (ppm) 2.2 (s, 3H), 3.9 (s, 6H), 6.9-7.0 (m, 4H), 7.0-7.2 (m, 3H), 8.1-8.2 (m, 4H)

### Synthesis Example 17

Compound (16) was obtained according to the same synthetic method as in Synthesis example 12, except that p-ethoxybenzoic acid was used instead of p-toluic acid.

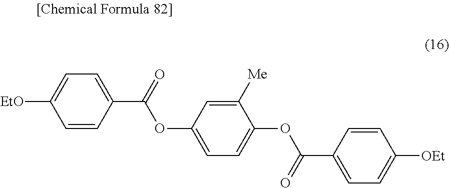 [SMILES: CCOc1ccc(C(=O)Oc2ccc(OC(=O)c3ccc(OCC)cc3)c(C)c2)cc1]

¹H-NMR (solvent: CDCl₃) δ(ppm): 1.5 (t, 6H), 2.3 (s, 3H), 4.0-4.3 (m, 4H), 6.9-7.0 (m, 4H), 7.0-7.2 (m, 3H), 8.1-8.2 (m, 4H)

### Synthesis Example 18

Compound (17) was obtained according to the same synthetic method as in Synthesis example 12, except that p-phenylbenzoic acid was used instead of p-toluic acid.

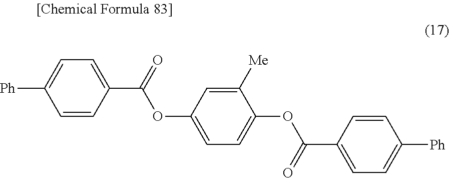 [SMILES: Cc1cc(OC(=O)c2ccc(-c3ccccc3)cc2)ccc1OC(=O)c1ccc(-c2ccccc2)cc1]

¹H-NMR (solvent: CDCl₃) δ (ppm): 2.3 (s, 3H), 7.1-7.3 (m, 3H), 7.4-7.5 (m, 6H), 7.6-7.8 (m, 8H), 8.1-8.3 (m, 4H)

### Synthesis Example 19

Compound (18) was obtained according to the same synthetic method as in Synthesis example 12, except that p-methoxycinnamic acid was used instead of p-toluic acid.

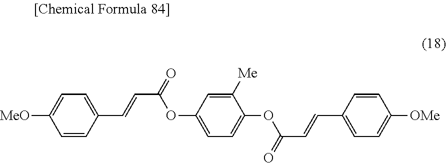 [SMILES: COc1ccc(/C=C/C(=O)Oc2ccc(OC(=O)/C=C/c3ccc(OC)cc3)c(C)c2)cc1]

¹H-NMR (solvent: CDCl₃) δ (ppm): 2.2 (s, 3H), 3.9 (s, 6H), 5.8 (d, 1H), 6.1 (dd, 1H), 6.4-6.6 (m, 2H), 6.9-7.0 (m, 4H), (m, 3H), 7.5-7.6 (m, 2H), 7.8-7.9 (m, 1H), 8.1-8.2 (m, 2H)

### Synthesis Example 20

Compound (19) was obtained according to the same synthetic method as in Synthesis example 12, except that cinnamic acid was used instead of p-toluic acid.

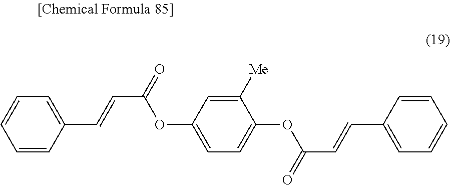 [SMILES: Cc1cc(OC(=O)/C=C/c2ccccc2)ccc1OC(=O)/C=C/c1ccccc1]

¹H-NMR (solvent: CDCl₃) δ (ppm): 1.9-2.0 (m, 4H), 2.2 (s, 3H), 4.1-4.3 (m, 4H), 5.8 (d, 1H), 6.1 (dd, 1H), 6.4 (d, 1H), 6.6-6.7 (d, 1H), 6.9-7.0 (m, 4H), 7.1-7.2 (m, 3H), 7.4-7.5 (m, 3H), 7.6-7.7 (m, 2H), 7.9 (d, 1H), 8.1-8.2 (m, 2H)

Compound (11L) was obtained according to the same synthetic method as in Synthesis example 12, except that 4-(acryloylamino)benzoic acid was used instead of p-toluic acid.

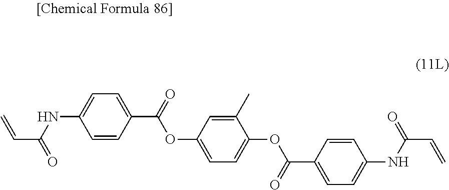 [SMILES: C=CC(=O)Nc1ccc(C(=O)Oc2ccc(OC(=O)c3ccc(NC(=O)C=C)cc3)c(C)c2)cc1]

¹H-NMR (solvent: CDCl₃) δ(ppm): 2.25 (s, 3H), 5.8-5.9 (m, 2H), 6.3-6.5 (m, 4H), 7.1-7.2 (m, 3H), 7.6-7.7 (m, 4H), 7.8 (s, 2H), 8.1-8.2 (m, 4H)

Compound (12L) was obtained according to the same synthetic method as in Synthesis example 12, except that 4-(methacryloylamino)benzoic acid was used instead of p-toluic acid.

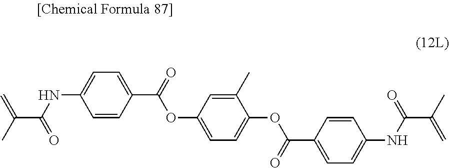 [SMILES: C=C(C)C(=O)Nc1ccc(C(=O)Oc2ccc(OC(=O)c3ccc(NC(=O)C(=C)C)cc3)c(C)c2)cc1]

¹H-NMR (solvent: CDCl₃) δ (ppm): 2.05 (s, 6H), 2.25 (s, 3H), 5.5 (d, 2H), 5.8-5.9 (d, 2H), 7.1-7.2 (m, 3H), 7.7-7.8 (m, 4H), 8.0 (s, 2H), 8.1-8.2 (m, 4H)

Compound (13L) was obtained according to the same synthetic method as in Synthesis example 12, except that 4-(allyloxycarbamoyl)benzoic acid was used instead of p-toluic acid.

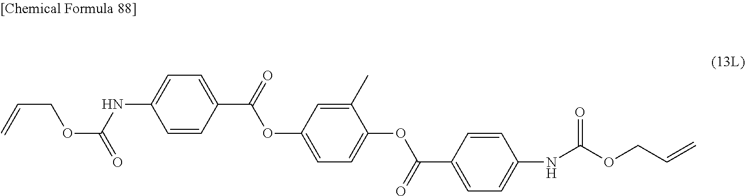 [SMILES: C=CCOC(=O)Nc1ccc(C(=O)Oc2ccc(OC(=O)c3ccc(NC(=O)OCC=C)cc3)c(C)c2)cc1]

¹H-NMR (solvent: CDCl₃) δ (ppm): 2.25 (s, 3H), 4.7 (m, 4H), 5.25-5.45 (m, 4H), 5.9-6.0 (m, 2H), 7.1-7.2 (m, 3H), 7.4 (m, 2H), 7.45-7.55 (m, 4H), 8.1-8.2 (m, 4H)

Compound (14L) was obtained according to the same synthetic method as in Synthesis example 12, except that 4-allyloxybenzoic acid was used instead of p-toluic acid.

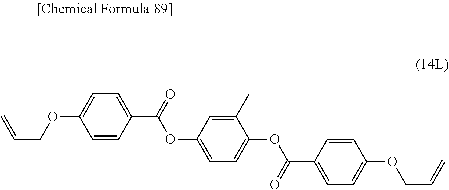 [SMILES: C=CCOc1ccc(C(=O)Oc2ccc(OC(=O)c3ccc(OCC=C)cc3)c(C)c2)cc1]

¹H-NMR (solvent: CDCl₃) δ (ppm): 2.25 (s, 3H), 4.65 (m, 4H), 5.3-5.5 (m, 4H), 6.0-6.1 (m, 2H), 6.9-7.0 (m, 4H), 7.1-7.2 (m, 3H), 8.1-8.2 (m, 4H)

Compound (17L) was obtained according to the same synthetic method as in Synthesis example 12, except that 4-[N-(2-methacryloyloxyethyl)carbamoyloxy]benzoic acid was used instead of p-toluic acid.

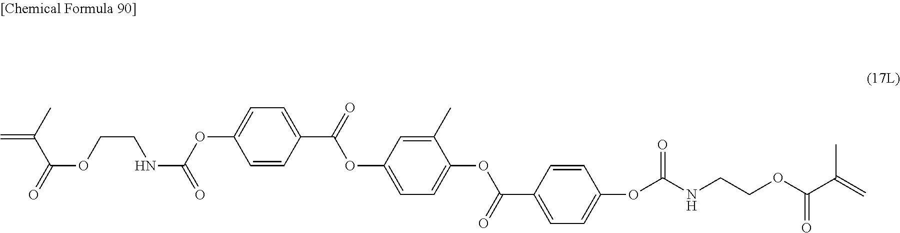 [SMILES: C=C(C)C(=O)OCCNC(=O)Oc1ccc(C(=O)Oc2ccc(OC(=O)c3ccc(OC(=O)NCCOC(=O)C(=C)C)cc3)c(C)c2)cc1]

¹H-NMR (solvent: CDCl₃) δ (ppm): 2.0 (s, 6H), 2.25 (s, 3H), 3.6-3.7 (m, 4H), 4.1-4.4 (m, 4H), 5.4 (bd, 2H), 5.65 (d, 2H), 5.8-5.9 (d, 2H), 6.9-7.0 (m, 4H), 7.1-7.2 (m, 3H), 8.1-8.2 (m, 4H)

Compound (11M) was obtained according to the same synthetic method as in Synthesis example 12, except that carboxylic acid (V-29) synthesized referring to paragraph [0082] of JP-A-2013-067603 was used instead of p-toluic acid.

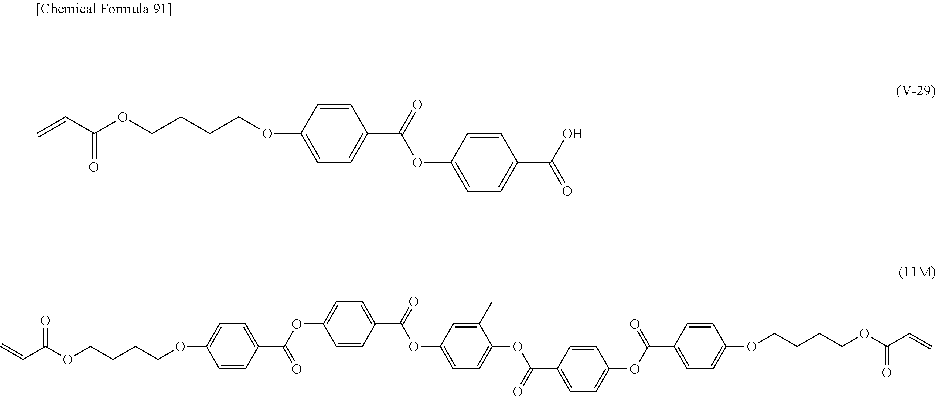 [SMILES: C=CC(=O)OCCCCOc1ccc(C(=O)Oc2ccc(C(=O)O)cc2)cc1 ; C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]

¹H-NMR (solvent: CDCl₃) δ (ppm): 1.8-2.0 (m, 8H), 2.3 (s, 3H), 4.2-4.5 (m, 8H), 5.8 (m, 2H), 6.1 (m, 2H), 6.4 (m, 2H), 6.9-7.0 (m, 4H), 7.1-7.2 (m, 3H), 7.3-7.4 (m, 4H), 8.1-8.2 (m, 4H), 8.2-8.3 (m, 4H)

Compound (14M) was obtained according to the same synthetic method as in Synthesis example 12, except that carboxylic acid (V-31) synthesized referring to paragraph [0082] of JP-A-2013-067603 was used instead of p-toluic acid.

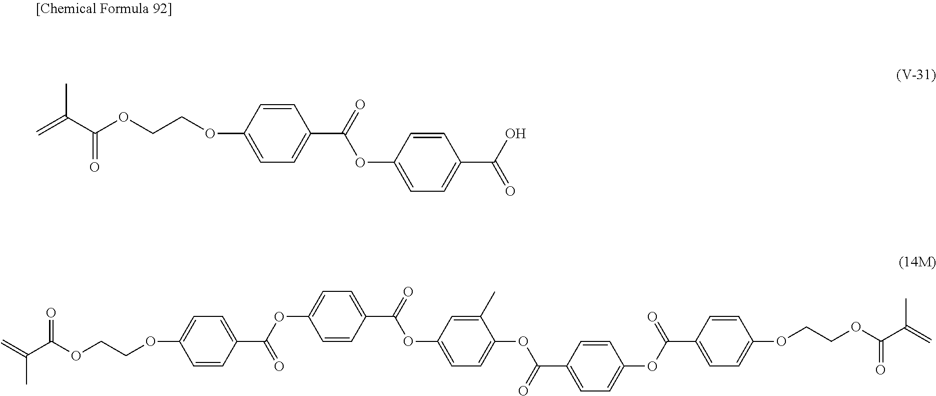 [SMILES: C=C(C)C(=O)OCCOc1ccc(C(=O)Oc2ccc(C(=O)O)cc2)cc1 ; C=C(C)C(=O)OCCOc1ccc(C(=O)Oc2ccc(C(=O)Oc3ccc(OC(=O)c4ccc(OC(=O)c5ccc(OCCOC(=O)C(=C)C)cc5)cc4)c(C)c3)cc2)cc1]

¹H-NMR (solvent: CDCl₃) δ (ppm): 2.0 (s, 6H), 2.25 (s, 3H), 4.1-4.5 (m, 8H), 5.65 (d, 2H), 5.8-5.9 (m, 2H), 6.9-7.0 (m, 4H), 7.1-7.2 (m, 3H), 7.3-7.4 (m, 4H), 8.1-8.2 (m, 4H), 8.2-8.3 (m, 4H)

Compound (15M) was obtained according to the same synthetic method as in Synthesis example 12, except that carboxylic acid (V-32) synthesized referring to paragraph [0082] of JP-A-2013-067603 was used. instead of p-toluic acid

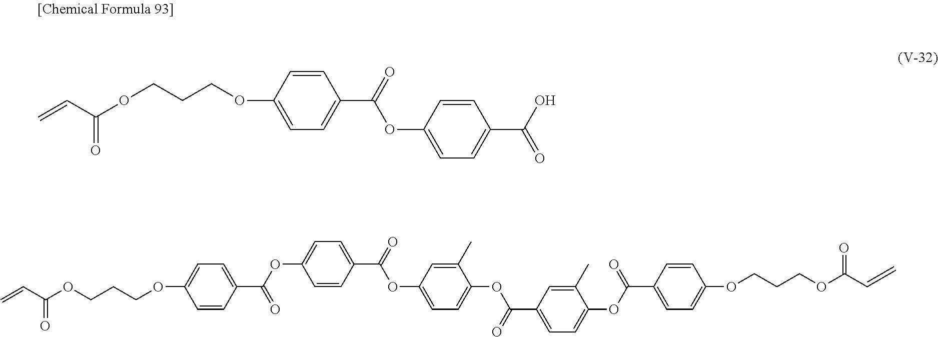 [SMILES: C=CC(=O)OCCCOc1ccc(C(=O)Oc2ccc(C(=O)O)cc2)cc1 ; C=CC(=O)OCCCOc1ccc(C(=O)Oc2ccc(C(=O)Oc3ccc(OC(=O)c4ccc(OC(=O)c5ccc(OCCCOC(=O)C=C)cc5)c(C)c4)c(C)c3)cc2)cc1]

¹H-NMR (solvent: CDCl₃) δ(ppm): 1.8-2.0 (m, 4H), 2.3 (s, 3H), 4.2-4.5 (m, 8H), 5.8 (m, 2H), 6.1 (m, 2H), 6.4 (m, 2H), 6.9-7.0 (m, 4H), 7.1-7.2 (m, 3H), 7.3-7.4 (m, 4H), 8.1-8.2 (m, 4H), 8.2-8.3 (m, 4H)

### Example 1

A mixture of Compounds (1), (11) and (1-A) was obtained according to the scheme below.

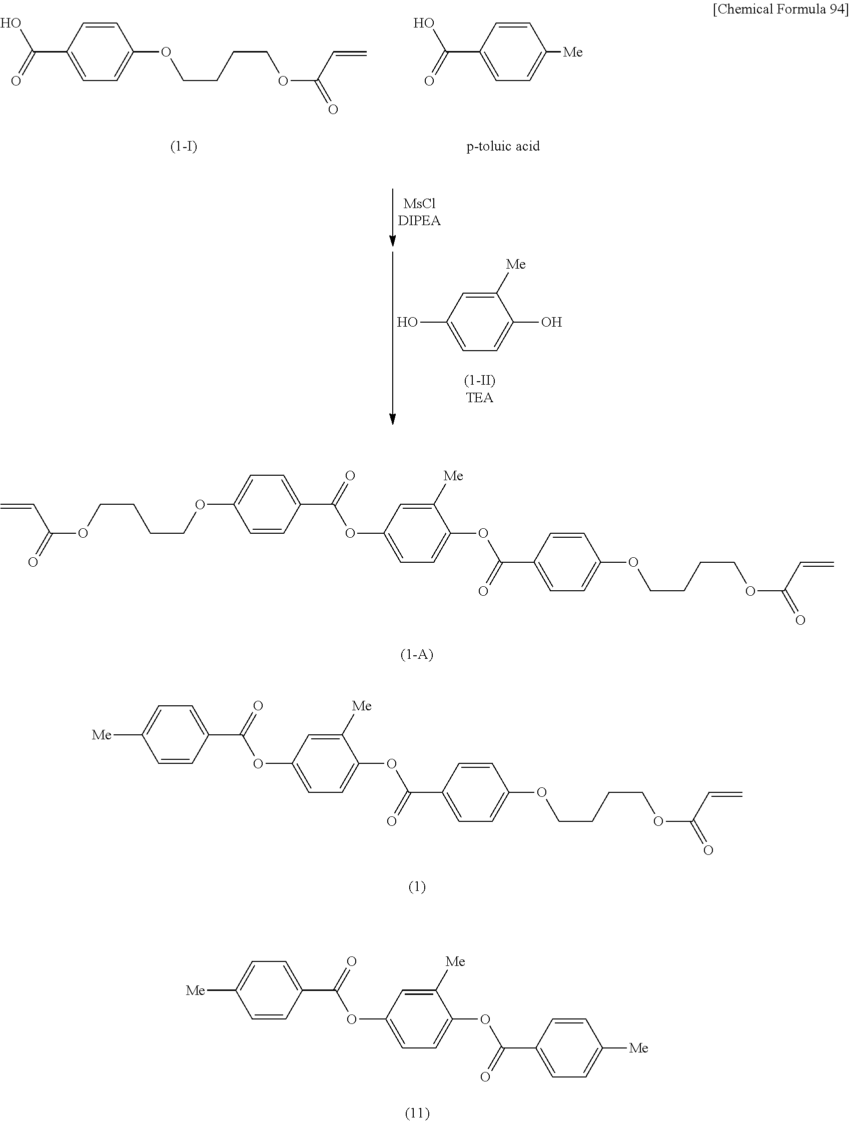 [SMILES: C=CC(=O)OCCCCOc1ccc(C(=O)O)cc1 ; Cc1ccc(C(=O)O)cc1 ; Cc1cc(O)ccc1O ; C=CC(=O)OCCCCOc1ccc(C(=O)Oc2ccc(OC(=O)c3ccc(OCCCCOC(=O)C=C)cc3)c(C)c2)cc1 ; C=CC(=O)OCCCCOc1ccc(C(=O)Oc2ccc(OC(=O)c3ccc(C)cc3)cc2C)cc1 ; Cc1ccc(C(=O)Oc2ccc(OC(=O)c3ccc(C)cc3)c(C)c2)cc1]

Compound (1-I) (106.1 g, 401.3 mmol) and p-toluic acid (6.07 g, 44.6 mmol) were mixed with ethyl acetate (100 mL), tetrahydrofuran (100 mL) and triethylamine (83.6 mL). The obtained solution was slowly added dropwise to an ethyl acetate solution containing methanesulfonyl chloride (50.8 g, 443.7 mmol) under cooling on ice.

The mixture was then stirred under cooling on ice for one hour, an ethyl acetate solution of Compound (1-II) was added dropwise under cooling on ice, and then triethylamine (67.3 mL) was slowly added dropwise under cooling on ice.

The obtained mixture was then stirred for 2 hours, while keeping the reaction temperature at 20° C., and then, water (60 g) was added to allow extraction into an organic layer, and the organic layer was washed with a 2% aqueous hydrochloric acid solution, and then with a 10% aqueous sodium chloride solution.

The organic layer was filtered under suction, methanol/water was added to the filtrate so as to allow crystal to deposit, and the deposited crystal was collected by filtration to obtain liquid crystal composition which contains a mixture of Compounds (1), (11) and (1-A) (yield=107.7 g)

The contents by mass of the Compounds (1), (11) and (1-A) in the thus obtained liquid crystal composition were found to be 8.3%, 0.7% and 91%, respectively.

### Example 2

### Preparation of Liquid Crystal Composition

Using Compound (1) synthesized in Synthesis example 1, Compound (11) synthesized in Synthesis example 12, and the polymerizable liquid crystal Compound (1-A), a liquid crystal composition was prepared according to the method described below.

A coating liquid (A) of liquid crystal composition, having the composition below, was prepared as a liquid crystal composition of Example 2.

| | | |
|---|---|---|
| Polymerizable liquid crystal Compound (1) | 15 | parts by mass |
| of Formula (1) | | |
| Liquid crystal Compound (11) of Formula (2) | 2 | parts by mass |
| Polymerizable liquid crystal Compound (1-A) | 85 | parts by mass |
| of Formula (3) | | |
| Methyl ethyl ketone | 238 | parts by mass |

### <Manufacture of Film>

Next, using the thus obtained liquid crystal composition of Example 2, a film of Example 2 was manufactured according to the method described below.

Over a cleaned glass substrate, polyimide alignment film SE-130 from Nissan Chemical Industries Ltd. was spin-coated, the coating was dried, and baked at 250° C. for one hour. The obtained alignment film was rubbed, to thereby manufacture a substrate with alignment film. Over the rubbed surface of alignment film on the substrate, the coating liquid (A) of liquid crystal composition, as the liquid crystal composition of Example 2, was spin-coated at room temperature. The coating formed on the rubbed surface of alignment film on the substrate was allowed to stand still at room temperature for 30 minutes to thereby form the film of Example 2.

### (Evaluation of Suppression of Crystallization)

The thus obtained liquid crystal film, when visually observed in an arbitrary region thereof under a polarization microscope, was found to have a ratio of crystal deposition of 10%.

### Examples 3 to 14, Examples 42 to 53 and Comparative Examples 1 to 6

Coating liquids of liquid crystal compositions were prepared in the same way as in Example 2, except that Compounds (1) and (1-A) prepared in Example 1 were replaced with the compounds shown in Table 1 below, to respectively prepare liquid crystal compositions of the individual Examples and Comparative Examples.

Films of the individual Examples and Comparative Examples were manufactured in the same way as in Example 2, except that the liquid crystal composition of Example 2 was replaced with the liquid crystal compositions of the individual Examples and Comparative Examples.

The ratio of crystal deposition was measured for the thus obtained films of the individual Example and Comparative Examples. Results were summarized in Table 1. In Table, “Polymerizable liquid crystal compound of Formula (1)” is a compound represented by the above described Formula (1), and is preferably a polymerizable liquid crystal compound having one (meth)acrylate group. “Liquid crystal compound of Formula (2)” is a compound represented by the above described Formula (2), and is preferably a liquid crystal compound not having (meth)acrylate group. “Polymerizable liquid crystal compound of Formula (3)” is a compound represented by the above described Formula (3), and is preferably a polymerizable liquid crystal compound having two (meth)acrylate group.

TABLE 1

| | Polymerizable | | Polymerizable | Evaluation |
|---|---|---|---|---|
| | liquid crystal | Liquid crystal | liquid crystal | for Crystal |
| | compound of | compound of | compound of | Deposition |
| | Formula (1) | Formula (2) | Formula (3) | of Film |
| Example 2 | Compound(1) | Compound(11) | Compound(1-A) | A |
| | 15 parts by weight | 2 parts by weight | 85 parts by weight | |
| Example 3 | Compound(2) | Compound(12) | Compound(1-A) | A |
| | 15 parts by weight | 2 parts by weight | 85 parts by weight | |
| Example 4 | Compound(3) | Compound(13) | Compound(1-A) | B |
| | 15 parts by weight | 2 parts by weight | 85 parts by weight | |
| Example 5 | Compound(4) | Compound(14) | Compound(1-A) | B |
| | 15 parts by weight | 2 parts by weight | 85 parts by weight | |
| Example 6 | Compound(5) | Compound(15) | Compound(1-A) | A(S) |
| | 15 parts by weight | 2 parts by weight | 85 parts by weight | |
| Example 7 | Compound(6) | Compound(16) | Compound(1-A) | A(S) |
| | 15 parts by weight | 2 parts by weight | 85 parts by weight | |
| Example 8 | Compound(7) | Compound(17) | Compound(1-A) | A(S) |
| | 15 parts by weight | 2 parts by weight | 85 parts by weight | |
| Example 9 | Compound(8) | Compound(18) | Compound(1-A) | B |
| | 15 parts by weight | 2 parts by weight | 85 parts by weight | |
| Example 10 | Compound(9) | Compound(19) | Compound(1-A) | B |
| | 15 parts by weight | 2 parts by weight | 85 parts by weight | |
| Example 11 | Compound(1) | Compound(17) | Compound(1-A) | B |
| | 15 parts by weight | 2 parts by weight | 85 parts by weight | |
| Example 12 | Compound(2) | Compound(17) | Compound(1-A) | A |
| | 15 parts by weight | 2 parts by weight | 85 parts by weight | |
| Example 13 | Compound(2A) | Compound(12) | Compound(1-B) | A(S) |
| | 15 parts by weight | 2 parts by weight | 85 parts by weight | |
| Example 14 | Compound(7F) | Compound(17) | Compound(1-C) | A(S) |
| | 15 parts by weight | 2 parts by weight | 85 parts by weight | |
| Example 42 | Compound(1L) | Compound(11L) | Compound(1-A) | A(S) |
| | 10 parts by weight | 1 parts by weight | 91 parts by weight | |
| Example 43 | Compound(1L) | Compound(11L) | Compound(1-A) | A(S) |
| | 15 parts by weight | 2 parts by weight | 85 parts by weight | |
| Example 44 | Compound(1L) | Compound(11L) | Compound(1-A) | A(S) |
| | 20 parts by weight | 3 parts by weight | 79 parts by weight | |
| Example 45 | Compound(1L) | Compound(11L) | Compound(1-A) | A |
| | 5.3 parts by weight | 0.2 parts by weight | 96.5 parts by weight | |
| Example 46 | Compound(2L) | Compound(12L) | Compound(1-A) | A(S) |
| | 12 parts by weight | 1 parts by weight | 89 parts by weight | |
| Example 47 | Compound(3L) | Compound(13L) | Compound(1-A) | B |
| | 15 parts by weight | 2 parts by weight | 85 parts by weight | |
| Example 48 | Compound(4L) | Compound(14L) | Compound(1-A) | A |
| | 18 parts by weight | 2 parts by weight | 82 parts by weight | |
| Example 49 | Compound(7L) | Compound(17L) | Compound(1-A) | A |
| | 14 parts by weight | 2 parts by weight | 86 parts by weight | |
| Example 50 | Compound(8L) | Compound(11M) | Compound(1-A) | A(S) |
| | 13 parts by weight | 1 parts by weight | 88 parts by weight | |
| Example 51 | Compound(8L) | Compound(11M) | Compound(1-A) | A(S) |
| | 15 parts by weight | 2 parts by weight | 85 parts by weight | |
| Example 52 | Compound(1N) | Compound(15M) | Compound(1-B) | A(S) |
| | 15 parts by weight | 2 parts by weight | 85 parts by weight | |
| Example 53 | Compound(2N) | Compound(14M) | Compound(1-A) | A(S) |
| | 15 parts by weight | 2 parts by weight | 85 parts by weight | |
| Comparative | — | — | Compound(1-A) | D |
| Example 1 | | | 102 parts by weight | |
| Comparative | — | — | Compound(1-B) | D |
| Example 2 | | | 102 parts by weight | |
| Comparative | Compound(1) | — | Compound(1-A) | C |
| Example 3 | 17 parts by weight | | 85 parts by weight | |
| Comparative | — | Compound(11) | Compound(1-A) | D |
| Example 4 | | 2 parts by weight | 98 parts by weight | |
| | | Compound(17) | | |
| | | 2 parts by weight | | |
| Comparative | Comparative Example | — | Compound(1-A) | D |
| Example 5 | Compound(1′) | | 85 parts by weight | |
| | 17 parts by weight | | | |
| Comparative | Comparative Example | — | Compound(1-A) | D |
| Example 6 | Compound(2′) | | 85 parts by weight | |
| | 17 parts by weight | | | |

In Table 1, the ratio of crystal deposition was visually observed area of crystal deposition and ranked. When the area of crystal deposition is 5% or less of the film, the film was ranked at “A (S)” When the area exceeds 5% and 15% or less, the film was ranked at “A”. When the area exceeds 15% and 30% or less, the film was ranked at “B”. When the area exceeds 30% and 50% or less, the film was ranked at “C”. When the area exceeds 50%, the film was ranked at “D”.

Structures of Compound (1-B) and Compound (1-C) in Table 1 are shown below. Also structures of Comparative Compounds (1′) and (2′) in Table 1 are shown below. Note that Comparative Compound (1′) is a compound described in JP-T2-2002-536529, and Comparative Compound (2′) is a compound described in Molecular Crystals and Liquid Crystals (2010), 530 169-174.

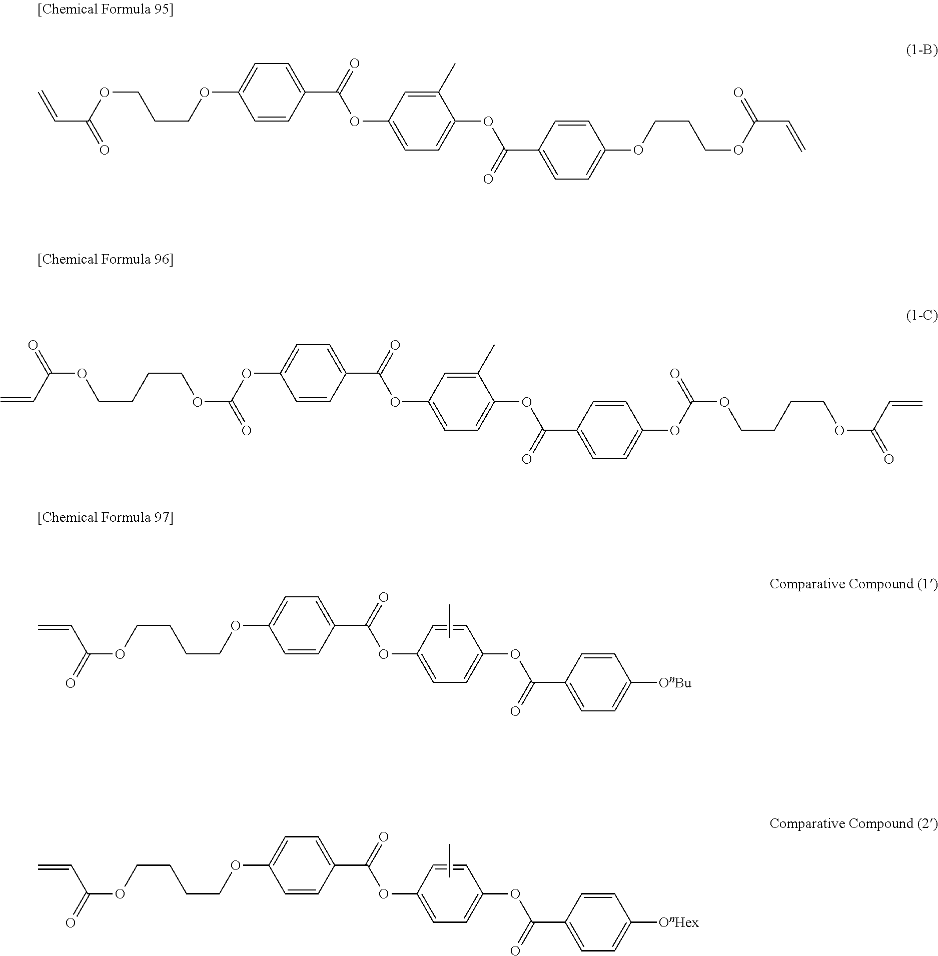

From the results of Examples 2 to 14, Examples 42 to 53 and Comparative Examples 1 to 6 summarized in Table 1, it was demonstrated that the mixtures of the polymerizable liquid crystal compound represented by Formula (1), the liquid crystal compound represented by Formula (2), and the polymerizable liquid crystal compound represented by the formula (1-A) could largely suppress the crystal deposition of polymerizable liquid crystal Compound (1-A).

In particular, combination of the compounds having similar skeletons, such as Compound (1) and Compound (11), was found to improve the suppressive effects on crystal deposition.

From the results of Examples 2 to 14 summarized in Table 1, it was found that, among the polymerizable liquid crystal Compounds (1) to (9), (2A) and (7F) represented by Formula (1) used for this invention, in particular Compounds (1), (2), (5), (6), (7), (2A) and (7F) showed high suppressive effects on crystal deposition. Still among them, Compounds (5), (6), (7), (2A) and (7F) were found to demonstrate high suppressive effects on crystal deposition. While not adhering to any theory, Compound (7) demonstrated a large suppressive effect on crystal deposition, supposedly because the crystal form of the liquid crystal composition, when deposited, was not a crystal form easy to deposit.

From the results of Examples 42 to 53 summarized in Table 1, it was found that, among polymerizable liquid crystal Compounds (1L) to (4L), (7L), (8L), (1N) and (2N) represented by Formula (1) used in this invention, in particular Compounds (1L), (2L), (4L), (7L), (8L), (1N) and (2N) were found to demonstrate high suppressive effects on crystal deposition. Still among them, Compounds (1L), (2L), (8L), (1N) and (2N) were found to demonstrate high suppressive effects on crystal deposition.

### Manufacture of Selective Reflection Film

### Example 15

Liquid crystal composition (B) was prepared using Compound (1), Compound (11) and polymerizable liquid crystal Compound (1-A), according to the method described below.

| | | |
|---|---|---|
| Polymerizable liquid crystal Compound (1) of Formula (1) | 18 | parts by mass |
| Liquid crystal Compound (11) of Formula (2) | 2 | parts by mass |
| Polymerizable liquid crystal Compound (1-A) of Formula (3) | 80 | parts by mass |
| Chiral agent “Paliocolor LC756” (from BASF) | 3 | parts by mass |
| Aligning agent for air interface side (X1-1) | 0.04 | parts by mass |
| Polymerization initiator “Irgacure 819” (from BASF) | 3 | parts by mass |
| Chloroform (solvent) | 300 | parts by mass |

[Chemical Formula 98]
Aligning agent for air interface side (X1-1)

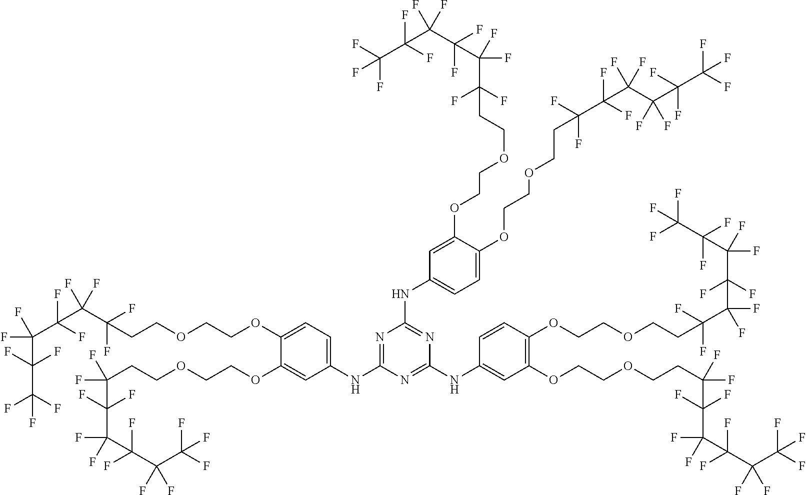 [SMILES: FC(F)(F)C(F)(F)C(F)(F)C(F)(F)C(F)(F)C(F)(F)CCOCCOc1ccc(Nc2nc(Nc3ccc(OCCOCCC(F)(F)C(F)(F)C(F)(F)C(F)(F)C(F)(F)C(F)(F)F)c(OCCOCCC(F)(F)C(F)(F)C(F)(F)C(F)(F)C(F)(F)C(F)(F)F)c3)nc(Nc3ccc(OCCOCCC(F)(F)C(F)(F)C(F)(F)C(F)(F)C(F)(F)C(F)(F)F)c(OCCOCCC(F)(F)C(F)(F)C(F)(F)C(F)(F)C(F)(F)C(F)(F)F)c3)n2)cc1OCCOCCC(F)(F)C(F)(F)C(F)(F)C(F)(F)C(F)(F)C(F)(F)F]

Over the surface of alignment film of a substrate with alignment film manufactured in the same way as in Example 2, Liquid crystal composition (B) was spin-coated at room temperature, ripened at 120° C. for 3 minutes for alignment, irradiated by UV using a high-pressure mercury lamp with the short-wavelength component cut off, at room temperature for 10 seconds to fix the alignment, to thereby obtain a selective reflection film. Crystal deposition wasn't observed in the coated film, during a period after the coating and before the heating.

The obtained selective reflection film was observed under a polarization microscope and confirmed a uniform alignment without alignment defect thereby. The film was further subjected to transmission spectrometry using a spectrophotometer UV-3100PC from Shimadzu Corporation, to find a selective reflection peak in the infrared region.

### Examples 16 to 23

Coating liquids of liquid crystal composition were prepared in the same way as in Example 15, except that Compound (1) was respectively replaced with Compound (2) to Compound (9), and Compound (11) was respectively replaced with Compound (12) to Compound (19). The selective reflection films were formed by respectively using the coating liquids, in the same way as in Example 15. All of the selective reflection films were found to show good alignment. Transmission spectrometry of each of the films, measured using a spectrophotometer UV-3100PC, showed a selective reflection peak in the infrared region.

### Examples 54 to 66

Coating liquids of liquid crystal composition were prepared in the same way as in Example 15, except that the composition prepared by using Compound (1), Compound (11) and Compound (1-A) were replaced with the liquid crystal compositions prepared in Examples 42 to 53. The selective reflection films were formed by respectively using the coating liquids, in the same way as in Example 15. All of the selective reflection films were found to show good alignment. Transmission spectrometry of each of the films, measured using a spectrophotometer UV-3100PC, showed a selective reflection peak in the infrared region.

### Example 24

### Manufacture of Optically-Compensatory Film (1)

Coating liquid (C) of liquid crystal composition was prepared using Compounds (1), (11) and (1-A), according to the method described below.

| | | |
|---|---|---|
| Polymerizable liquid crystal Compound (1) of Formula (1) | 15 | parts by mass |
| Liquid crystal Compound (11) of Formula (2) | 2 | parts by mass |
| Polymerizable liquid crystal Compound (1-A) of Formula (3) | 85 | parts by mass |
| Polymerization initiator “Irgacure 819” (from BASF) | 3 | parts by mass |
| Aligning agent for air interface side (X1-2) | 0.1 | parts by mass |
| Methyl ethyl ketone (solvent) | 400 | parts by mass |

[Chemical Formula 99]
Aligning agent for air interface side (X1-2)

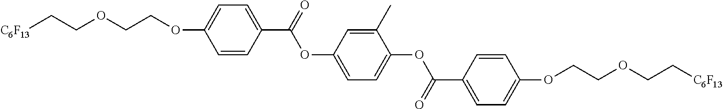

Over a cleaned glass substrate, polyimide alignment film SE-130 from Nissan Chemical Industries Ltd. was spin-coated, the coating was dried, and baked at 250° C. for one hour. The obtained film was rubbed, to thereby manufacture a substrate with alignment film. Over the surface of the substrate, the coating liquid (C) of liquid crystal composition was spin-coated at room temperature, so as to control the thickness of the coating layer to 1 μm, the coated film was ripened at 60° C. for one minute for alignment, irradiated by UV using a high-pressure mercury lamp with the short-wavelength component cut off, at room temperature for 10 seconds to fix the alignment, to thereby obtain an optically-compensatory film. Crystal deposition wasn't observed in the coated film, during a period after the coating and before the heating.

The thus obtained optically-compensatory film was observed under a polarization microscope, to confirm a uniform alignment without alignment defect.

Next, the thus obtained optically-compensatory film was measured regarding retardation (Re) using AxoScan (Mueller matrix polarimeter) from Axometrics, Inc. Re(550) at 550 nm was found to be 162.4 nm.

### Examples 25 to 32

Coating liquids of liquid crystal composition were prepared in the same way as in Example 24, except that the Compound (1) was respectively replaced with Compound (2) to Compound (9), and Compound (11) was respectively replaced with Compound (12) to Compound (19). Optically-compensatory films were manufactured in the same way as in Example 24, by respectively using the coating liquids. The thus obtained optically-compensatory films were respectively observed under a polarization microscope, to confirm uniform alignment without alignment defects. Measured values of Re at 550 nm of the individual optically-compensatory films are as summarized below.

TABLE 2

| | Polymerizable liquid | Liquid crystal | Polymerizable liquid | | |
|---|---|---|---|---|---|
| | crystal compound of | compound of | crystal compound of | | Film |
| | Formula (1) | Formula (2) | Formula (3) | Re | thickness |
| | (15 parts by weight) | (2 parts by weight) | (85 parts by weight) | (nm) | (μm) |
| Example 24 | Compound(1) | Compound(11) | Compound(1-A) | 161.8 | 1.01 |
| Example 25 | Compound(2) | Compound(12) | Compound(1-A) | 162.0 | 1.00 |
| Example 26 | Compound(3) | Compound(13) | Compound(1-A) | 164.3 | 1.02 |
| Example 27 | Compound(4) | Compound(14) | Compound(1-A) | 162.7 | 1.02 |
| Example 28 | Compound(5) | Compound(15) | Compound(1-A) | 165.7 | 0.99 |
| Example 29 | Compound(6) | Compound(16) | Compound(1-A) | 166.1 | 1.02 |
| Example 30 | Compound(7) | Compound(17) | Compound(1-A) | 180.8 | 1.02 |
| Example 31 | Compound(8) | Compound(18) | Compound(1-A) | 182.1 | 1.01 |
| Example 32 | Compound(9) | Compound(19) | Compound(1-A) | 159.2 | 1.00 |

### Examples 67 to 74

Coating liquids of liquid crystal composition were prepared in the same way as in Example 24, except that the Compound (1), Compound (11) and Compound (1-A) were replaced with the compounds summarized in Table below. Optically-compensatory films were formed in the same way as in Example 24, by respectively using the coating liquids. The thus obtained optically-compensatory films were observed under a polarization microscope, to confirm uniform alignment without alignment defects. Measured values of Re at 550 nm of the individual optically-compensatory films are as summarized below.

TABLE 3

| | Polymerizable liquid | Liquid crystal | Polymerizable liquid | | |
|---|---|---|---|---|---|
| | crystal compound of | compound of | crystal compound of | | Film |
| | Formula (1) | Formula (2) | Formula (3) | Re | thickness |
| | (15 parts by weight) | (2 parts by weight) | (85 parts by weight) | (nm) | (μm) |
| Example 67 | Compound(1L) | Compound(11L) | Compound(1-A) | 178.8 | 1.00 |
| Example 68 | Compound(2L) | Compound(12L) | Compound(1-A) | 163.5 | 1.01 |
| Example 69 | Compound(3L) | Compound(13L) | Compound(1-A) | 172.5 | 0.99 |
| Example 70 | Compound(4L) | Compound(14L) | Compound(1-A) | 159.2 | 1.02 |
| Example 71 | Compound(7L) | Compound(17L) | Compound(1-A) | 132.0 | 0.99 |
| Example 72 | Compound(8L) | Compound(11M) | Compound(1-A) | 181.8 | 1.00 |
| Example 73 | Compound(1N) | Compound(15M) | Compound(1-B) | 182.0 | 1.02 |
| Example 74 | Compound(2N) | Compound(14M) | Compound(1-A) | 179.1 | 1.00 |

### Example 33

### Manufacture of Optically-Compensatory Film (2)

Coating liquid (D) of liquid crystal composition was prepared using Compounds (1), (11) and (1-A), according to the method described below.

| | | |
|---|---|---|
| Monofunctional polymerizable Compound (1) | 15 | parts by mass |
| Non-polymerizable Compound (11) | 2 | parts by mass |
| Bifunctional polymerizable Compound (1-A) | 85 | parts by mass |
| Sensitizer (Kayacure DETX, from Nippon Kayaku Co., Ltd.) | 1 | part by mass |
| Aligning agent for air interface side (X1-3) | 0.11 | parts by mass |
| Onium salt (X1-4) | 1.5 | parts by mass |
| Methyl ethyl ketone (solvent) | 300 | parts by mass |

[Chemical Formula 100]
Aligning agent for air interface side (X1-3) 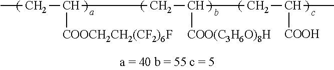
[Chemical Formula 101]
Onium salt (X1-4)

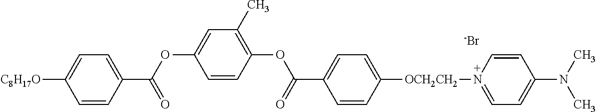

### Composition of Coating Liquid of Alignment Film

| | | |
|---|---|---|
| Modified polyvinyl alcohol, shown below | 10 | parts by mass |
| Water | 371 | parts by mass |
| Methanol | 119 | parts by mass |
| Glutaraldehyde | 0.5 | parts by mass |

[Chemical Formula 102]
Modified polyvinyl alcohol

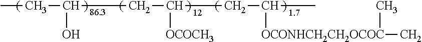

On a cleaned glass substrate, the coating liquid for forming alignment film was coated using a wire bar coater in an amount of 20 mL/m². The coating was dried under hot air at 60° C. for 60 seconds, and further under hot air at 100° C. for 120 seconds, to thereby fabricate a substrate with alignment film. Over the surface of the substrate, coating liquid of liquid crystalline composition (D) was coated at room temperature by spin coating so as to control the coating layer thickness of 1 μm, the coating was aged for alignment at 60° C. for one minute, and then irradiated with light at 50° C. using a high-pressure mercury lamp, with short wavelength UV components cut off, for 10 seconds to fix the alignment, to thereby form an optical compensation film. Crystal deposition in the coated film wasn't observed over the period after the coating and before the heating.

The obtained optical compensation film was observed under a polarizing microscope, and was found to show uniform alignment without alignment defect.

Further measurement of Rth of the obtained optical compensation film, using AxoScan (Mueller matrix polarimeter) from Axometrics, Inc., showed an Rth at 550 nm of −124.8 nm.

### Examples 34 to 41

Coating liquids of liquid crystalline compositions were respectively prepared in the same way as in Example 33, except that compound (2) to compound (9) were used in place of compound (1). Optical compensation films were formed by respectively using these coating liquids, in the same way as in Example 33. The obtained optical compensation films were observed under a polarizing microscope, and were found to show uniform alignment without alignment defect. Further measurement of Rth at 550 nm and thickness of the obtained optical compensation films, were as summarized below.

TABLE 4

| | Polymerizable liquid | Liquid crystal | Polymerizable liquid | | |
|---|---|---|---|---|---|
| | crystal compound of | compound of | crystal compound of | | Film |
| | Formula (1) | Formula (2) | Formula (3) | Rth | thickness |
| | (15 parts by weight) | (2 parts by weight) | (85 parts by weight) | (nm) | (μm) |
| Example 33 | Compound(1) | Compound(11) | Compound(1-A) | −124.1 | 1.47 |
| Example 34 | Compound(2) | Compound(12) | Compound(1-A) | −126.6 | 1.47 |
| Example 35 | Compound(3) | Compound(13) | Compound(1-A) | −125.5 | 1.49 |
| Example 36 | Compound(4) | Compound(14) | Compound(1-A) | −127.7 | 1.48 |
| Example 37 | Compound(5) | Compound(15) | Compound(1-A) | −127.7 | 1.47 |
| Example 38 | Compound(6) | Compound(16) | Compound(1-A) | −138.1 | 1.50 |
| Example 39 | Compound(7) | Compound(17) | Compound(1-A) | −136.5 | 1.49 |
| Example 40 | Compound(8) | Compound(18) | Compound(1-A) | −119.0 | 1.47 |
| Example 41 | Compound(9) | Compound(19) | Compound(1-A) | −125.1 | 1.48 |

### Examples 75 to 82

Coating liquids of liquid crystalline compositions were respectively prepared in the same way as in Example 33, except that the compounds mentioned in the following table were used in place of compound (1), compound (11) and compound (1-A). Optical compensation films were formed by respectively using these coating liquids, in the same way as in Example 33. The obtained optical compensation films were observed under a polarizing microscope, and were found to show uniform alignment without alignment defect. Further measurement of Rth at 550 nm and thickness of the obtained optical compensation films, were as summarized below.

TABLE 5

| | Polymerizable liquid | Liquid crystal | Polymerizable liquid | | |
|---|---|---|---|---|---|
| | crystal compound of | compound of | crystal compound of | | Film |
| | Formula (1) | Formula (2) | Formula (3) | Rth | thickness |
| | (15 parts by weight) | (2 parts by weight) | (85 parts by weight) | (nm) | (μm) |
| Example 75 | Compound(1L) | Compound(11L) | Compound(1-A) | −142.7 | 1.46 |
| Example 76 | Compound(2L) | Compound(12L) | Compound(1-A) | −128.9 | 1.45 |
| Example 77 | Compound(3L) | Compound(13L) | Compound(1-A) | −136.4 | 1.46 |
| Example 78 | Compound(4L) | Compound(14L) | Compound(1-A) | −128.0 | 1.47 |
| Example 79 | Compound(7L) | Compound(17L) | Compound(1-A) | −102.8 | 1.46 |
| Example 80 | Compound(8L) | Compound(11M) | Compound(1-A) | −144.4 | 1.48 |
| Example 81 | Compound(1N) | Compound(15M) | Compound(1-B) | −144.9 | 1.49 |
| Example 82 | Compound(2N) | Compound(14M) | Compound(1-A) | −143.6 | 1.47 |

What is claimed is:

1. A liquid crystal composition comprising:
at least one species of compound represented by the following formula (1);
at least one species of compound represented by the following formula (2); and
at least one species of compound represented by the following formula (3); 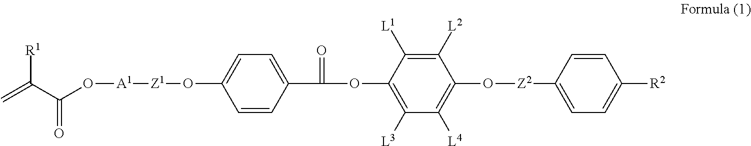
wherein
A¹ represents an alkylene group having 2 to 18 carbon atoms, one CH₂ group or two or more non-adjacent CH₂ groups in the methylene group may be replaced by —O—;
Z¹ represents —CO—, —O—CO— or single bond;
Z² represents —CO— or —CO—CH═CH—;
R¹ represents a hydrogen atom or methyl group;
R² represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, N-acetylamide group, acryloylamino group, N,N-dimethylamino group, maleimide group, methacryloylamino group, allyloxy group, allyloxycarbamoyl group, N-alkyloxycarbamoyl group with an alkyl group thereof having 1 to 4 carbon atoms, N-(2-methacryloyloxyethyl)carbamoyloxy group, N-(2-acryloyloxyethyl)carbamoyloxy group, or a structure represented by Formula (1-2) below;
each of L¹, L², L³ and L⁴ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, at least one of L¹, L², L³ and L⁴ represents a group other than hydrogen atom; 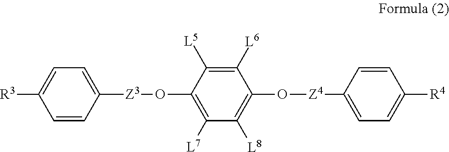
wherein
Z³ represents —CO— or —CH═CH—CO—;
Z⁴ represents —CO— or —CO—CH═CH—;
each of R³ and R⁴ independently represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, acryloylamino group, N,N-dimethylamino group, maleimide group, methacryloylamino group, allyloxy group, allyloxycarbamoyl group, N-alkyloxycarbamoyl group with an alkyl group thereof having 1 to 4 carbon atoms, N-(2-methacryloyloxyethyl)carbamoyloxy group, N-(2-acryloyloxyethyl)carbamoyloxy group, or a structure represented by Formula (1-2);
each of L⁵, L⁶, L⁷ and L⁸ independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, at least one of L⁵, L⁶, L⁷ and L^{B} represents a group other than hydrogen atom; 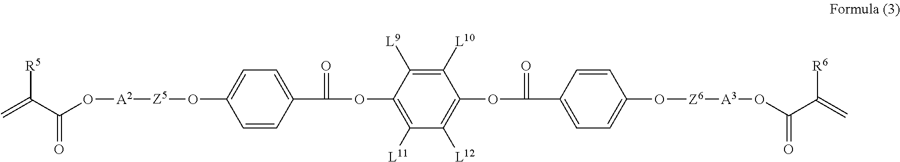
wherein
each of A² and A³ independently represents a methylene group having 2 to 18 carbon atoms, one CH₂ group or two or more non-adjacent CH₂ groups in the methylene group may be replaced by —O—;
Z⁵ represents —CO—, —O—CO— or single bond;
Z⁶ represents —CO—, —CO—O— or single bond;
each of R⁵ and R⁶ independently represents a hydrogen atom or methyl group;
each of L⁹, L¹⁰, L¹¹ and L¹² independently represents an alkyl group having 1 to 4 carbon atoms, alkoxy group having 1 to 4 carbon atoms, alkoxycarbonyl group having 2 to 5 carbon atoms, acyl group having 2 to 4 carbon atoms, halogen atom or hydrogen atom, and at least one of L⁹, L¹⁰, L¹¹ and L¹² represents a group other than hydrogen atom;
—Z⁵-T-Sp-P Formula (1-2)
wherein
P represents an acryl group, methacryl group or hydrogen atom;
Z⁵ represents a single bond, —COO—, —CONR¹—, R¹ represents a hydrogen atom or methyl group, or —COS—;
T represents a 1,4-phenylene group; and
Sp represents an optionally substituted divalent aliphatic group having 1 to 12 carbon atoms, one CH₂ group or two or more non-adjacent CH₂ groups in the aliphatic group may be replaced by —O—, —S—, —OCO—, —COO— or —OCOO—.

2. A liquid crystal composition of claim 1, wherein
in Formula (1), R² represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group, acetyl group, acetoxy group, N-acetylamide group, acryloylamino group, N,N-dimethylamino group or maleimide group; and
in Formula (2), each of R³ and R⁴ independently represents a hydrogen atom, halogen atom, straight-chain alkyl group having 1 to 4 carbon atoms, methoxy group, ethoxy group, optionally substituted aromatic ring, cyclohexyl group, vinyl group, formyl group, nitro group, cyano group; acetyl group, acetoxy group, acryloylamino group, N,N-dimethylamino group or maleimide group.

3. The liquid crystal composition of claim 1, wherein the compounds represented by Formulae (1), (2) and (3) are compounds represented by Formulae (4), (5) and (6) below: 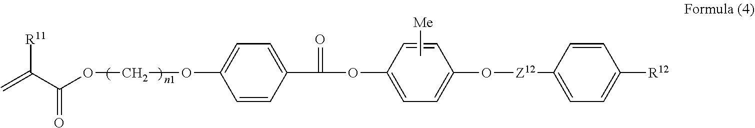
wherein,
n1 represents an integer of 3 to 6;
R¹¹ represents a hydrogen atom or methyl group;
Z¹² represents —CO— or —CO—CH═CH—;
R¹² represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3) below; 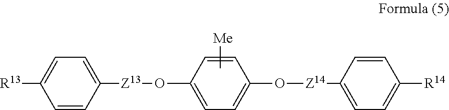
wherein
Z¹³ represents —CO— or —CO—CH═CH—;
Z¹⁴ represents —CO— or —CH═CH—CO—;
each of R¹³ and R¹⁴ independently represents a hydrogen atom, straight-chain alkyl group having 1 to 4 carbon atoms, methoxy group, ethoxy group, phenyl group, acryloylamino group, methacryloylamino group, allyloxy group, or a structure represented by Formula (1-3) below; 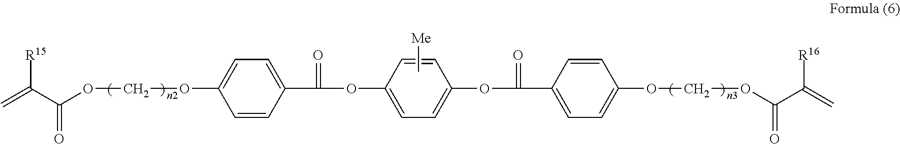
wherein
each of n2 and n3 independently represents an integer of 3 to 6; and
each of R¹⁵ and R¹⁶ independently represents a hydrogen atom or methyl group;
—Z⁵¹-T-Sp-P Formula (1-3)
wherein
P represents an acryl group or methacryl group;
Z⁵¹ represents —COO—;
T represents a 1,4-phenylene group; and
Sp represents an optionally substituted divalent aliphatic group having 2 to 6 carbon atoms, one CH₂ group or two or more non-adjacent CH₂ groups in the aliphatic group may be replaced by —O—, —OCO—, —COO— or —OCOO—.

4. The liquid crystal composition of claim 3, wherein at least two of R¹², R¹³ and R¹⁴ represent the same substituent.

5. The liquid crystal composition of claim 3, wherein n1 is 4.

6. The liquid crystal composition of claim 3, wherein each of R¹¹, R¹⁵ and R¹⁶ represents a hydrogen atom.

7. The liquid crystal composition of claim 3, wherein each of Z¹², Z¹³ and Z¹⁴ represents —CO—.

8. The liquid crystal composition of claim 3, wherein each of R¹², R¹³ and R¹⁴ independently represents a methyl group, ethyl group, methoxy group, ethoxy group, phenyl group, acryloylamino group, methacryloylamino group, allyloxy group, or a structure represented by Formula (1-3) below:
—Z⁵¹-T-Sp-P Formula (1-3)
wherein
P represents an acryl group or methacryl group;
Z⁵¹ represents —COO—;
T represents a 1,4-phenylene group; and
Sp represents an optionally substituted divalent aliphatic group having 2 to 6 carbon atoms, one CH₂ group or two or more non-adjacent CH₂ groups in the aliphatic group may be replaced by —O—, —OCO—, —COO— or —OCOO—.

9. The liquid crystal composition of claim 3, wherein each of R¹², R¹³ and R¹⁴ represents a phenyl group.

10. The liquid crystal composition of claim 1, containing 3 to 50% by mass of the compound represented by Formula (1), and 0.01 to 10% by mass of the compound represented by Formula (2), relative to the compound represented by Formula (3).

11. The liquid crystal composition of claim 1, containing at least one polymerization initiator.

12. The liquid crystal composition of claim 1, containing at least one species of chiral compound.

13. A method for manufacturing a polymer material, comprising polymerizing a liquid crystal composition described in claim 1.

14. The method for manufacturing a polymer material of claim 13, wherein the polymerization is attained through irradiation ultraviolet radiation.

15. A polymer material, obtainable by polymerizing the liquid crystal composition described in claim 1.

16. A film containing at least one polymer material described in claim 15.

17. A film comprising an optically anisotropic layer configured by fixing an alignment of a liquid crystal compound contained in a liquid crystal composition described in claim 1.

18. The film of claim 17, wherein the optically anisotropic layer is configured by fixing cholesteric alignment of the liquid crystal compound.

19. The film of claim 18, having a selective reflection characteristic.

20. The film of claim 18, having a selective reflection characteristic in the infrared wavelength region.

21. The film of claim 17, wherein the optically anisotropic layer is configured by fixing homogeneous alignment of the liquid crystal compound.

22. The film of claim 17, wherein the optically anisotropic layer is configured by fixing homeotropic alignment of the liquid crystal compound.

23. A polarizing plate comprising a film described in claim 21, and a polarizing film.

24. A liquid crystal display device comprising a polarizing plate described in claim 23.
